(19) United States
(12) Patent Application Publication
(10) Pub. No.: US 2002/0099586 A1
(43) Pub. Date: Jul. 25, 2002

(54) Method, system, and computer program product for risk assessment and risk management

(75) Inventors: Marc Bladen, Swansea (GB); Richard Hocking, Swansea (GB); Fred Houghton, Wrexham (GB); Philip Jones, Herts (GB); Peter Matthews, Herts (GB); Anthony Record, Kent (GB); Mark Sainty, Swansea (GB); Adrian Walker, Surrey (GB); Rhys Williams, Caerphilly (GB); Philip Johnson, Buckinghamshire (GB); Michael Raymond, Hampstead (GB); Lesley Tomlinson, Gwent (GB)

Correspondence Address: STERNE, KESSLER, GOLDSTEIN & FOX PLLC, 1100 NEW YORK AVENUE, N.W., SUITE 600, WASHINGTON, DC, 20005-3934, US

(73) Assignee: National Britannia Group Ltd.

(21) Appl. No.: 09/988,780

(22) Filed: Nov. 20, 2001

(30) Foreign Application Priority Data
Nov. 22, 2000 (GB) 0028499.2
Mar. 30, 2001 (GB) 0108045.6

(51) Int. Cl. G06F 17/60

(52) U.S. Cl. 705/7

(57) ABSTRACT

A system, method and computer program product for risk assessment and interactive risk management.

### BACKGROUND OF THE INVENTION

1. Field of the Invention

The present invention relates to risk assessment and risk management and, more particularly, to risk assessment and risk management based on government regulations, best practices, and other standards of care.

2. Background Art

Businesses and other entities are often confronted with various standards of care.

Standards of care can arise from statutes, rules, and/or regulations promulgated by government and/or other types of regulatory organizations. Standards of care can also arise from best practice standards, industry standards, due diligence standards, tort law standards, and/or from other standards. Standards of care can be divided into disciplines, such as, food health, occupational health, environmental pollution, asbestos, fire, etc.

Business and other entities need to minimize risks associated with non-compliance with these standards of care.

What is needed therefore is a method and system for assessing compliance with standards and for minimizing risks associated with the non-compliance with standards of care.

### BRIEF SUMMARY OF THE INVENTION

The present invention is directed to methods, systems, and computer program products for assessing compliance with standards and for minimizing risks associated with the non-compliance with standards of care.

### BRIEF DESCRIPTION OF THE DRAWINGS/FIGURES

The present invention will be described with reference to the accompanying drawings, wherein like reference numbers indicate identical or functionally similar elements. Also, the leftmost digit(s) of the reference numbers identify the drawings in which the associated elements are first introduced.

FIG. 1A illustrates a block diagram of an example risk assessment and risk management system.

FIG. 1B illustrates an exemplary interactive risk assessment component and an audit component according to an embodiment of the invention.

FIG. 1C illustrates a more detailed block diagram of an example risk assessment and risk management system.

FIG. 1D illustrates a more detailed description of a discipline specific master templates module.

FIG. 1E illustrates how a user interface interacts with an audit central component of an e-Risk system.

FIG. 1F illustrates an Internet user interface for an e-Risk system.

FIG. 1G illustrates how an Internet user interface is used in conjunction with multiple clients that are located remotely from the user of the Internet user interface.

FIG. 1H illustrates the division of tasks/labor among one or more teams of specialists according to an embodiment of the invention.

FIG. 1I illustrates teams of specialists and their respective areas of expertise according to an embodiment of the invention.

FIG. 1J illustrates an exemplary computer system.

FIG. 1K illustrates an embodiment of the invention implemented for multiple languages.

FIG. 2A illustrates a detailed diagram of a registration module.

FIG. 2B illustrates a diagram of a user administration module.

FIG. 2C illustrates a diagram of a menu module.

FIG. 2D illustrates a diagram of a client administration module.

FIG. 2E illustrates a diagram of an authorized third party module.

FIG. 2F illustrates a diagram of an owner administration module.

FIG. 2G illustrates a diagram of a sites administration module.

FIG. 2H illustrates a diagram of a laboratories module.

FIG. 2I illustrates a diagram of a configuration module.

FIGS. 3A, 3B, 3C, and 3D illustrate an exemplary method for developing an interactive master manual for a new discipline.

FIGS. 3E, 3F, and 3G illustrate an exemplary method for developing an audit master manual for a new discipline.

FIG. 4 illustrates an exemplary method for performing a benchmark audit according to an embodiment of the invention.

FIGS. 5A and 5B illustrate an exemplary method for generating an audit site for a specific discipline.

FIGS. 5C, 5D, 5E, and 5F illustrate an exemplary method for generating an interactive site for a specific discipline.

FIG. 6A is an exemplary screen shot of a user interface according to an embodiment of the invention.

FIG. 6B is an exemplary screen shot of a responseline enquiry according to an embodiment of the invention.

FIG. 7A illustrates a high level process flowchart for implementing the present invention.

FIG. 7B illustrates an example process flowchart for an interactive risk assessment process.

FIG. 7C illustrates an example process flowchart for an audit process.

FIG. 7D illustrates an exemplary interactive risk assessment and audit process flowchart.

FIG. 8A is an example front screen of a user interface.

FIG. 8B is an example responsibilities screen showing the Assign Responsibilities Function.

FIG. 8C is an example responsibilities screen showing the additional responsibilities function.

FIG. 8D is an example skills matrix screen, showing required skills, skills held, and training requirement.

FIG. 8E illustrates an example risk assessment screen, showing hazards associated with a work activity and the control measures.

FIG. 8F is an example screen showing a control standard.

FIG. 8G is an example risk monitoring menu screen.

FIG. 8H is an example risk monitoring checklist screen, showing question, corrective action and mark completed function.

FIG. 8I is an example audit screen.

FIG. 8J illustrates an example external audit report screen.

FIG. 9 illustrates a business management flowchart according to an embodiment of the invention.

FIG. 10A is a block diagram illustrating an exemplary report management system.

FIG. 10B is a flow diagram illustrating a method for providing reports to authorized viewers using a report management system.

FIG. 10C is a flow diagram illustrating in more detail, a method for receiving audit reports.

FIG. 10D is a flow diagram illustrating in more detail, a method of formatting data for a report.

FIG. 10E illustrates an exemplary business method for generating audits.

FIG. 11A is an exemplary list of electrical energy, natural gas, and water consumptions for a period of one year.

FIG. 11B is a diagram illustrating metering vs. invoice methods of determining resource consumption.

FIG. 12A illustrates an example modular view of various interactive modules that provide input to an organization-wide modular report.

FIG. 12B illustrates a multiple organization implementation that includes interactive modules and an organization-wide report.

FIG. 13A is a diagram illustrating an example list of asbestos material found on a particular site and an outstanding checklist according to an embodiment of the e-risk manager system.

FIG. 13B is an exemplary screenshot of an asbestos register checklist for EPA 56496-020.

FIG. 13C is an exemplary screenshot showing additional information about asbestos EPA 56469-20.

### DETAILED DESCRIPTION OF THE INVENTION

Table of Contents

I. Introduction

A. Methods for Assessing and Managing Risk

1. High Level Methods

2. Interactive Risk Assessments

3. Audits

4. Combined Interactive Risk Assessments and Audits

B. High Level Architecture

1. Modular Auditing and Reporting

2. Report Management System

C. Computer Program Product

II. Detailed Example Architecture

A. Registration Module

B. Blank Templates Module

C. Discipline-Specific Master Templates

1. Discipline-Specific Audit Assessment Template Module

2. Discipline-Specific Interactive Assessment Template Module

D. Site-Specific Files

III. Example Processes

A. Adding a New Discipline

B. Performing Benchmark Audits

C. Establishing Interactive and Audit Sites for Risk Assessment and Management

D. User Initiated Tasks

E. Providing/Maintaining Reference Files

1. Interactive Template Forms

2. Newsfeed

3. Legislation

F. Business Management Processes

G. Example Interactive User Guide

IV. Conclusions

I. Introduction

The present invention is directed to methods, systems, and computer program products for assessing and managing risks to businesses and other entities. The invention combines the knowledge and experience of Information Technology (IT) professionals, chief consultants having knowledge and experience in the main specific standards of care and local consultants who interface with clients, customers, and users.

Unless otherwise specified herein, the following terms shall have the indicated meaning.

e-Risk manager is a risk assessment and risk management system of the present invention. e-Risk manager is based on government regulations, best practices, industry standards, due diligence standards, tort law standards, and/or other standards of care. Throughout this document risk assessment and risk management system, e-Risk system, and e-Risk manager are used synonymously.

Sector refers to major industries such as care homes, supermarkets, apartments, factories, hotels, and restaurants.

The term discipline is used to refer to a particular area of risk management. Major disciplines in the risk management area include health and safety, food safety, water safety, asbestos safety, fire safety, occupational health and occupational hygiene. Thus, one sector can have several disciplines associated with it.

A response line team refers to a group of people who learn legislation, translate legislation to practical common sense and guidance notes that are used by users, produce news feeds, and give telephone support to users of the e-Risk manager.

Chief consultants refer to environmental help consultants, environmental scientists, and medical officers who interpret data as it relates to users needs.

Local consultants refer to local environment help consultants or environmental scientists who perform tasks relevant to a particular site. These consultants set up particular sites, run the audit on these sites, and maintain sites. The term environmental health consultant refers to consultants associated with a particular discipline. In general, environmental health consultants are associated only with the health and safety, food safety, and fire safety disciplines. The term environmental scientist is used to refer to a consultant in a particular discipline. In general, environmental scientists are associated only with the asbestos safety, water safety, and occupational hygiene disciplines. The term medical officer is used to refer to a consultant in a particular discipline. In general, a medical officer is only associated with the occupational health discipline.

The term chief consultant is used to refer to a high ranking consultant in a particular discipline having seniority in that discipline.

The term local consultant is used to refer to a consultant which is located at a site and having expertise in a particular discipline. The term information technology specialist is used to refer to a system administrator and system programmer having access and authorization to modify certain aspect of the system.

A. Methods for Assessing and Managing Risk

The present invention includes multiple types of risk assessments. These include audits, interactive assessments, and combinations thereof.

Generally, audits provide a snapshot of a business for other entities of businesses or other entities' compliance with standards of care. An audit typically provides a fixed or relatively fixed set of questions, criteria, and/or other measurables that can be used repeatedly by one or more entities or portions of an entity. This allows comparison between audits performed at various points of time for an entity or comparison of different entities' risk assessment.

Interactive risk assessments, on the other hand, are directed to ongoing risk maintenance.

In an embodiment audits and interactive risk assessments are both performed to provide benefits of both.

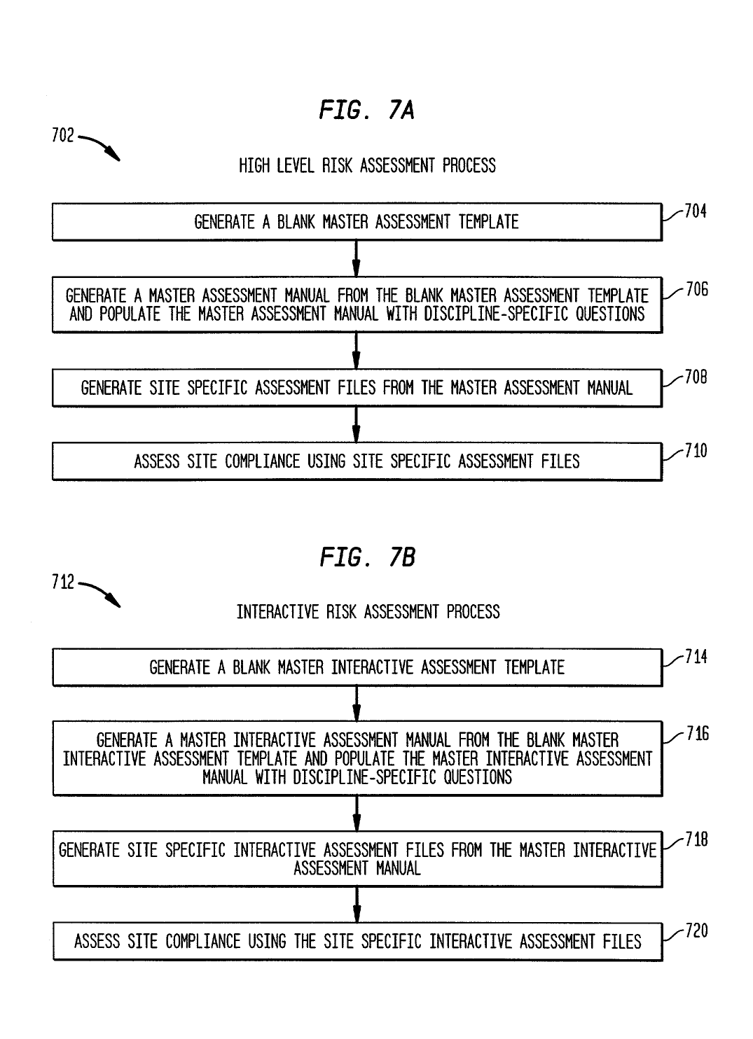

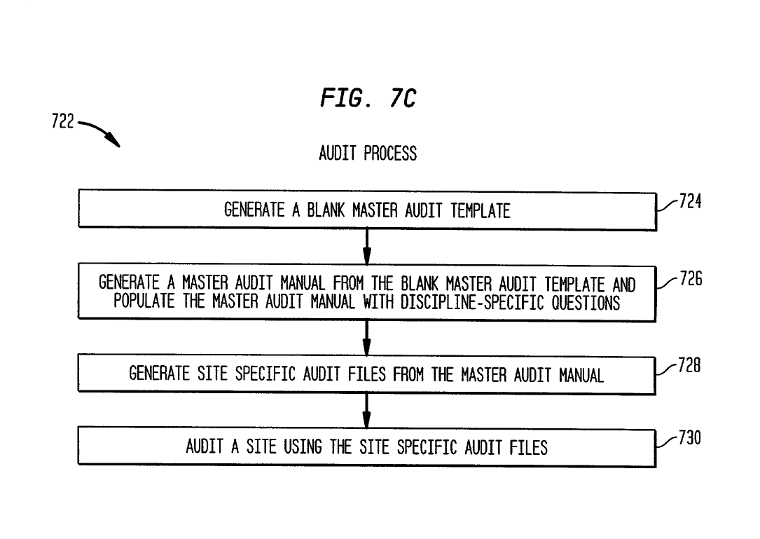

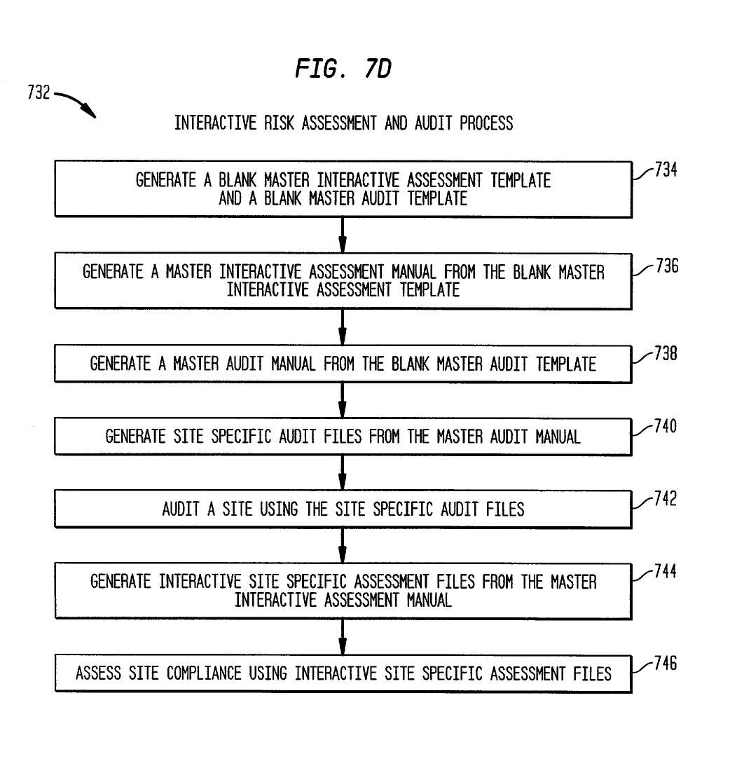

Methods for implementing the invention are now described at a high level with reference to FIGS. 7A-7D.

1. High Level Methods

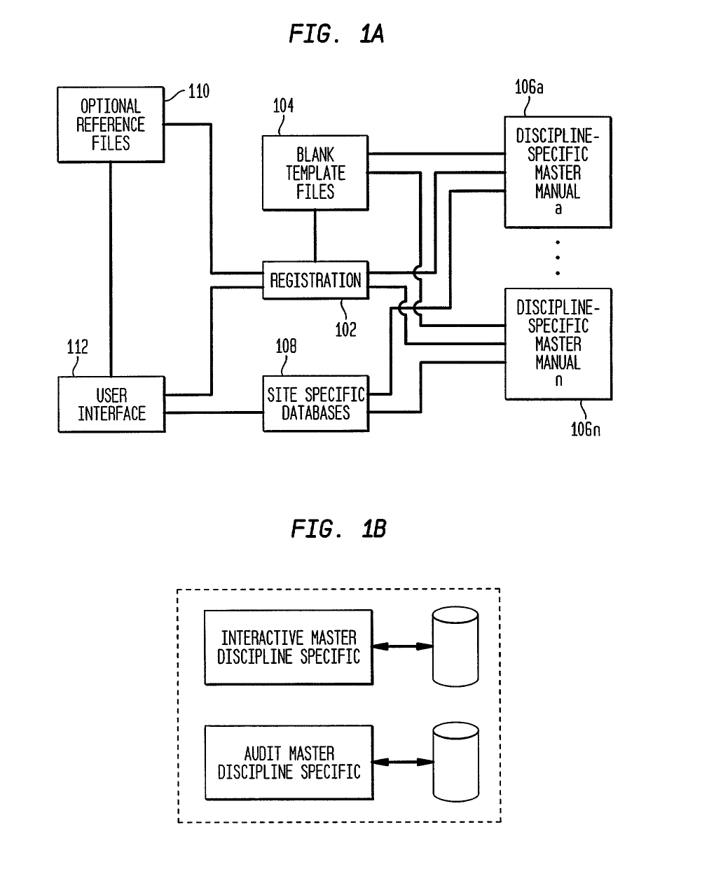

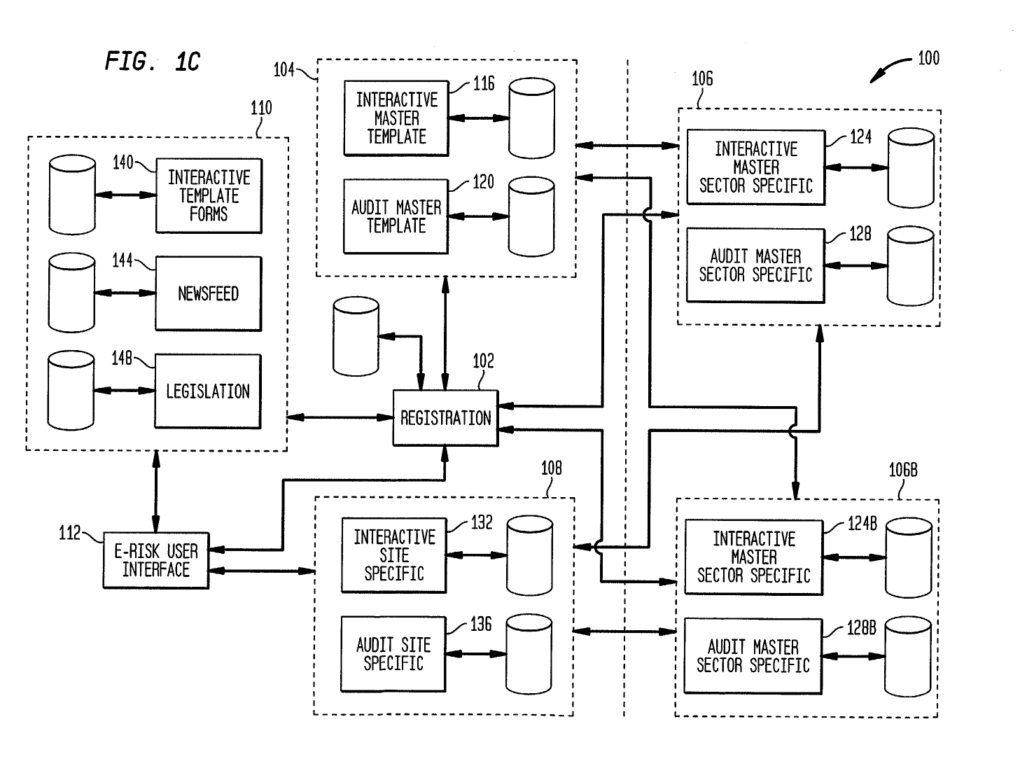

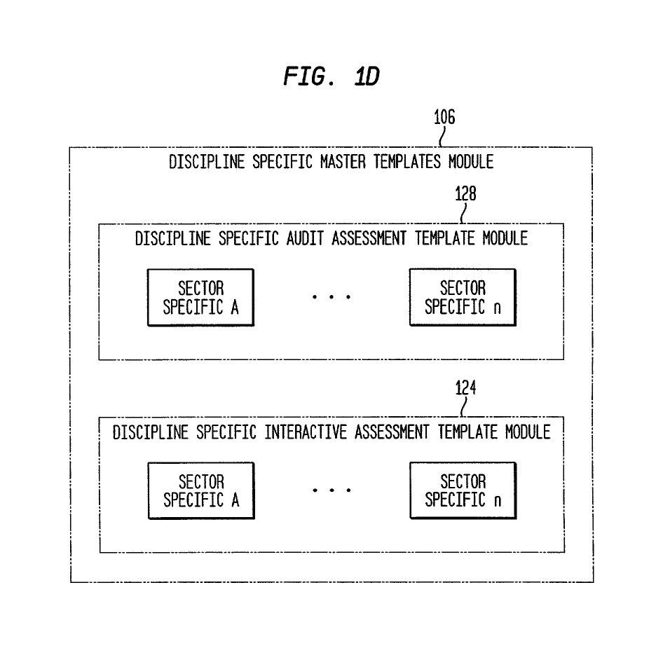

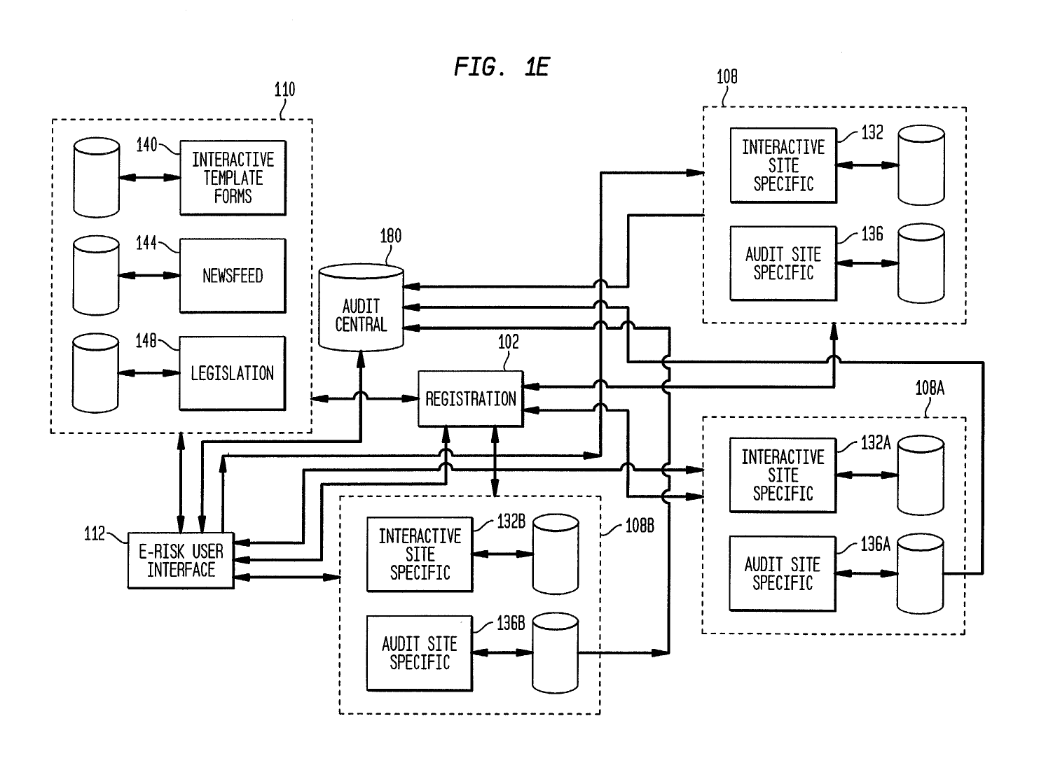

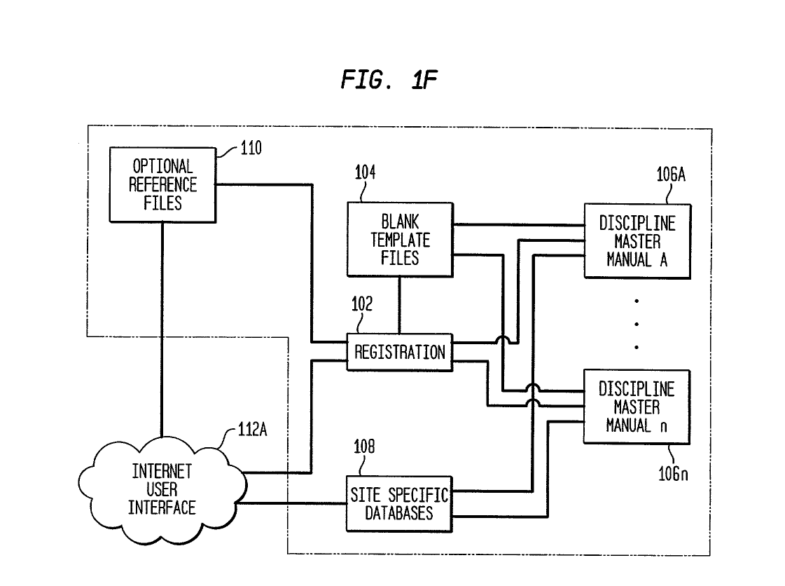

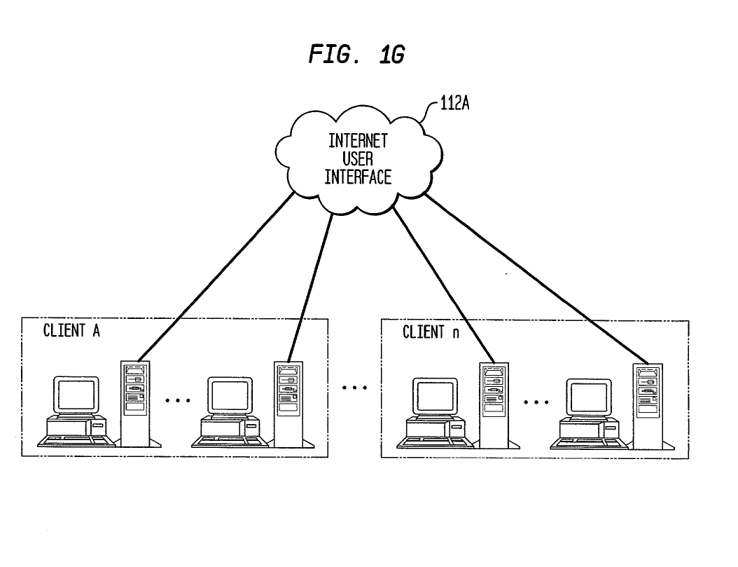

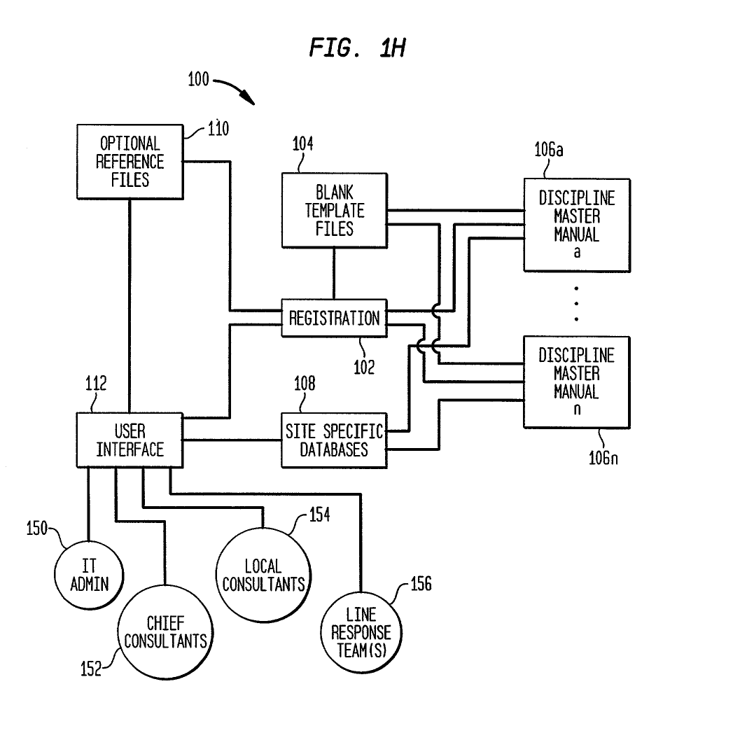

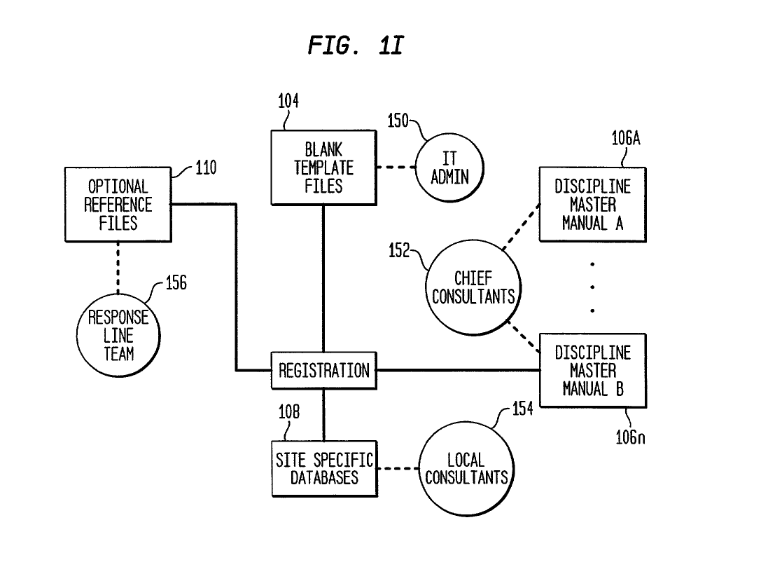

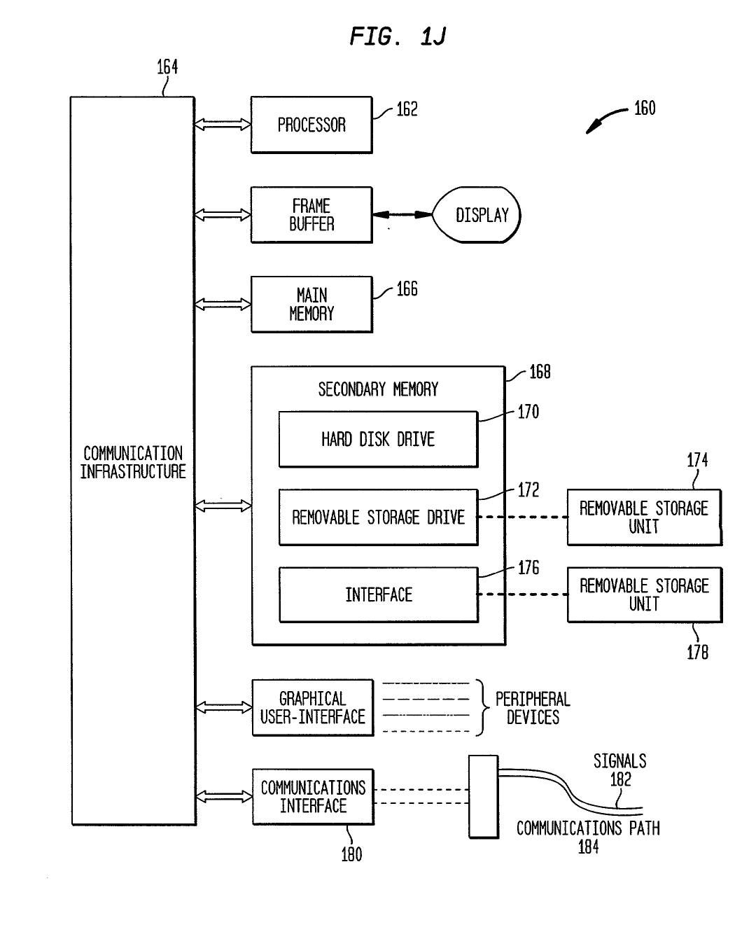

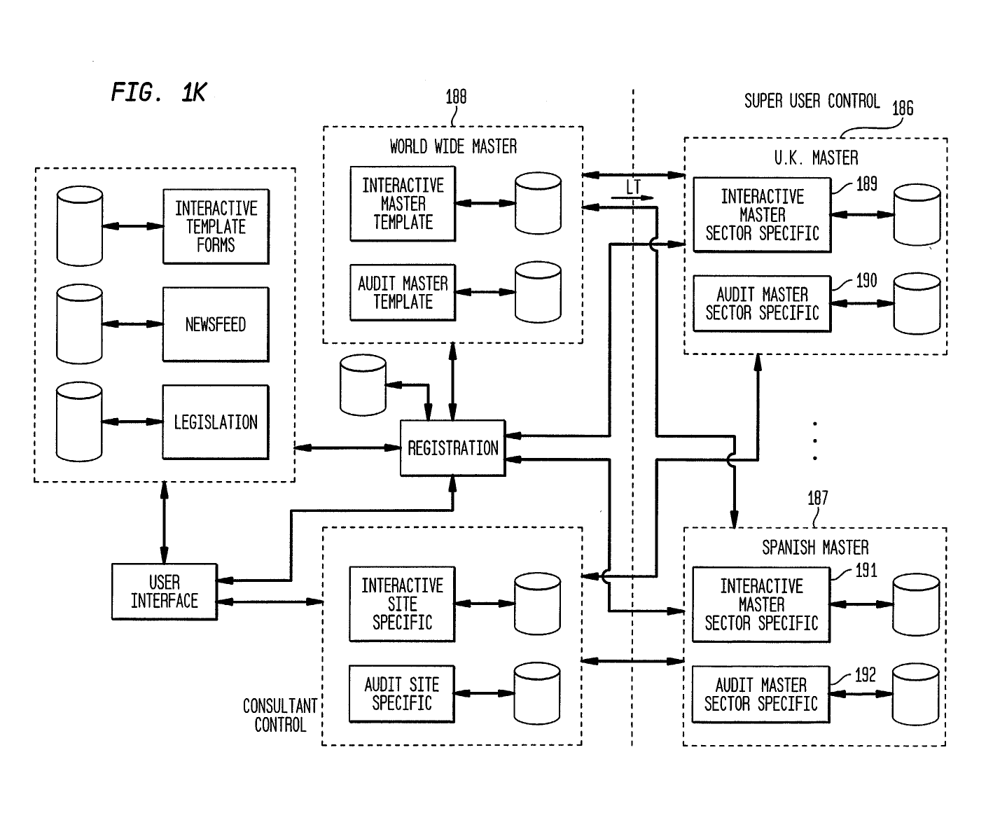

FIG. 7A illustrates a high level process flowchart 702 for implementing the present invention. The process begins at step 704, generating a blank master assessment template. The blank master assessment template will be used as a basis for future assessments. The blank master assessment template can be generated by information technology (IT) professionals, as discussed below with reference to FIGS. 1H and 1I.

Step 706 includes generating a master assessment manual from the blank master assessment template and populating the master assessment manual with risk management questions, procedures, links, comments, and/or other information useful for risk assessment and management. Unless otherwise specified herein, when reference is made to questions in a master assessment manual, the reference includes such questions, procedures, links, comments, and/or other information useful for risk assessment and management.

In an embodiment, the master assessment manual is populated with discipline-specific risk management questions. Disciplines can include, without limitation, health and safety, food safety, occupational health, occupational hygiene, water safety, asbestos safety, and fire safety. A manual populated with discipline-specific questions is referred to herein as a discipline-specific master assessment manual.

Generation of a master assessment manual is typically performed via commands to a computer system. Systems and processes for populating master assessment manuals are described below.

Population of the discipline-specific master assessment manuals is typically performed by one or more chief consultants having expertise in a discipline.

For example, in an embodiment, chief consultants include environmental health consultants (EHCs), who may be enforcement officers, and who have knowledge of rules/regulations in one or more regulated areas, such as, without limitation, health and safety (H&S), fire, and food.

In an embodiment, chief consultants include environmental scientists (ESs), who have technical expertise in a discipline, such as, without limitation, asbestos, water, and occupational hygiene. ESs can include microbiologists and/or scientists.

In an embodiment, chief consultants include medical officers who have medical expertise in a discipline, such as, without limitation, occupational health. Generally, chief consultants populate discipline-specific assessment manuals with questions that are structured to identify issues and/or to assess compliance with statutes, rules, regulations, best practices, and/or other duties of care relevant to a discipline.

In an embodiment, a single master assessment manual is generated for a single discipline, in step 706. Alternatively, multiple master assessment manuals, each directed to a different discipline, are generated in step 706.

Step 708 includes generating site-specific assessment files from the master assessment manuals. In an embodiment, site-specific assessment files are generated for a single discipline. Alternatively, site-specific assessment files are generated for multiple disciplines. In other words, a site may be impacted by risks associated with more than one discipline. In such a case, site-specific assessment files need to be generated from associated discipline-specific master assessment manuals.

Step 708 can be performed for one or more clients. Each client can have one or more sites.

In an embodiment, substantially all computer files utilized to implement the invention, including blank templates and master manuals, are maintained by a risk assessment and management service provider, at a central location controlled by the risk assessment and management service provider. Additionally, site specific files, which are typically generated locally, are uploaded to the central location for storage. This helps to avoid interfering with a client's information technology infrastructure, because it substantially avoids loading software on client computers.

For example, clients can be provided access to the central location through an Internet or other network connection that does not require software beyond what is typically already available within the client's information technology infrastructure.

Step 710 includes assessing site risk and/or compliance using the site-specific assessment files generated in step 708. Features associated with step 710 are described below.

The process flowchart 702 can be implemented to insure compliance with any of a variety of statutes, regulations, rules, best business practices, tort law standards, due diligence standards, etc.

2. Interactive Risk Assessments

FIG. 7B illustrates an example process flowchart 712 for an interactive risk assessment process.

The process begins at step 714, which includes generating a blank master interactive assessment template. This is similar to step 704 in FIG. 7A. A master interactive template is a template that can be utilized to generate master interactive assessment manuals for multiple disciplines.

Step 716 thus includes generating a master interactive assessment manual from the blank master interactive assessment template, and populating the master interactive assessment manual with discipline-specific questions. This is similar to step 706 in FIG. 7A, except that the master interactive assessment manuals, which are typically discipline-specific, are specifically tailored for interactive assessments, as described below.

Step 718 includes generating site-specific interactive assessment files from the master interactive assessment manual.

Step 720 includes interactively assessing site compliance using site-specific interactive assessment files.

Additional features associated with interactive risk assessments are described below.

3. Audits

FIG. 7C illustrates a process flowchart 722 for an audit process. The process begins in step 724, which includes, generating a blank master audit template.

Step 726 includes generating a master audit manual from the blank master audit template and populating the master audit manual with discipline-specific questions.

Step 728 includes generating site-specific audit files from the master audit manual.

Step 730 includes auditing a site using the site-specific audit files.

Additional features associated with audits are described below.

4. Combined Interactive Risk Assessments and Audits

FIG. 7D illustrates an interactive risk assessment and audit process flowchart 732, in accordance with the present invention. The interactive risk assessment and audit process 732 is a combination of the process flowcharts 712 and 722, discussed above.

The process begins at step 734, which includes generating a blank master interactive assessment template and a blank master audit template.

Step 736 includes generating one or more master interactive assessment manuals from the blank master interactive assessment template.

Step 738 includes generating one or more master audit manuals from the blank master audit template.

Step 740 includes generating site-specific audit files from the one or more master audit manuals generated in step 738.

Step 742 includes auditing a site using the site-specific audit files generated in step 740. In an embodiment, step 742 results in an audit report. In an embodiment, steps 740 and 742 are performed under the direction of a local consultant. In an embodiment, the local consultant is prompted to insert comments and/or instructions to be used in an interactive assessment described below.

Step 744 includes generating interactive site-specific assessment files from the one or more master interactive assessment manuals generated in step 736.

Step 746 includes assessing site compliance using the interactive site-specific assessment files generated in step 744. In an embodiment, 746 includes performing an initial audit and generating periodic procedures and/or instructions to be performed over a period of time. Thus, in an embodiment, step 746 is performed over a period of time.

For example, in an embodiment, the procedures and/or instructions are then performed periodically over some period of time, for example, three months, after which one or more local consultants may come back in, assess the adequacy of risk reduction since the audit, and/or review and revise the interactive file and maintenance procedures and/or instructions. After this, the client/user can continue to perform the periodic instructions and/or procedures.

For example, an interactive site-specific assessment file may include procedures to be performed and/or items to be checked on a daily, weekly, monthly, etc., basis.

Referring back to step 742, in an embodiment, step 742 includes permitting a local consultant to insert instructions and/or comments inserted into an audit report. In this embodiment, step 744 includes using the instructions and/or comments to generate the interactive site-specific assessment files.

B. High Level Architecture

A high level exemplary architecture is now described for implementing one or more of the process flowcharts 702, 712, 722, and 732. The example high-level architecture described below is provided to assist the reading and understanding of the present invention. The present invention is not, however, limited to the example architecture described below. Based on the description herein, one skilled in the relevant arts will understand that the present invention can be implemented with other architectures as well.

FIG. 1A illustrates a block diagram of an example risk assessment and risk management system 100. The example system 100 initially includes a registration module 102 and a blank template files module 104. In an embodiment, one or more of the remaining modules illustrated in FIG. 1A are generated at a later time.

The registration module 102 includes functionality for generating one or more discipline-specific master manuals 106a through 106n. For example, a discipline-specific master manual 106 is generated for each desired discipline. Disciplines can include, without limitation, health and safety, food safety, occupational health, occupational health and hygiene, water safety, asbestos safety, and fire safety. Typically, a separate discipline-specific master manual 106 is generated for each desired discipline.

Generally, a discipline-specific master manual 106 is generated by making a copy of blank template 104 and populating it with questions, etc. designed to assess risk for a particular discipline. For example, a fire safety discipline-specific master manual 106 could include questions designed to assess compliance with local and/or national fire regulations and/or best practices.

In an embodiment, questions within a discipline-specific master manual 106 are divided into one or more sectors associated with one or more types of businesses and/or other type of entities. For example, using the fire safety example from above, questions can be divided into sectors according to types of businesses to be assessed. A first sector of questions may be directed to restaurant fire safety. A second set of fire safety questions can be directed to hotel fire safety risk assessments. Additional sectors of questions can be generated for additional categories of business or entities.

Discipline-specific master manuals 106 serve as a repository of questions for generating site-specific files for use in assessing and managing risk at one or more businesses.

When a new client is identified or signed up for risk assessment, site-specific databases 108 are generated from one or more discipline-specific master manuals 106. Site-specific databases 108 can be viewed as a subset of one or more questions taken from the repository of questions, that is, discipline specific master manuals 106.

Typically, site-specific databases 108 include question sets associated with one or more question sets associated with one or more disciplines, respectively.

For example, site-specific databases 108 can include questions directed to fire safety, questions directed to asbestos safety, etc.

In an embodiment, questions are selected for site-specific databases 108 on a sector basis. For example, questions selected from site-specific databases 108 can be limited to questions from a particular sector. For example, questions from a discipline can be limited to only those questions that apply to restaurants, for example.

In an embodiment, where only audits are performed by system 100, all of the tasks described thus far are performed by representatives of the risk assessment and management service provider.

Where interactive risk assessments, as described in the process flowchart 712 of FIG. 7B, are performed, site-specific databases 108 also include interactive risk assessment questions which typically prompt a client user to periodically answer questions and/or periodically perform one or more tasks. For example, in a fire safety discipline, a periodically performed interactive task can include checking batteries in smoke detectors, on a weekly, monthly, and/or annual basis. A user interface 112 is provided to allow users to interact with system 100. System 100 provides either audit or interactive risk assessments at user interface 112, which may actually include multiple user interfaces.

In an embodiment, user interface 112 includes a network interface. In an embodiment, the network interface is a packet switched wide area network (WAN) such as the global Internet. In this embodiment, Internet user interface 112 can be a standard personal computer that is wired to the Internet, or a wireless device that wirelessly access the Internet (e.g., a PalmPilot® or a web capable wireless phone). In an embodiment, the network interface includes one or more of a private WAN, a local area network (LAN), a telecommunications network, and/or combinations thereof.

In an embodiment, the invention divides tasks/labor among one or more teams of specialists. For example, referring to FIG. 1H, in an embodiment, the invention divides tasks/labor among IT administrators 150, chief consultants 152, local consultants 154, and optional response line teams 156. FIG. 1I illustrates these teams with their respective areas of expertise.

For example, IT administrators 150 are responsible for creating, maintaining, and updating, when necessary, blank templates 104. Chief consultants 152 are responsible for generating and populating discipline-specific master manuals 106. Local consultants 154 are responsible for generating site-specific databases 108 and for performing audits and interactive assessments. Optional responsible line team members 156 are responsible for optional reference files 110. Optional reference files 110 are described below.

Typically, IT administrators 150, chief consultants 152, local consultants 154, and optional response line teams 156 are associated with a risk assessment and management service provider.

Referring to FIG. 1B, in an embodiment, system 100 is implemented with interactive risk assessment components and audit components. As described above, interactive risk assessment and management system typically refers to an ongoing process for managing and/or reducing risk for a business or other entity. Audits are typically a snapshot measurement of the results of managing risk.

FIG. 1C illustrates system 100 implemented with interactive risk assessment and audit components. FIG. 1C is described below.

1. Modular Auditing and Reporting

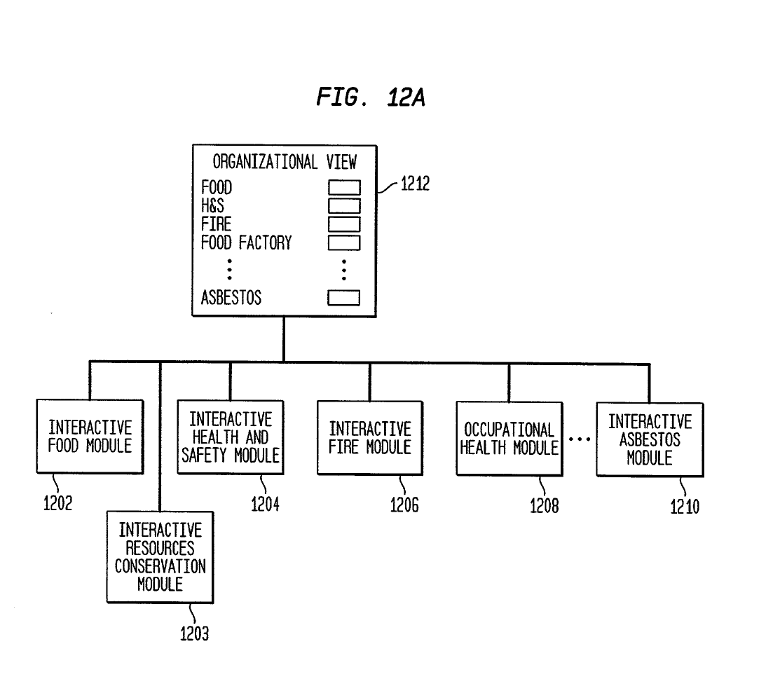

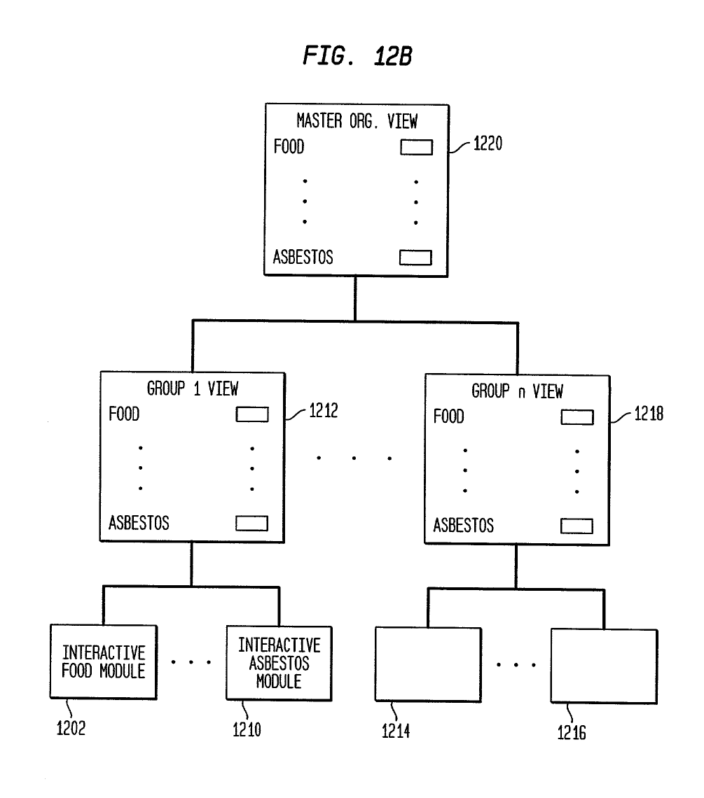

In an embodiment, the invention is thus implemented in a modular form. FIG. 12A illustrates an example modular view of various interactive modules 1202 through 1210 that provide input to an organization-wide modular report 1212. In an embodiment, the organization-wide report 1212 lists the interactive modules 1202-1210 and indicates whether each is in compliance or not. In an embodiment, a user can select to view details of non-compliance issues.

Compliance indications are based on one or more of a variety of measurements. For example, when legal requirements are at issue, a non-compliance indication is typically provided based on even a single failure to meet the legal requirement.

When, however, best business practices are at issue, compliance can be divided into categories. For example, in an embodiment, best business practices are divided into minor issues, major issues and critical issues. In such an embodiment, failure to meet or exceed a major or critical best business practice typically results in a non-compliance indication. However, for minor best business practices, a non-compliance indication typically will not result until the organization is out of compliance with a certain number and/or percentage of minor best business practices. For example, in an embodiment, an organization can fail to comply with up to ten percent of minor best business practices before a non-compliance indication is reported.

FIG. 12B illustrates a multiple organization implementation that includes the interactive modules 1202 through 1210 and the organization-wide report 1212. The multiple organization implementation of FIG. 12B also includes interactive modules 1214 through 1216 and an associated organization-wide report 1218. Organization-wide reports 1212 and 1218 are combined to a master organization-wide report 1220.

The modules illustrated in FIGS. 12A and 12B are provided for illustrative purposes only. The preseent invention is not limited to the modules illustrated in FIGS. 12A and 12B. Similarly, in an embodiment, the invention is implemented with fewer than and/or other than the modules illustrated in FIGS. 12A and 12B.

Additional optional implementation details of various optional modules are now described for illustrative purposes. Again, the present invention is not limited to or by the examples provided herein.

In an embodiment, one or more of a variety of modules are implemented, including, without limitation, one or more of the following types of modules:

a resources conservation module;

an occupational health module;

a fire safety module;

an asbestos module; and

a food preparation module.

Example implementations of optional modules are described below.

In an embodiment, an optional food preparation module 1202 is directed to identifying and rectifying food preparation hazards, which are based on regulatory and/or best business practices.

In an embodiment, an optional resources conservation module 1203 is directed to one or more of electrical energy conservation, water conservation, and natural gas conservation. The optional resources conservation module is designed to identify and conserve resource usage. For example, an initial survey is performed to determine the level and cost of one or more of electrical energy consumption, natural gas consumption, and water consumption over a period of time. The level and cost of energy, natural gas, and water consumption may be obtained from invoices as well as meter readings over a period of time. In an embodiment, a period of time may be equal to, for example, one year. Exemplary electrical energy, natural gas, and water consumptions for a period of one year are shown in FIG. 11A. The total consumption of electrical energy, natural gas, and water for that period of time will become target consumptions against which all subsequent monitoring is judged. Usage that is equal to or exceeds the target consumption results in non-compliance. Usage that falls below the target consumption level results in compliance. The frequency with which data is collected must be defined at the onset. This will enable the system to know when data may be missing. If the system determines that data is missing, the system will not deem the site non-compliant because of the lack of data.

FIG. 11B is a diagram illustrating metering vs. invoice methods of determining resource consumption. A metering method 1102 is shown and an invoice method 1104 is shown. Metering method 1102 shows data being extracted every half hour. Although this example shows that data is collected every half hour, one skilled in the art would know that other periods of time for collecting data may be used as well. Metering method 1102 shows electricity consumption data 1106, natural gas consumption data 1108 and water consumption data 1110 automatically being collected by a processor 1112. Meters for reading such utility data may connect to processor 1112 via telephone lines or some other interfacing configuration. Processor 1112 then feeds this data to a central data processor 1114 via a local area network configuration. Invoice method 1104 shows water, natural gas, and electricity consumption values being taken from utility bills 1116 and manually entered into a central data processor. This process of manually entering utility bill data may be carried out by a data processing operator (not shown). Depending on the type of resource, utility bills may be monthly, quarterly, or bi-annually. For example, natural gas and electric bills may occur monthly. Water bills may occur quarterly or bi-annually. Central data processor 1114 will compare the data being collected against target consumption values. When the collected data exceeds a specified percentage of the target consumption value, an alarm is sent to the interactive site causing it to be non-compliant. If the collected data is less than a specified amount, the interactive site is in compliance and no alarm is sent.

After an initial survey of an interactive site is completed, areas where resources are wasted may be identified, and control measures may be suggested to the interactive site to aid in conserving resources. Control measures for the resource conservation module may fall into one or more of three areas: (1) no cost control measures, (2) low cost control measures, and (3) high cost control. For example, a no cost control measure may be to switch off unnecessary office equipment overnight. A low cost control measure may be to install sensor lighting controls in selected areas. A high cost control measure may be to change from an electric-based heating system to a gas-based heating system.

In an embodiment, an optional health and safety module 1204 is directed to accidents of employees that occur at the workplace. Such accidents may include, but are not limited to, injuries from using certain machinery, falling on slippery floors, electrocution, escalator and elevator accidents, etc.

In an embodiment, an optional fire safety module 1206 is directed to identifying and rectifying fire related safety issues, which can be based on regulatory and/or best business practices.

In an embodiment, an optional occupational health module 1208 is directed to occupational health problems that result from undesirable conditions at the workplace. Such conditions may include asbestos exposure, excessive exposure to noise, repetitive strain injuries, exposure to toxic chemicals, etc.

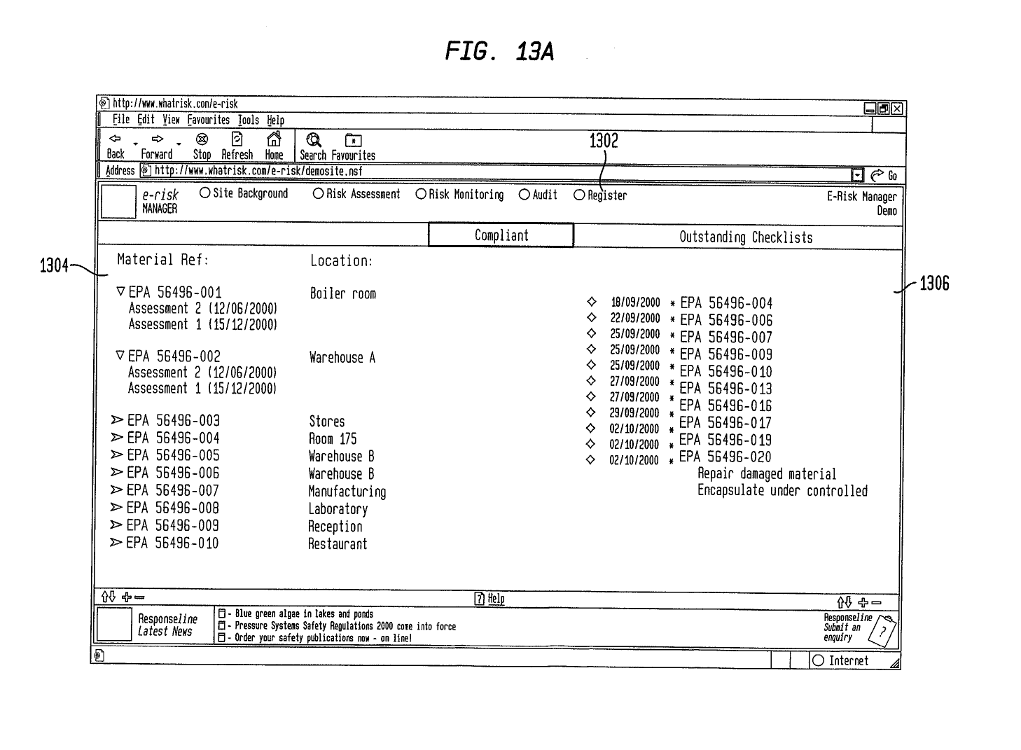

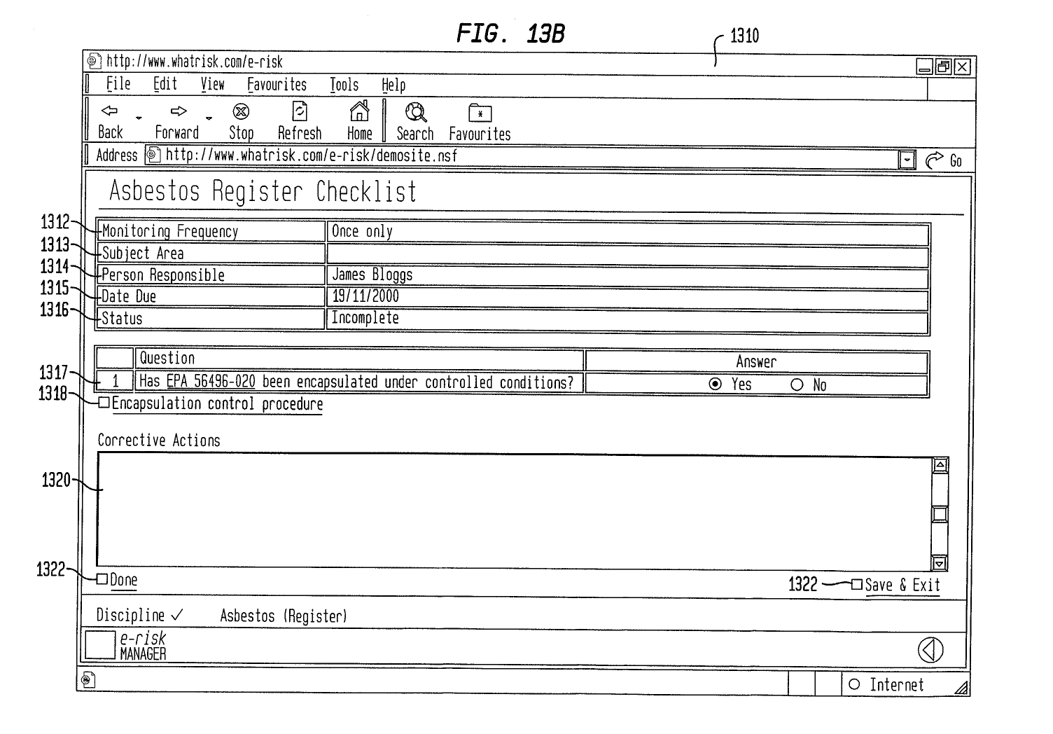

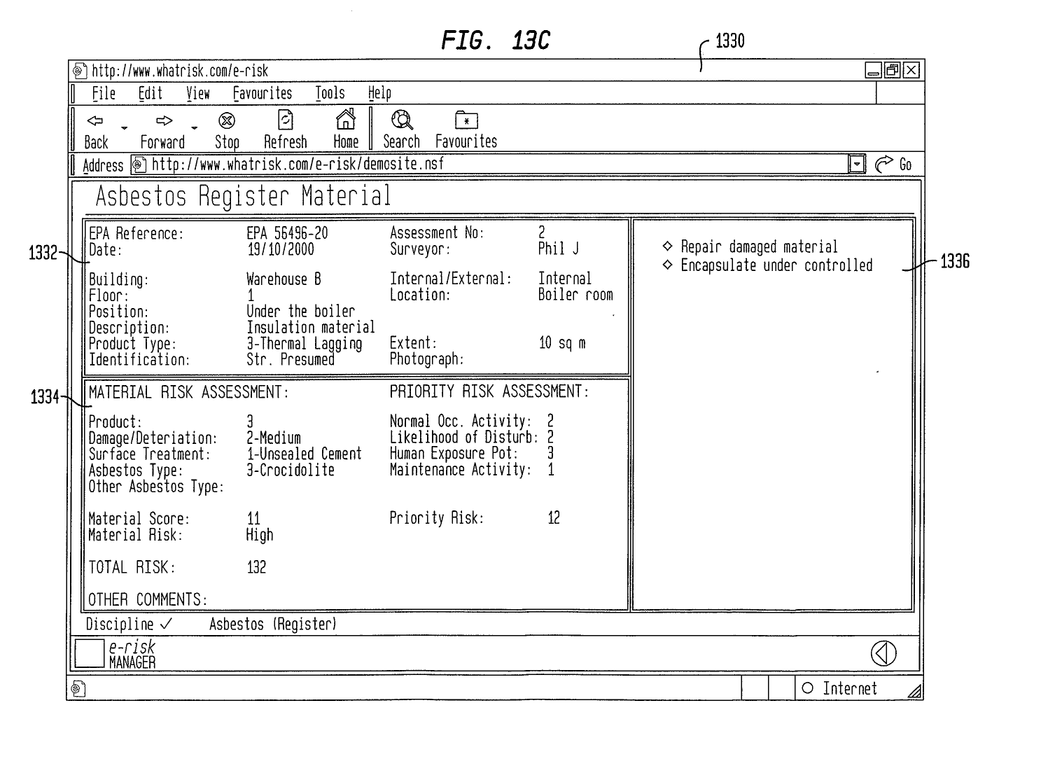

In an embodiment, an optional asbestos safety module 1210 is directed to locating and rectifying asbestos materials, based on regulatory and/or best business practices. For asbestos inspections, e-risk manager requires that all asbestos material be listed. FIG. 13A is a diagram illustrating a list of asbestos material found on a particular site and an outstanding checklist according to an embodiment of the e-risk manager system. E-risk manager stores the asbestos material list using a register menu 1302. When register menu 1302 is selected, the list of asbestos material 1304 for a particular site is displayed. The corresponding location of the asbestos material is also displayed. One may also view a list of all assessment dates of any one of the asbestos materials listed by selecting the asbestos material of interest. Outstanding checklists 1306 for the asbestos listing is also displayed. By selecting any one of the asbestos listings in the outstanding checklists 1306, information about the corresponding checklist for that asbestos listing will be displayed.

FIG. 13B is a screenshot 1310 of an asbestos register checklist for EPA 56496-020. The screenshot indicates monitoring frequency 1312, the area where the asbestos was found 1211, the person responsible for monitoring the asbestos material 1314, a due date for when this monitoring should occur 1315, and the status of the checklist 1316. Questions 1317 that pertain to the maintenance of the asbestos material are also shown with a corresponding answer that should be filled in by responsible person 1314. Control procedures for the asbestos material are also obtainable by selecting button 1318. Control procedures may include, but are not limited to, removing the asbestos material, monitoring the asbestos material for breaks or cracks, repairing the damaged asbestos material or encapsulating the asbestos material. An area 1320 is also provided for responsible person 1214 to enter corrective actions. A save and exit button 1324 will save all of the information entered into asbestos register checklist 1310. A done button 1322 will return the user to the previous menu.

Additional information from the selection of asbestos material from the register may also be shown. FIG. 13C is a screenshot 1330 showing additional information about asbestos EPA 56469-20. Additional information about the asbestos material (1332) includes, for example, information about the number of assessments, the date the last assessment was performed, the surveyor who performed the assessment, the exact location of the asbestos material (building, floor, position), a description of the asbestos material, product type, size, identification, and a photograph of the asbestos material is provided. Screenshot 1330 also provides material risk assessment and prioritization of that risk assessment (1334). A list of tasks to perform on the asbestos material is also provided (1336).

2. Report Management System

In one embodiment of the invention, a report management system is used to access reports from a central location for viewing by authorized viewers. The reports may include, but are not limited to, audit reports, supplier information reports, industry standard reports, etc. The report management system provides easy access to information obtained from a plurality of sources in one central location and cuts down on the amount of paper reports being sent directly to authorized viewers.

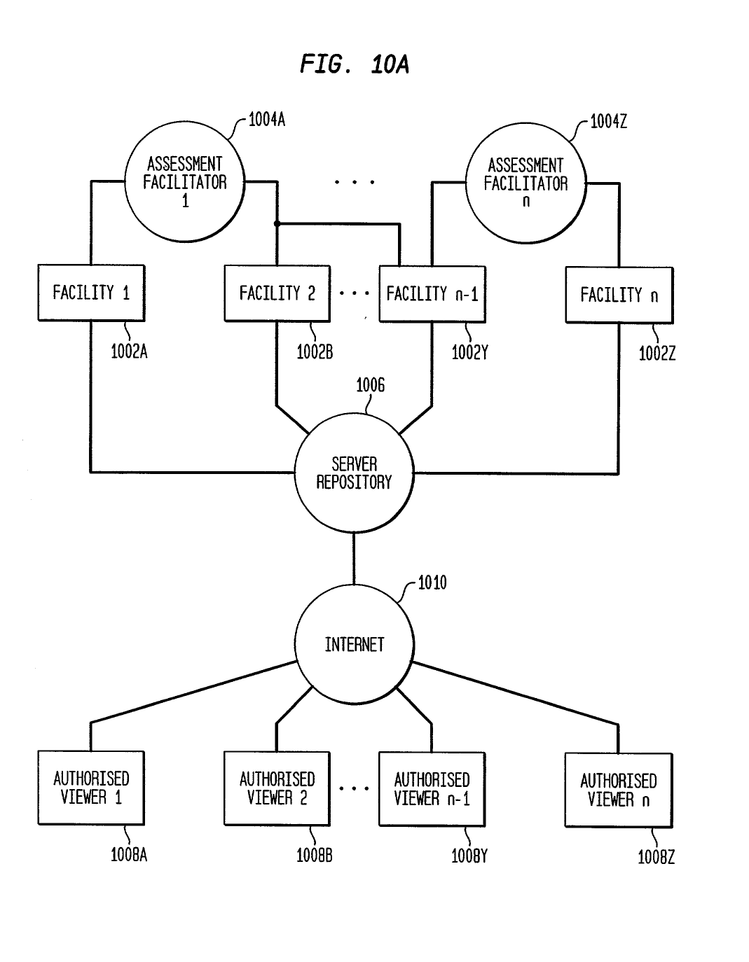

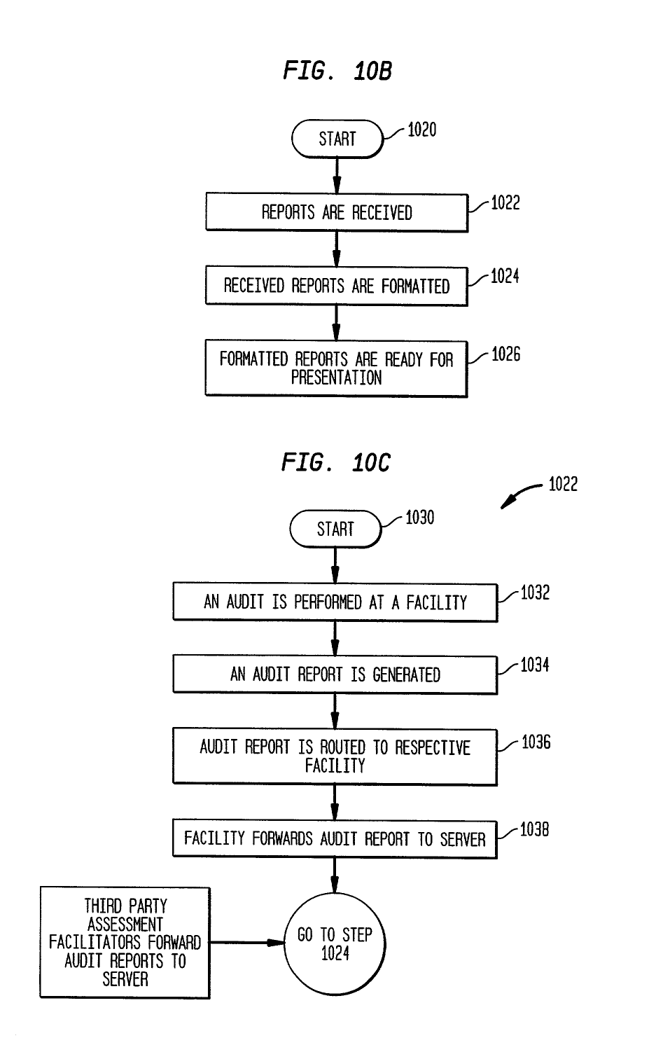

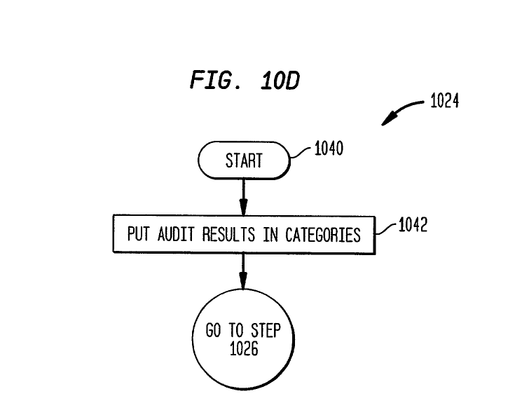

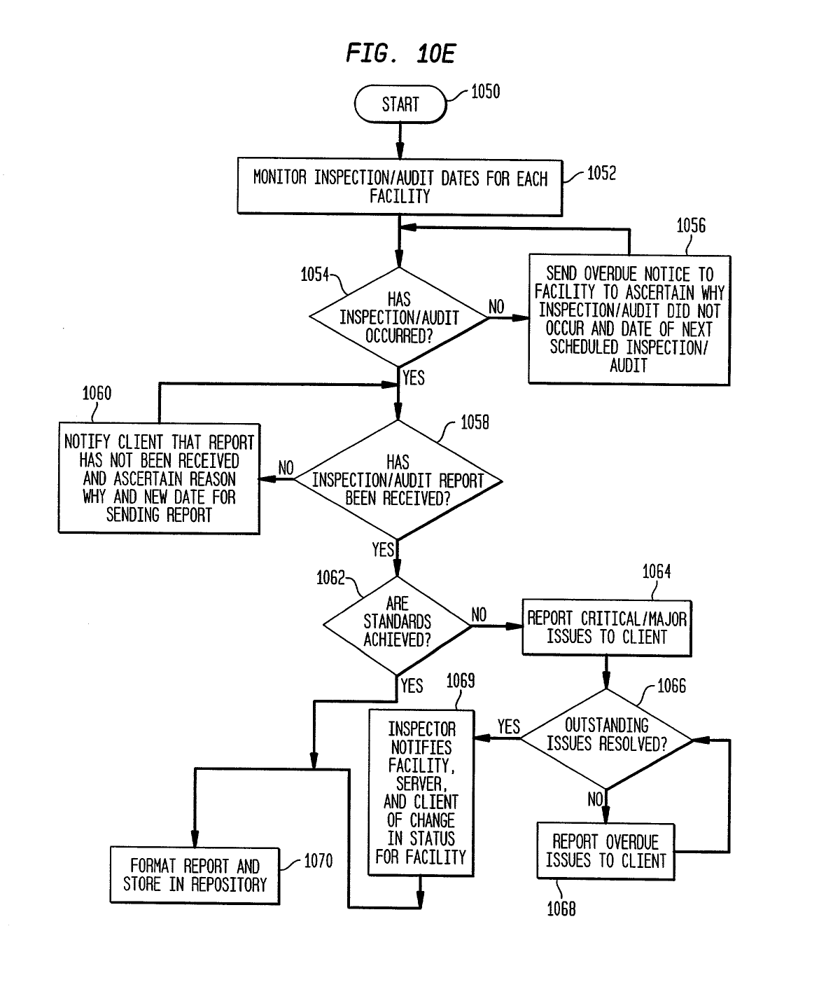

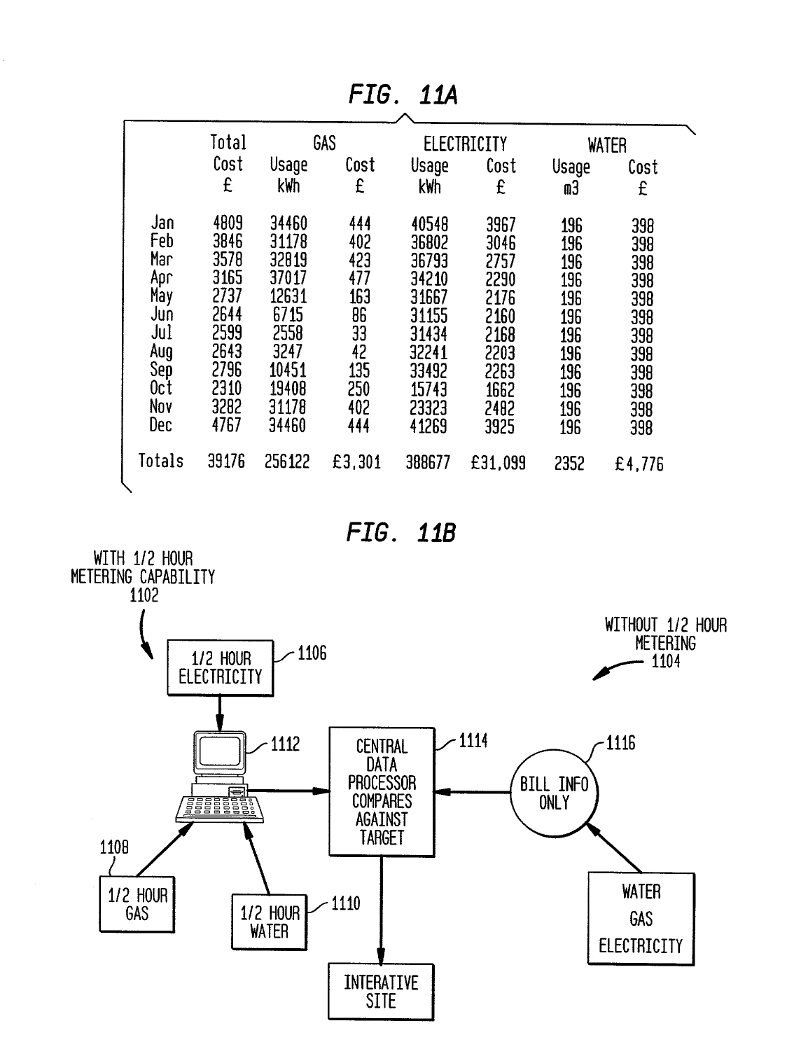

FIG. 10A is a block diagram illustrating an exemplary report management system 1000. Report management system 1000 comprises a plurality of facilities 1002, a plurality of assessment facilitators 1004, a server/repository 1006, and a plurality of authorized viewers 1008. Facilities 1002 may be, but are not limited to, a supplier of goods, such as a factory or an entrepreneur, a food chain, real estate, etc. Goods may include food, clothing, electronic goods, etc. Assessment facilitators are companies or establishments that provide inspectors to facilities 1002 to perform audits. Server/repository 1006 may be a computer, such as a server, that houses all of the reports. Authorized viewers 1008 may access server/repository 1006 via an Internet user interface 1010.

In one embodiment, facilities 1002, assessment facilitators 1004, and server/repository 1006 are connected via a computer network, such as a wide area network. Server/repository 1006 may be connected to Internet user interface 1010. Authorized viewers are provided access to server/repository 1006 via Internet user interface 1010. In other embodiments, authorized viewers may connect directly to server/repository 1006 via the wide area network (not shown). Authorized viewers may be, but are not limited to, clients, government agencies, or authorized third parties, such as an investor, a contractor hired by a client to fix what is ailing, etc. Authorized viewers 1008, such as clients, may obtain goods from a plurality of facilities, and therefore, will need to view reports from each of the facilities 1002. For example, authorized viewer 1008A may obtain goods from facility 1002A, facility 1002B, and facility 1002Z, while authorized viewer 1008B may obtain goods from facility 1002A, facility 1002Y, and facility 1002Z. In this instance, authorized viewer 1008A will need to view reports from facility 1002A, 1002B, and 1002Z, while authorized viewer 1008B will need to view reports from facility 1002A, 1002Y, and 1002Z. Authorized viewer 1008B will not automatically have access to any reports from facility 1002B because it does not obtain goods from facility 1002B. In one embodiment, authorized viewer 1008B could be given access to reports from facility 1002B at the request of facility 1002B. Even though facilities 1002A and 1002Z provide goods to both authorized viewers 1008A and 1008B, the reports from these facilities (1002A and 1002Z) are provided once to repository 1006. Thus, one report may be viewed by multiple authorized viewers 1008.

Also, an authorized viewer 1008 may be a client in which the client's own facility 1002 has been audited. In such an instance, the authorized viewer 1008 may view its own audit report from server/repository 1006 via Internet user interface 1010.

In one embodiment, more than one assessment facilitator may perform an audit for the same facility. For example, assessment facilitator 1004A and assessment facilitator 1004Z may both perform an asbestos audit on facility 1002Y. Also, each assessment facilitator 1004 may perform a specific kind of audit. For example, assessment facilitator 1004A may perform asbestos audits while assessment facilitator 1004Z may perform a health and safety audits.

Assessment facilitators that are not a part of report management system 1000, but who provide auditing services to one or more authorized viewers 1008, may be requested by such authorized viewers 1008 to become a part of report management system 1000, if the assessment facilitators want to maintain business relations with the authorized viewers 1008. This would eliminate authorized viewer 1008 of having to maintain paper copies of reports from more than one facility. By using server/repository 1006, authorized viewers may do electronic searches in a matter of seconds to locate certain information provided in the report. Also, summaries of the reports are also provided by server/repository 1006 according to categories. The naming of categories is discussed below with reference to FIG. 10C.

FIG. 10B is a flow diagram illustrating a method for providing reports to authorized viewers 1008 using report management system 1000. The process begins with step 1020, where the process immediately proceeds to step 1022.

In step 1022, reports are received by server/repository 1006. The process then proceeds to step 1024.

In step 1024, server/repository 1006 formats the data from each report for presentation. The process then proceeds to step 1026.

In step 1026, the formatted report data is presented to authorized viewers 1008 upon request. The process then proceeds to step 1028, where the process ends.

FIG. 10C is a flow diagram illustrating in more detail, a method for receiving audit reports. The process begins with step 1030, where the process immediately proceeds to step 1032.

In step 1032, an audit is performed by an assessment facilitator 1004. The process then proceeds to step 1034.

In step 1034, the assessment facilitator 1004 generates an audit report. The process proceeds to step 1036.

In step 1036, the assessment facilitator 1004 forwards the audit report to the respective facility 1002. The process then proceeds to step 1038. In one embodiment, a third party assessment facilitators may also forward audit reports to server/repository 1006 (step 1037).

In step 1038, facility 1002 forwards the audit report to server/repository 1006. The process then proceeds to step 1024, where the audit report is formatted.

FIG. 10D is a flow diagram illustrating in more detail, a method of formatting data for a report. The process begins with step 1040, where the process immediately proceeds to step 1042.

In step 1042, the audit results are categorized. The categories are chosen by authorized viewers 1008 that are clients. Authorized viewers are not limited in choosing categories. Categories are tailored to the client' needs. For example, authorized viewer 1008A is a fast food chain that obtains a large amount of produce from facilities 1002A and 1002Z. Authorized viewer 1008A has indicated that it wants its audit report categorizes to be pass/fail. An audit report for facility 1002A indicates that facility 1002 passed the audit. An audit report for facility 1002Z indicates that facility 1002Z failed the audit. When authorized viewer 1008A requests to see audit reports of its suppliers by status (in step 1026), facility 1002A will be displayed under the category PASS and facility 1002Z will be displayed under the category FAIL. The process then proceeds to step 1026, where the formatted report may be presented to authorized viewers 1008.

An exemplary business method for generating audits is provided in FIG. 10E. The process begins with step 1050, where the process immediately proceeds to step 1052. In step 1052, server/repository 1006 monitors the inspection dates for each facility 1002. Prior to the inspection date, server/repository 1006 will contact each facility 1002 to ascertain if the inspection or audit has been booked. Each facility 1002 contacted will provide server/repository 1006 with the actual inspection data booked and the assessment facility 1004 providing the inspection. The process proceeds to step 1054.

In step 1054, it is determined whether the inspection or audit has taken place. Server/repository 1006 will search its records to determine if they have received notice that the inspection/audit report has taken place for facility 1002. If notice of the inspection/audit has not been received, then server/repository 1006 will assume that the inspection/audit has not taken place, and the process will proceed to step 1056.

In step 1056, server/repository will send an overdue notice to facility 1002 to ascertain reasons as to why the audit has not taken place and to obtain a new date for the inspection/audit. The process then returns to step 1054 to determine whether the inspection/audit has occurred for the new date.

In step 1054, if it is determined that the inspection/audit has taken place, the process then proceeds to step 1058. In step 1058, it is determined whether the inspection/audit report has been received. Server/repository 1006 will allow the assessment facilitator a reasonable amount of time after the inspection has occurred to prepare the inspection/audit report. In one embodiment, the time allotment is two weeks, but this value may vary according to the client/authorized viewer 1008. If the inspection/audit report has not been received, the process proceeds to step 1060.

In step 1060, server/repository 1006 notifies client/authorized viewer 1008 that the inspection/audit report has not been received, and ascertains the reason for the delay. Server/repository 1006 also requests a date from client/authorized viewer 1008 as to when client/authorized viewer 1008 expects to receive the inspection/audit report. The process then returns to decision step 1058.

In decision step 1058, if the inspection/audit report is received by server/repository 1006, the process then proceeds to step 1062.

In step 1062, server/repository 1006 reviews the report to determine if all standards have been achieved. If all standards have not been achieved, the process proceeds to step 1064.

In step 1064, all critical/major issues of non-conformance are reported to client/authorized viewer 1008. The process then proceeds to step 1066.

In step 1066, it is determined whether the facility 1002 has resolved all outstanding non-conformances. Once facility 1002 has removed all outstanding non-conformances, facility 1002 must notify assessment facilitator 1004 of the rectification of all outstanding non-conformances. The assessment facilitator 1004 will then determine whether all of the issues have been resolved. If assessment facilitator 1004 determines that all of the issues have not been resolved, the process proceeds to step 1068.

In step 1068, assessment facilitator 1004 must report all overdue issues to client/authorized viewer 1008. The process then returns to step 1066.

In step 1066, if assessment facilitator 1004 determines that all of the issues have been resolved, assessment facilitator 1004 will then notify facility 1002 and client/authorized viewer 1008 of the change in Certificate status for facility 1002 (step 1069). Facility 1002 will, in turn, notify server/repository 1006 of the change in Certificate status and provide electronic copies of the certificate to server/repository 1006 (step 1069). The process then proceeds to step 1070.

Returning to step 1062, if all standards have been achieved, the process proceeds to step 1070.

In step 1070, the inspection/audit report is formatted accordingly and stored by server/repository 1006.

C. Computer Program Product

In an embodiment, the invention is implemented in one or more computer systems capable of carrying out the functionality described herein. For example, in an embodiment, the invention is implemented, at least in part, using Lotus Notes, available from IBM Corporation.

FIG. 1J illustrates an example computer system 160. Various software embodiments are described in terms of this example computer system 160. After reading this description, it will become apparent to a person skilled in the relevant art how to implement the invention using other computer systems and/or computer architectures.

The example computer system 160 includes one or more processors 162. Processor 162 is connected to a communication infrastructure or bus 164.

Computer system 160 also includes a main memory 166, preferably random access memory (RAM).

Computer system 160 can also include a secondary memory 166, which can include, for example, a hard disk drive 170 and/or a removable storage drive 172, which can be a floppy disk drive, a magnetic tape drive, an optical disk drive, etc. Removable storage drive 172 reads from and/or writes to a removable storage unit 174 in a well known manner. Removable storage unit 174, represents a floppy disk, magnetic tape, optical disk, etc., which is read by and written to by removable storage drive 172. Removable storage unit 174 includes a computer usable storage medium having stored therein computer software and/or data.

In alternative embodiments, secondary memory 168 can include other devices that allow computer programs or other instructions to be loaded into computer system 160. Such devices can include, for example, a removable storage unit 178 and an interface 176. Examples of such can include a program cartridge and cartridge interface (such as that found in video game devices), a removable memory chip (such as an EPROM, or PROM) and associated socket, and other removable storage units 178 and interfaces 176 that allow software and data to be transferred from the removable storage unit 178 to computer system 160.

Computer system 160 can also include a communications interface 180, which allows software and data to be transferred between computer system 160 and external devices. Examples of communications interface 180 include, but are not limited to a modem, a network interface (such as an Ethernet card), a communications port, a PCMCIA slot and card, etc. Software and data transferred via communications interface 180 are in the form of signals 182, which can be electronic, electromagnetic, optical or other signals capable of being received by communications interface 180. These signals 182 are provided to communications interface 180 via a signal path 184. Signal path 184 carries signals 182 and can be implemented using wire or cable, fiber optics, a phone line, a cellular phone link, an RF link and other communications channels.

In this document, the terms “computer program medium” and “computer usable medium” are used to generally refer to media such as removable storage units 174 and 178, a hard disk installed in hard disk drive 170, and signals 182. These computer usable media are means for providing software to computer system 160.

Computer programs (also called computer control logic) are stored in main memory 166 and/or secondary memory 168. Computer programs can also be received via communications interface 180. Such computer programs, when executed, enable the computer system 160 to perform the features of the present invention as discussed herein. In particular, the computer programs, when executed, enable the processor(s) 162 to perform the features of the present invention. Accordingly, such computer programs represent controllers of the computer system 160.

In an embodiment where the invention is implemented using software, the software can be stored in a computer program product and loaded into computer system 160 using removable storage drive 172, hard drive 170 and/or communications interface 180. The control logic (software), when executed by the processor(s) 162, causes the processor(s) 162 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

II. Detailed Example Architecture

As previously stated, FIG. 1C shows an example architecture of the e-Risk system 100 including a more detailed view of its components. Each component of FIG. 1C is described below.

FIG. 1C shows registration module 102. Registration module 102 is a pivotal part of the e-Risk system 100. Registration module 102 encompasses the functionality of setting up users for the e-Risk system 100 and defining access authorization for each user. Registration module 102 can encompass functionality for language translation for users of different languages. Registration module 102 can also encompass functionality for creating different disciplines.

FIG. 1C shows blank template module 104. Blank template module 104 encompasses the functionality of creating templates to be used for different disciplines and different clients. Blank audit assessment template module 120 can be used to define blank templates that can later be populated by persons creating and performing an audit. Within blank template module 104 is located blank audit assessment template module 120 and blank interactive assessment template module 116. Blank audit assessment template module 120 includes the functionality of creating templates for use with an audit. Blank interactive assessment template module 116 includes the functionality of creating templates for use in an interactive risk management and monitoring system. Blank interactive assessment template module 116 can also be used to define interactive templates that can later be populated by a chief consultant.

FIG. 1C shows discipline specific master template module 106. Discipline specific master template module 106 includes all of the templates for risk assessment and risk management that are relevant to a particular discipline. The templates within discipline specific master template module 106 are populated by a chief consultant. Located within discipline specific master template module 106 is discipline specific audit assessment template module 128 and discipline specific interactive assessment template module 104. Discipline specific audit assessment template module 128 includes the templates necessary for performing an audit pertaining to a specific discipline. Discipline specific interactive assessment template module 124 includes the templates for performing interactive risk management and risk monitoring relevant to a particular discipline.

FIG. 1C shows site specific files 108. Site specific files 108 includes the necessary files for performing audits and for interactive risk management and risk monitoring for a particular site. Included within site specific files 108 is a site specific audit assessment template module 136 and a site specific interactive assessment template module 132. Site specific audit assessment template module 136 contains the templates necessary for performing an audit for a particular site. A local consultant populates these templates which may pertain to one or multiple risks within the disciplines that pertain to his site. Site specific interactive assessment template module 132 contains all of the templates that are necessary for performing interactive risk monitoring and risk assessments for a specific site. Once again, a local consultant populates these templates which may pertain to one or multiple risks within the disciplines that pertain to his site. Site specific audit assessment template 136 is used for performing a benchmark audit which gives a snapshot of risk at one point and time. This module can also provide a report which may be used to better manage risk.

FIG. 1C shows optional reference files 110, which include any of a variety of types of information. These files include information relevant to learning how to use the e-Risk system 100, resource files that may contain statistics relevant to particular disciplines, or general reference materials pertaining to particular users. Included within reference files 110 is interactive template forms 140, news feed 144, and legislation 148. Interactive template forms 140 includes those template forms that are specific to a particular site that may be saved locally by the local site user. This can include templates created within site specific interactive assessment template module 132. News feed 144 provide a news service pertaining to risk management news. News may be delivered in a variety of ways. News can be sorted, selected and received by country, language, sector, discipline, clients, and products. In general, news feed 144 can be tailored to a particular site, client, or user. Legislation 148 is a repository containing copies or references to legislation pertaining to regulations that may affect the client or user. The response line team can be responsible for updating the database which is referenced by legislation 148 and the newsfeed which is sent to the end user.

FIG. 1D shows a more detailed description of discipline specific master templates module 106. Discipline specific master template module 106 is shown as being subdivided into two modules: discipline specific audit assessment module 128 and discipline specific interactive template module 124. The purpose of this division is to divide the risk management and risk monitoring capabilities of the e-Risk system 100 into two manageable groups. Discipline specific audit assessment template module 124 includes the templates used for performing a benchmark audit of a site pertaining to a particular discipline. A benchmark audit is a snapshot of risk at one point in time. The result of a benchmark audit is an assessment of how risk is being managed and controlled at the time of the audits. Discipline interactive template module 124 includes all of the templates for performing interactive risk management and risk monitoring of a site pertaining to a particular discipline. Interactive risk management and risk monitoring comprises the performance of risk assessments over time and or the performance of risk monitoring over time. Performance of risk management and risk monitoring comprises the performance of tasks that are completed over time.

FIG. 1D also shows that each template module can contain sub-modules which are sector specific. In other words, each template module can be further subdivided into sectors for easy access, lookup and ease of use. Discipline specific interactive assessment template module 124 shows multiple sector specific templates located within it. Each template within discipline specific interactive assessment template module 124 pertains to interactive risk management and risk monitoring information pertaining to a particular sector. For example, discipline specific interactive assessment template module 124 can pertain to the health and safety discipline. The first sector specific template within discipline specific interactive assessment template module 124 can pertain to the hotel sector. Thus, this sector specific template would include only the interactive risk management and risk monitoring information relating to health and safety for hotels. Another sector specific template within discipline specific interactive assessment template module 124 can pertain to supermarkets. Thus, this sector specific template would include only interactive risk management and risk monitoring information pertaining to health and safety for supermarkets.

In a similar way, discipline specific audit assessment template module 128 can be further divided into different sectors. Thus, the information contained in each sector specific file for discipline specific audit assessment template module 128 contains audit information pertaining only to a discipline for that particular sector. For example, if discipline specific audit assessment template module 128 pertains only to water safety, and the first sector specific file pertains only to apartments, then the first sector specific template would contain only audit information pertaining to water safety for apartments.

FIG. 1E shows user interface 112 as it relates to the rest of the e-Risk system 100. Specifically, FIG. 1E shows user interface 112 as it relates to audit capabilities. FIG. 1E shows audit central 180 as the central reference point that references all audit materials on the e-Risk system 100. FIG. 1E also shows multiple site specific files. In particular site specific files 108, site specific files 108A and site specific files 108B. Each of these site specific files represents a group of files for performing audits and performing interactive risk management and risk monitoring of a particular site. As shown in FIG. 1E audit central 180 directly links to the site specific audit assessment template module for each site specific file module. Thus, audit central 180 links directly to site specific audit assessment module 136, site specific audit assessment template module 136A and site specific template module 136B. In this way, audit central 180 is able to read the audit information directly from each site specific file module. e-Risk user interface 112 is directly linked to audit central 180. Thus, any user with a correct access authorization can view and interact with audit information and audit capabilities of any site via audit central 180.

In practice, this architecture is advantageous because it allows a user quick and easy access to all audit data pertaining to all sites. Thus, an environmental health consultant or regulatory official conducting an audit or setting up an audit for a company comprising many sites can access all the audit information for the entire company all at once. This allows for more efficient creation and performance of an audit. Furthermore, a user wishing to access audit information need only access one node, audit central 180, to access the desired audit information. This allows for quicker and less confusing access to audit information.

FIG. 1F shows Internet user interface 112A as it relates to the e-Risk system 100. e-Risk user interface 112A can be any web browser connected to a network, preferably the Internet. In an embodiment of the present invention Internet user 112A can be located on the computer of a user that is connected to a network, preferably the Internet. Therefore, the user of Internet user interface 112A can be located remotely from e-Risk system 100. In a similar way to user interface 112, Internet user interface 112A can access all functions of the e-Risk system 100. Therefore, Internet user interface 112A can be connected directly to reference files 110. Thus, a remote user would be able to access interactive template forms 140, newsfeed 144 and legislation 148. Likewise, Internet user interface 112A can access registration module 102. This would give the user of Internet user interface 112A the capability to create and manage users of e-Risk system 100. Internet user interface 112A can be connected directly to site specific files module 108. This would give the user of Internet interface 112A the capability to create and modify audit template and interactive templates for a particular site.

FIG. 1F shows Internet user interface 112A connected to the rest of the e-Risk system 100 in a manner similar to user interface 112. An advantage of the architecture of FIG. 1F is the distributed nature of the architecture. Specifically, all files and functionality related to risk management, risk assessment and risk monitoring can be located remotely from Internet user interface 112A. In other words, all relevant files pertaining to the e-Risk system 100 can be located in one location (an e-Risk server, for example), and a user of Internet user interface 112A need only have the capability of connecting to the Internet or other network. Therefore, this allows for easier access of e-Risk system 100. Furthermore, it allows for greater compatibility of e-Risk system 100 with systems of remote users because the system requires only that a remote user have an Internet or other network interface. With the wide popularity and expansion of the Internet, standard Internet browsers are widely available and can be easily accessed. This is beneficial because it allows for a greater user base of the e-Risk system 100.

This embodiment of the present invention is advantageous because it allows a user to be located remotely from the e-Risk system 100. This is beneficial because the nature of risk management often requires an auditor to travel to a site or to perform an audit at the site. This is also beneficial because it allows a risk management officer to monitor risk management from a location which is remote from a site. Furthermore, this is beneficial because it allows third party users such as regulatory officers to access and monitor risks that are located at remote sites. Moreover, it allows environmental scientists to participate in the process of managing and monitoring risks remotely. In general, this allows for a greater and more efficient exchange of risk management information over a larger geographical area.

FIG. 1G shows Internet user interface 112A as it relates to multiple clients. FIG. 1G illustrates the manner in which Internet user interface 112A can be used in conjunction with multiple clients that are located remotely from the user of Internet user interface 112A. In an embodiment of the present invention, Internet user interface 112A can connect to client A. In this embodiment, the user of Internet user interface 112A is located remotely from client A. Using this connection, the user of Internet user interface 112A may then avail itself of the capabilities of the e-Risk system 100. For example, the user of Internet user interface 112A can proceed to create templates that pertain to the site specific file module 108 for client A. Thus, the user can create audit files and interactive risk management and risk monitoring files for use in connection with the site pertaining to client A. In addition the user can access registration module 102 to review and manage authorized users of the e-Risk system 100. Likewise, the user of Internet user interface 112A can be connected directly to client N. Using this connection, the user can then avail itself of all of the capabilities of the e-Risk system 100.

FIG. 1G shows multiple clients accessing Internet user interface 112A. FIG. 1G shows that each client comprises multiple terminals. For example, client A comprises more than one terminal, each of which may access Internet user interface 112A. Likewise client N comprises more than one terminal, each of which may access Internet user interface 112A. In an embodiment of the present invention, Internet user interface 112A, as it is accessed by each client, can also be tailored to each particular client. Tailoring may involve aesthetic customizations such as color modifications, text modifications, additions of logos, or any other modification of Internet user interface 112A which makes the interface more aesthetically compatible to a client. Tailoring may also involve other more complicated modifications, such as modifications of the substance of certain interface pages, modifications as to processes performed by certain Internet interfaces, or modifications to the sequence of Internet interfaces as they are seen by certain clients. Tailoring can also involve modifications as to access authorization to Internet user interface 112A. That is, Internet user interface 112A can be modified so that only certain terminals within each client can access the interface. In an embodiment of the present invention, Internet user interface 112A can also be tailored to particular users within certain clients. Tailoring may involve changes to the environment as they are defined by particular users within a client. For example, a terminal within a client may specify a desire to read text of certain size or backgrounds of certain color. Internet user interface 112A supports these and other, more complicated modifications to the interface.

A. Registration Module

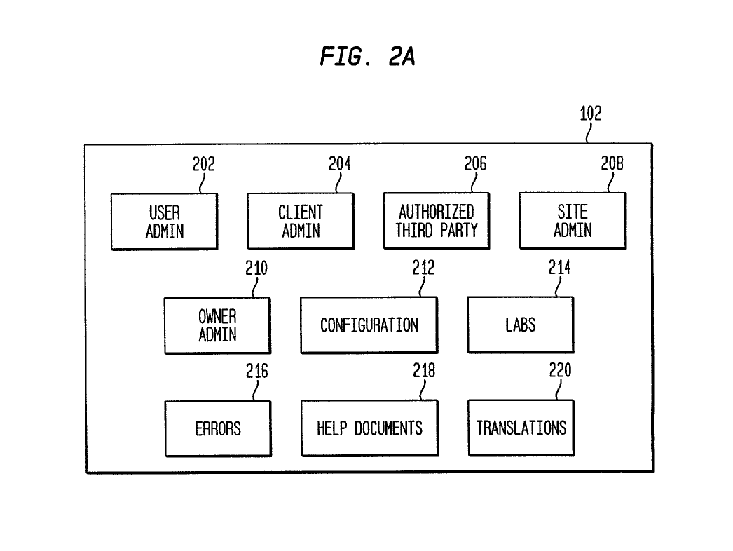

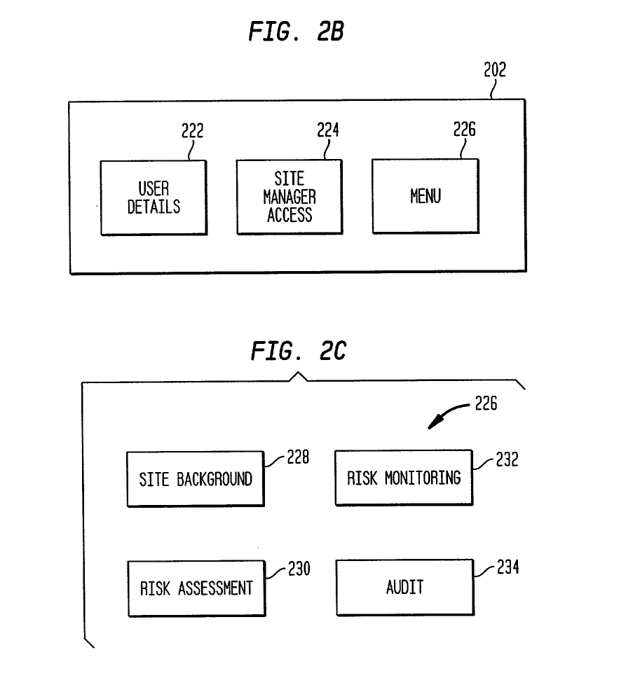

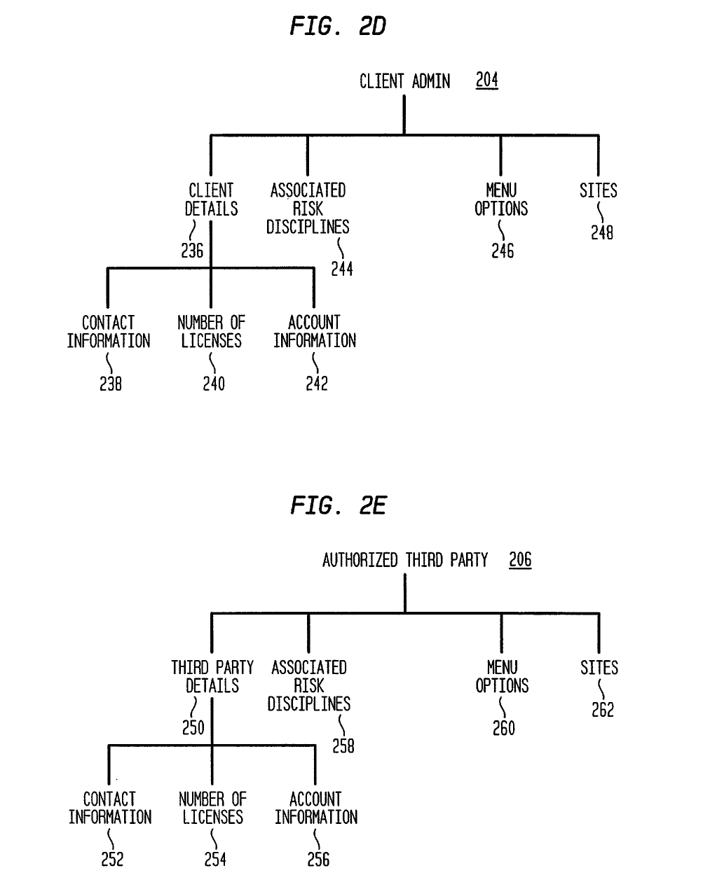

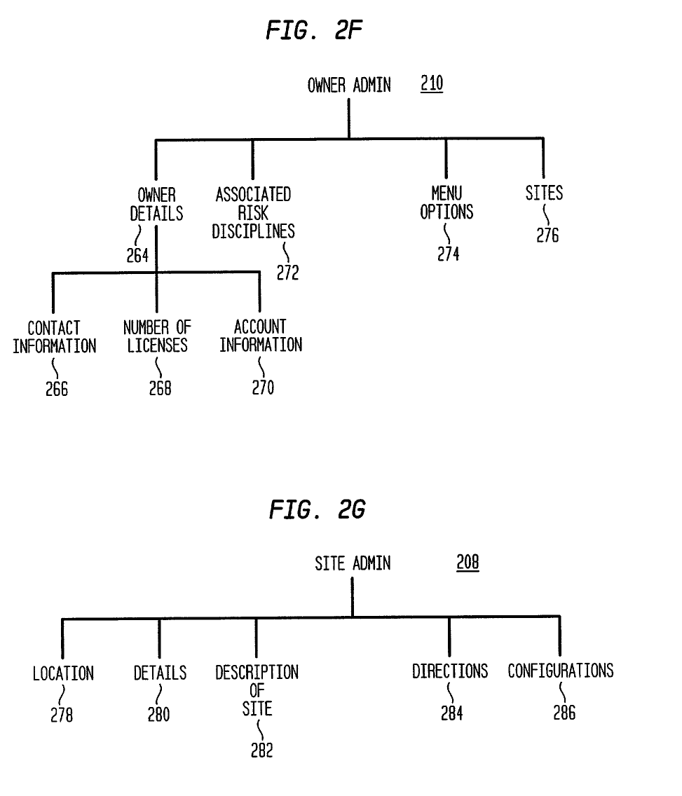

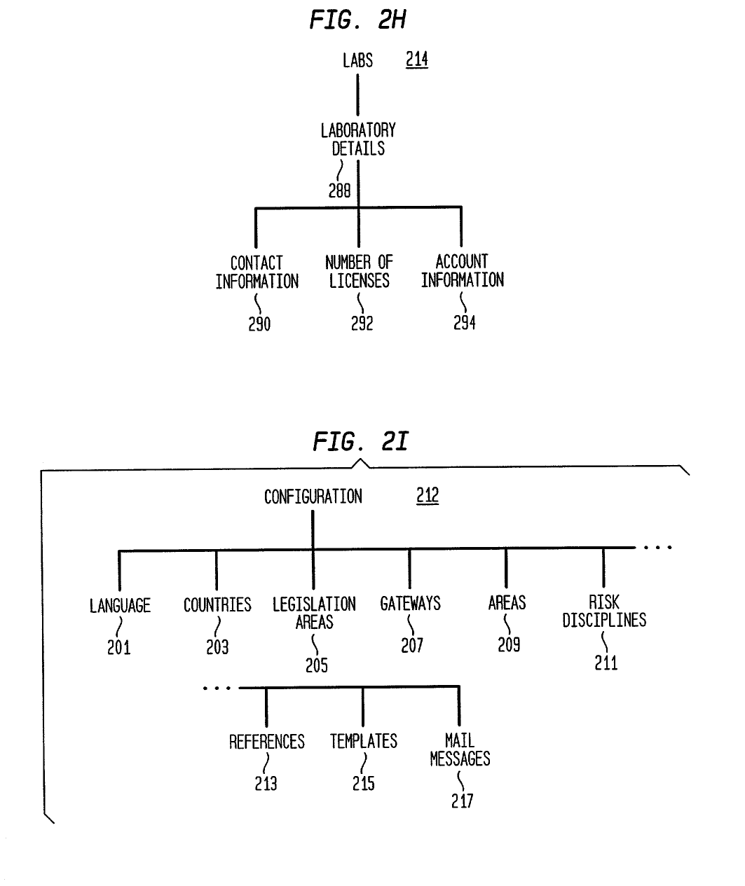

FIG. 2A shows a more detailed illustration of registration module 102. Registration module 102 includes user administration module 202. This module is used for creating new users, entering information associated with users, and setting up other variables associated with users. This module is also used for maintaining users. For purposes of this discussion, a user can be a client. A client refers to a company or other organization. A client can then, in turn, contain multiple sites. A site refers to a particular location within a client, i.e., a company. Therefore, a client can be a large department store chain, and a site may be one department store in that chain. A site can then, in turn, contain multiple individual users. An individual user refers to a person such as a worker or a manager. An individual user is generally an employee of the site to which it pertains.

FIG. 2A also includes client administration module 204. This module is used to register clients, enter information relating to clients and maintain clients. The information entered for a particular client is similar to that information entered for a user in the user administration module 202. This is explained in greater detail below.

FIG. 2A also shows authorized third party administration module 206. This module is used for creating authorized third parties and allowing them access to e-Risk system 100. An authorized third party can be any third party who wishes to access e-Risk system 100 to view information relating to a particular client or user. For example, an authorized third party can be a governmental body which necessitates review of compliance with particular regulations by a client.

FIG. 2A also shows site administration module 208. This module is used for creating sites within clients. A site can be viewed together with all of the risk disciplines associated with the site and all of the registered users associated with the site. For example, this module can be used to add new stores as sites to a department store chain client.

FIG. 2A shows owner administration module 210. This module is similar to the authorized third party administration module 206 in that it allows a particular user, the owner, to access information related to a particular client or user. Typically, this module is used to allow access to an owner of a client to all information relating to that client. For example, the president of a department store can be allowed access to the risk management files relating to the client of which it is president.

FIG. 2A also shows configuration module 212. This module contains all of the information that is necessary for configuring the e-Risk system 100. The information contained in this module relates only to general information necessary for configuring e-Risk system 100, not client specific or site specific information necessary for executing the e-Risk system 100. Only e-Risk system 100 managers or system administrators can have access to this module.

FIG. 2A also shows laboratory module 214. This module is used for allowing access to e-Risk system 100 for laboratories that are used for sampling. In other words, laboratories that are employed by the e-Risk system 100 for performing benchmark tests which are necessary for audits are allowed access to the e-Risk system 100. The purpose of this access is for laboratory employees to read from e-Risk those tasks that must be performed on physical specimens that have been taken from the site or client for the purposes of an audit. The results of the laboratory tests can then be written into the e-Risk system 100 by a laboratory employee. This is advantageous because it allows for an efficient relationship of the e-Risk system 100 with laboratories and allows for quicker results of laboratory tests to be conveyed to the e-Risk system 100 and to the client.

FIG. 2A also shows errors module 216. This module is used to store internal server errors that are generated by the e-Risk server. These errors can then be analyzed and used for maintenance of the e-Risk server.

FIG. 2A also shows help documents module 218. This module includes all of the help documents that are associated with the e-Risk system 100 and are made available to users of the system. Help documents may be tailored to certain clients, sites or users. Tailoring may involve modifications to the text colors or the substance of the help documents.

FIG. 2A also includes translations module 220. This module includes a reference list of every key word that exists in the e-Risk system 100. A keyword refers to a word that is listed on an interface that is viewed by a user of the e-Risk system 100. These keywords can then be translated into a different language when it is determined that the e-Risk system 100 is providing information to a user of a foreign language. Therefore, this module is used for translating in one place the information provided by the e-Risk system 100 into different languages. This is advantageous because it allows for rapid automatic translation of all parts of system 100 for greater availability of system 100 to a wide variety of users over different countries and languages.

For example, FIG. 1K illustrates an embodiment of the invention implemented for multiple languages. In this example embodiment, a primary-language discipline specific master template module 186 is generated from a blank template module 188. A secondary-language discipline specific master template module 187 is also generated from the blank template module 188.

The primary-language discipline specific master template module 186 includes a discipline specific audit assessment template module 190 and a discipline specific interactive assessment template module 189. Modules 189 and 190 both include computer code necessary for displaying information in the primary language.

The secondary-language discipline specific master template module 187 includes a discipline specific audit assessment template module 192 and a discipline specific interactive assessment template module 190. Modules 189 and 190 both include computer code necessary for handling information in both the primary language and the secondary language.

Site specific files 193 are generated from primary-language discipline specific master template module 186 and/or secondary-language discipline specific master template module 187. When site specific files 193 are generated from primary-language discipline specific master template module 186, the site specific files 193 are generated to display and receive user input in the primary language. However, when site specific files 193 are generated from secondary-language discipline specific master template module 187, the site specific files 193 are generated to display and receive user input in both the primary language and the secondary language.

This allows users of the site specific files 193 that are generated from secondary-language discipline specific master template module 187 to work with the site specific files 193 in either the primary or secondary language, depending upon a language in use at the user terminal.

For example, when a user terminal is enabled to display and receive user input in the primary language, the site specific files 193 will be displayed on the user terminal in the primary language. However, when the user terminal is enabled to display and receive user input in the secondary language, the site specific files 193 will be displayed on the user terminal in the secondary language.

This example is provided for illustrative purposes only. Other methods of providing language translations can be implemented. Based on the description herein, one skilled in the relevant art(s) will understand that other methods of providing language translations can be implemented. Such other methods are within the scope of the present invention.

FIG. 2B shows a more detailed illustration of user administration module 202. As described above, this module is used mainly for viewing, modifying, and maintaining the information relating to a user. FIG. 2B shows user details module 222. This module is used for entering detailed information pertaining to a user. This module can include the user's name, the user's address, the country in which the user is located, and the number of users having licenses for using e-Risk system 100 at a particular site. This module can also include the account number of a particular user, the telephone number of the user, the fax number of the user, and an email address of the user. A user name can be supplied by the e-Risk system 100. This name can be a specific code in which is embedded a client code, a site code, and a user code.

FIG. 2B also shows site manager access module 224. This module is used for defining access authorization of particular site managers associated with a particular site. Access authorization can include authorization to create new users for a site or for giving limited access to certain users.

FIG. 2B also shows menu module 226. This module is used mainly for defining access authorizations given for using certain functions of the e-Risk system 100. In other words, this module is used for defining which functions a particular user can access.

FIG. 2C shows a more detailed illustration of menu module 226. As explained above, menu module 226 is used for defining access authorization for certain users. FIG. 2C shows site background module 228. This module contains background information relating to a particular site. This can include site details such as a site plan, legislation affecting the site, a policy statement regarding certain aspects of the site, particular responsibilities pertaining to a site, a skills matrix of skills pertaining to the workers on the site, a directory of site information, and interactive templates for reports that may be used by a particular site.

FIG. 2C also shows risk assessment module 230. This module is used for defining the risk assessment functionality that may be assessed by a user. This functionality includes: identifying hazards, risk assessment of control hazards, and creation of a full task list associated with controlling risk. A task list is used for specifying responsibilities of particular workers, specifying risk monitoring tasks that must be accomplished, and the frequencies in which these tasks must be accomplished.

FIG. 2C also shows risk monitoring module 232. This module defines all of the functionality associated with risk monitoring that can be accessed by a user. This functionality includes: production of a check list calendar that is used to define daily checklists associated with an entire site, production of personal checklists for use by individuals with certain responsibilities at the site, production of outstanding checklist items which can be used to assess due diligence assessments associated with a particular site and which may be sent to a higher authority in the event of non-compliance and production of action reports describing tasks that must be completed as a result of a risk assessment in order to comply with regulations.

FIG. 2C also shows audit module 234. Audit module 234 contains all of the functionality associated with performing audits. This functionality includes: performance of audits, the creation of external audits reports including scores and analyses and the listing of standards against which audits are taken.

FIG. 2D shows a more detailed illustration of client administration module 204. This module is similar to user administration module 202. FIG. 2D shows client details module 236. This module includes detailed information of a particular client. This detailed information may include company contact information 238, account information 242, and the number of licenses 240 for e-Risk that are located at a particular client. Additional information relating to a client may exist in this module. FIG. 2D also shows associated risk discipline module 244. This module is used to define the disciplinary risks that are associated with a particular client. For example, a particular client can be associated only with the occupational health disciplines. This would encompass certain risks that are associated with a particular client and, thus, would give a more clear view of the risks associated with a particular client. FIG. 2D also shows menu options module 246. This module is used to define the access authorization of a client to certain functions of the e-Risk system 100. These functions are described in more detail in FIG. 2C above. FIG. 2D also shows sites module 248. This module includes information on all of the sites associated with a particular client. For example, if a client is a department store chain, this module would include all of the information on the department store locations associated with the department store chain.

It should be noted that, in an embodiment of the invention, individual users are added to the e-Risk system 100 via the client administration module 204. This is because users must be associated with a client before they can be created. Therefore, a client must first be created and then users are added to a particular client.

Clients details module 236 can include contact information module 236 for including company contact information associated with the client, number of licenses module 240 which defines the number of licenses for the e-Risk system 100 associated with a particular client, and account information module 242 for defining the particular account number associated with a client.

FIG. 2E shows authorized third party module 206. This module is similar to client administration module 204. Third party details module 250 includes details associated with the third party that is viewing information associated with a site, user or client. Contact information module 252 is used for storing information relating to contacting the third party. Number of licenses module 254 defines the number of licenses for the e-Risk system 100 that are associated with the third party. Account information module 256 defines the account number for the third party. Associated risks disciplines 258 module defines the risk disciplines that may be viewed by the third party. Therefore, the third party, in an embodiment of the invention, can select certain disciplines for which desires to gather or view information. Menu options module 260 is similar to menu options module 246 for the client administration module. Menu options module 260 is described in greater detail in FIG. 2C above. Sites module 262 is used for defining the sites that are associated with the client that is being viewed by the third party.

FIG. 2F shows owner administration module 210. This module is similar to client administration module 204. Owner details module 264 includes detailed information associated with the owner desiring to view and access information associated with a particular client or user. Contact information module 266 defines the information for contacting the owner. Number of licenses module 268 is used for defining the number of licenses for accessing the e-Risk system 100 that are associated with owner. Accounts information module 270 is used for defining the account information associated with a particular owner.

FIG. 2F shows associated risk disciplines module 272. This module is used for defining the risk disciplines for which the owner desires to view information. Thus, the owner can limit the information that is being viewed. Menu options module 274 is similar to menu options module 246 within client administration module 204. This module is used for defining the access authorization of the owner to certain function of the system. This module is described in greater detail in FIG. 2C above. Sites module 276 is used for defining the sites that are associated with a particular client.

FIG. 2G shows sites administration module 208. This module is used for defining information that is associated with a particular site. Location module 278 is used for defining information relating to a particular site such as the address of the site, a contact at the site, and a number for the site. Site details module 280 is used for storing other information regarding the site. This may include, the name of the client, the authorized third party for that site, the language of the site, the manned status of the site, the compliance percentage of the site, a compliance log for the site, the name of the owner of the site, the sector associated with the site, a list of the templates used for the site, the maximum number of licenses for the system associated with that site, and an icon for indicating whether the site is ready for execution of a checklist.

Description module 282 is used for defining a short text description of the site. For example, in this module, one may enter text such as “a 2,000 square foot manufacturing facility, including 15 washers and 20 dryers.” Directions module 284 is used for storing driving or walking directions to the particular site. Configurations module 286 is used for entering certain interactive information regarding a site. This module can include a time period for defining the initial review of a worker at the site, a location associated with a particular worker at the site, and the number of reviews associated with a worker per year.

FIG. 2H shows a more detailed illustration of the laboratories module 214. This module is used for entering information associated with certain laboratories that are employed for performing tasks associated with certain audits performed by the system. Laboratory details module 288 is used for storing certain information associated with a laboratory. This may include contact information for the laboratory, name and address of the laboratory 290, the number of licenses associated with the laboratory for using the system 292, and account information 294 for storing the account number for the lab.

FIG. 2I shows a more detailed illustration of configuration module 212. This module is used for defining certain customizable elements of the system. The changes made to configuration module 212 is propagated to all users of the system. The following is a list of features that may be configured. Language module 201 is used for defining all languages that are supported by the system. Countries module 203 is used for defining all of the countries that are supported by the system. Legislation areas module 205 is used for defining the legislation areas (areas effected by certain legislation) that are supported by the system. Gateways module 207 is used for defining the regional airports that are supported, or that may be defined by the system. Areas module 209 is used for defining the regional areas that are supported, or that may be defined in the system. Risk disciplines module 211 is used for defining the risk disciplines that are supported by the system. References module 213 is used for defining all of the references that are made available to clients by the system. This may include data references, such as statistical data and editable forms for entering information into the system. Template module 215 is used for defining a list of editable templates that may be used for entering information into the software. These are templates that may be used throughout the system. Mail messages module 217 is used for defining the types of email messages that may be sent using the system. For example, one type of email that may be defined is an email regarding non-compliance with a regulation. This type of email may be used to send an email regarding non-compliance to a person with authority for remedying the non-compliance.

Within each risk discipline module 211 a variety of information may be stored regarding each risk discipline. The following information may be stored: a risk discipline code, a risk discipline name, a user group name pertaining to the consultants that are relevant to a particular risk discipline, a list of other members of the same user group, the internal name of an interactive manual used for risk management and the monitoring of a particular risk discipline, the internal name of the audit manual used for auditing within a particular discipline, and menu options containing functions that can be associated with a particular risk discipline. These menu options are further defined in FIG. 2C above.

B. Blank Templates Module

FIG. 1C shows blank templates module 104. This module is used to create the templates necessary for performing interactive risk management and risk monitoring and for performing audits. These templates are created and modified by information technology specialists responsible for the e-Risk system 100. These templates are generic and do not contain any discipline-specific or site-specific information. With regards to blank audit assessment template module 120, this module is used for creating blank generic templates that will be used for auditing. Such a blank generic audit template would include such generic information as an audit definition or an audit type. Likewise, blank interactive assessment template module 116 is used for creating blank generic templates for use in interactive risk management and monitoring. Such a blank generic template would include such generic headings as: a policy statement, a list of responsibilities, a list of job titles, a list of skill definitions, a list of relevant legislation, a list of pertinent forms, a list of risks, a list of control measures for each hazard, and a status code for each control measure, and a list of keywords for possible translation. The templates created by blank templates module 104 can then be populated by a chief consultant.

C. Discipline-Specific Master Templates

FIG. 1C shows discipline specific master template module 106. This module is used for defining the templates that are used for a particular discipline. These templates are used to create the site specific templates used for both performing audits relevant to a particular discipline, and for performing an interactive risk management and monitoring associated with a particular discipline. The templates located within discipline specific master templates module 106 are created by chief consultants.

FIG. 1C shows discipline-specific master templates module 106B. This module is used for defining templates for auditing and for performing interacting risk management and risk monitoring pertinent to a particular further discipline. These templates are populated by a chief consultant. A chief consultant uses the blank templates produced by blank templates module 104 to create the templates for module 106B.

1. Discipline-Specific Audit Assessment Template Module

Discipline-specific audit assessment template module 128 is used to create audit templates for use with a particular discipline. Each discipline specific audit template contains a variety of information. This information includes: The identity of the pertinent discipline, the risk sector of that discipline, the acceptance standards associated with the audits, a code associated with a passing grade for the audit and a default pass score associated with a passing grade of the audits. Furthermore, a discipline-specific audit assessment template can include: audit sections which divide up an audit into different areas, audit standards which reference legislation pertinent to the audit, audit questions used during the audit (which can include a question, a question number, a sector for the question and the discipline pertaining to the question), audit replies to the questions, recommendations associated with the replies (such that a recommendation can be given if there is an adequate reply to a question), and a number of points that is related to each answer.

2. Discipline-Specific Interactive Assessment Template Module

FIG. 1C shows discipline-specific interactive assessment template module 124. This module is used for defining templates for use with interactive risk management and risk monitoring of a particular discipline.

Discipline-specific interactive assessment template module 124 is used for creating discipline-specific templates for use in interactive risk management and risk monitoring pertinent to a particular discipline. The information located on a discipline-specific interactive assessment template can include the following: a general statement of the client, a policy statement of the client, a list of responsibilities of each employee, a list of legislation pertaining to each employee according to his responsibilities, a list of skills pertaining to each worker of the site, a list of training associated with each skill, a list of legislation that is applicable to the particular discipline, a list of forms pertinent to the particular discipline (for example, an accident report form), a list of all potential risks based on legislation and best practices, a list of all work activity, a list of hazards, a list of specific legislation pertaining to that discipline, a list of control measures for each hazard, a status indicator for each control measure, a list of monitoring questions associated with each control measure, and a reference list of each keyword used in the module for possible translation. The template can also include a check items list of all risks associated with a particular discipline. The template can also include a list of procedures pertinent to the discipline.

D. Site-specific Files

Site-specific files module 108 contains all files relevant to a specific site. These files are then used and populated by a local consultant located on the site. Site-specific audit assessment template module 136 contains all audit related files pertaining to a site. These files include the discipline-specific audit assessment template module 128 files that were created by a chief consultant. These files are then used at a specific site to perform an audit. Furthermore, these files contain all of the information that is input by a local consultant during an audit. This includes all data that is transferred, including scoring information, audit report information and copies of audit answers, questions and recommendations. Site-specific interactive assessment template module 132 contains all interactive related files related to a particular site. These files include the files that were created by discipline-specific interactive assessment template module 124. These files also include all of the information that was entered by a local consultant during interactive risk management and risk monitoring at site. This includes any risk assessment files that were created during risk management and monitoring, any defect reports that were generated after risk management and monitoring, and any follow-up risk assessment forms that were created after risk management and risk monitoring.

III. Example Processes

A. Adding a New Discipline

A new discipline is added to the system through the generation of a discipline master manual. In one embodiment, an Information Technologist has the responsibility of generating the discipline master manual. There are two types of discipline master manuals that must be generated when a new discipline is added to the system. The first is an interactive master manual and the second is an audit master manual.

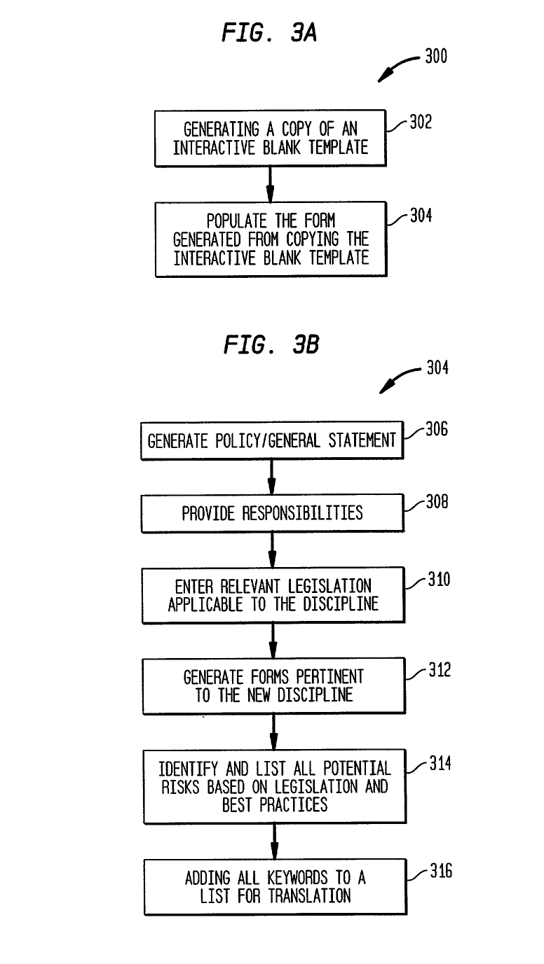

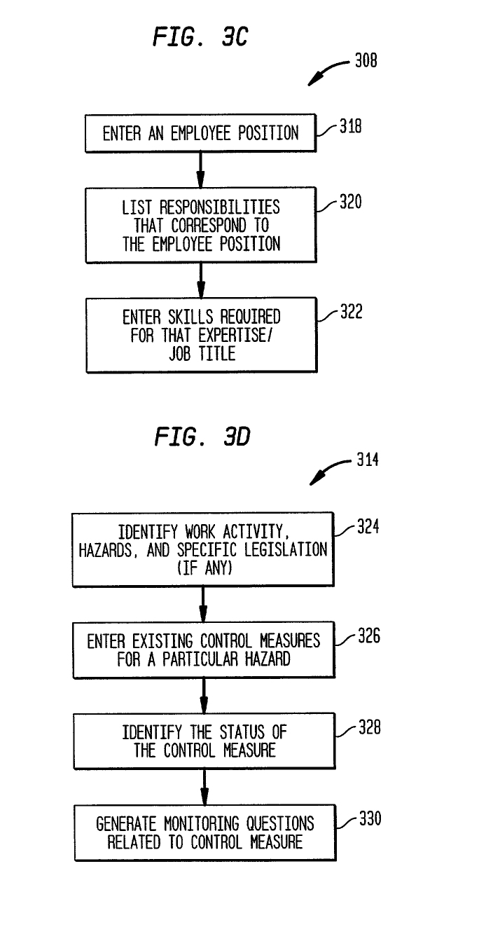

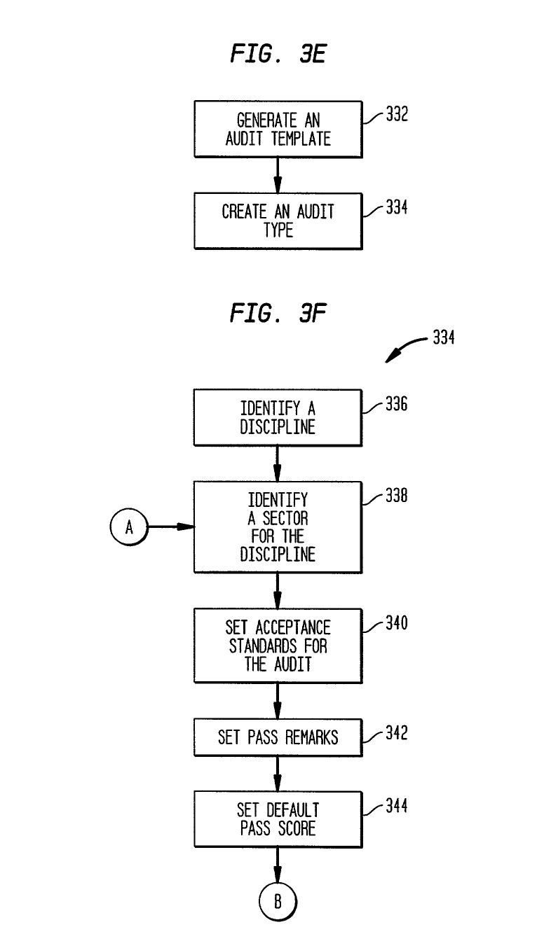

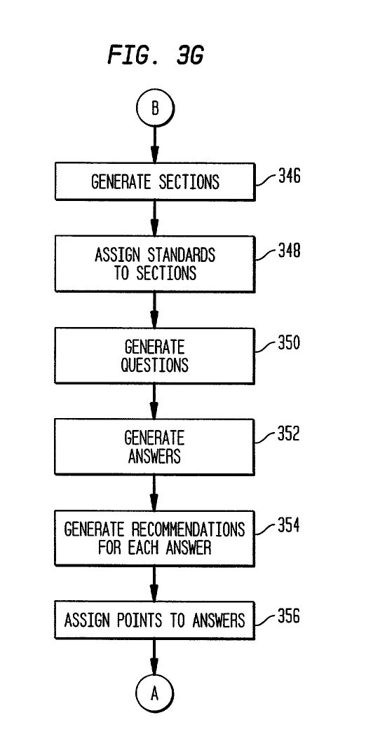

FIG. 3A is a flow diagram illustrating an exemplary method for developing an interactive master manual for a new discipline. The process begins with step 302. In step 302, an interactive form is generated by copying an interactive blank template from interactive master template 116. During this step, the new discipline is named and permissions are provided for populating and using the new discipline. The process then proceeds to step 304.

In step 304, the interactive form is populated to generate the new discipline. The interactive master manual for the new discipline is the completed interactive form. In one embodiment, an environmental health consultant (EHC) has the responsibility of completing the discipline master. An environmental scientist (ES) may also have this responsibility.

FIG. 3B is a flow diagram illustrating the population of the interactive form to generate the interactive master manual for a new discipline. In step 306, a general policy statement is provided. The general policy statement provides the general aims of an organization based on the particular discipline that is being generated. The process proceeds to step 308.

In step 308 employee responsibilities are defined.

FIG. 3C is a flow diagram illustrating the allocation of responsibilities according to the current discipline being created. In step 318 an employee position or job title is entered. The process then proceeds to step 320.

In step 320, the responsibilities that correspond to the employee position are provided. It is important that employees are only made responsible for those matters in which an employee is deemed to be competent. Control then passes to step 322.

In step 322, a list of skills required to perform the responsibilities listed in step 320 are entered. In one embodiment, the skills entered must be listed in a skills matrix. If the consultant enters a skill not found in the skills matrix, the system will automatically display a new field in the skills matrix for enabling the consultant to add the new skill to the skills matrix. In another embodiment, the consultant must add the new skill to the skills matrix prior to allocating responsibilities. The skills that are entered are those skills for which an employee demonstrates competence in order to accomplish the responsibilities provided in step 320. For example, suppose the new discipline being added is food safety and the employee position is for a chef. The responsibilities for such a position may be to prepare food safely and under hygienic conditions. A skill required to perform those responsibilities may be for the employee to have earned a food hygiene certificate.

Returning to step 308 in FIG. 3B, the process then proceeds to step 310. In step 310, relevant legislation applicable to the discipline is entered. In one embodiment, the actual text of the legislation is entered. One could also enter a citation to the actual legislation. In an embodiment, one could enter a link to a relevant section of the legislation. The link would be a hypertext link. The process then proceeds to step 312.

In step 312, forms pertinent to the new discipline are generated. In one embodiment, the forms are generated from government publications. In an embodiment, forms may be generated by a health and safety executive. The forms may be interactive or non-interactive forms. An example of a form generated that is pertinent to a new discipline may be an accident report form. In an accident report form, an employee would report an accident that occurred on the job.

In step 314, all potential risks based on the legislation provided in step 310 and best practices are identified. Risks are the likelihood of a hazard occurring. For example, suppose the discipline is food safety and the hazard is anything with the potential to cause food poisoning or food contamination. A potential risk may be the use of mayonnaise that was not properly refrigerated or packaged. The use of such mayonnaise may cause food poisoning.

FIG. 3D is a flow diagram describing the process used to identify all potential risks for a particular discipline based on legislation and best practices. In step 324 work activity hazards and specific legislation, if there is any, are identified. For example, a work activity could be, may be, cooking in the kitchen of a restaurant. An example of a hazard may be the potential risk of burns to employees working in the restaurant. The risk associated with that hazard may be an employee being burned by the flame from a gas stove or by the touch of an oven operating at a temperature of 500 degrees or higher. Specific legislation pertaining to that risk may be that flames on a burner should never exceed a height of one-fourth of an inch or that heat from an oven must be contained within and not be hot to the touch on the door of the oven.

In step 326, control measures for a particular hazard defined in step 324 are entered. Control measures may be negative control measures for the risk or affirmative control measures for the risk. A negative control measure for the risk may be a statement describing when additional control measures are needed. An example may be that a first aid box must be checked daily to see if it is not full to capacity. An affirmative control measure may be a statement describing when existing control measures are adequate. An example may be that a first aid box must be checked and filled daily to insure that it contains the necessary equipment to aid an injured person.

Procedures are also associated with control measures. A procedure indicates how to comply with the control measure. The process then proceeds to step 328.

In step 328, the status of the control measure is identified. The status of a control measure may be critical or legal, major or best practice, or minor. A critical or legal status indicates a risk of violating current legislation. A major or best practice status indicator indicates a fairly high risk of impending injury. A minor status indication should be indicated when there is a remote or small risk of injury. The process then proceeds to step 330.

In step 330, questions are generated that relate to monitoring the control measures. These questions allow a user of the system to monitor risk by answering monitoring questions. For example, a monitoring question may be: Are the first aid boxes full? In one embodiment, monitoring questions can be customized. Such customized questions may include frequency and the amount of time in which a user has to answer the question before it effects compliance with the legislation.

Returning to step 314 in FIG. 3B, the process then proceeds to step 316. In step 316, all key words defined in the newly generated discipline are added to a list for translation. When a user in a foreign country uses the newly generated discipline, a translation system will translate each keyword in the list to the local language.

In one embodiment, a list of all risks by category, together with a control measure for each risk and a monitoring question that is associated with the control measure may be found in a checklist of items. In an embodiment, procedures can be listed by category. One may also view procedures by how relevant they are to certain control measures.

The present invention establishes new auditing procedures by generating an audit master manual for a specific discipline. FIGS. 3E, 3F, and 3G illustrate an exemplary method for developing an audit master manual for a new discipline. Referring to FIG. 3E, the process begins with step 332. In step 332 an audit template is generated. Audit templates are generated by copying an audit master template from audit master template 120 in blank template files 104 and naming the audit template according to the specific discipline involved. The process proceeds to step 344.

In step 344, an audit master manual is created. The audit master manual is the result of populating the audit template.

FIGS. 3F and 3G illustrate a method for populating an audit master manual. Referring now to FIG. 3F, in step 336, a discipline is identified. Previous disciplines include fire safety, food safety, water safety, asbestos safety, health and safety, and occupational safety. The discipline for the new audit may be, for example, toy safety. The process proceeds to step 338.

In step 338, a sector for the discipline named instep 336 is identified. For example, a sector for toy safety may be a playpen or a playground. In yet another example the discipline may be water safety and the sector may be a care home. The process then proceeds to step 340.

In step 340, acceptance standards for the audit are defined. In one embodiment, acceptance standards are color coded. For example, red may be an acceptance standard of 30-44%, yellow may be an acceptance standard of 45-59%, blue may be an acceptance standard of 60-79%, and green may be an acceptance standard of 80-100%. Color coding acceptance standards is an incentive to encourage users to move to the next color coded level.

In step 342, pass remarks are set. Pass remarks are remarks pertaining to the acceptance standard in which a sector has achieved. The process then proceeds to step 344.

In step 344, a default pass score is set. A default pass score is generated to indicate a the minimum basic score indicating a pass. For example, the default pass score may be 50%. This would mean that everything in the yellow range (from the example stated above) is not an acceptable standard.

An audit is comprised of sections, and each section is comprised of questions. Referring now to FIG. 3G, in step 346, sections are generated. In one embodiment, an audit is comprised of 50 sections. The process then proceeds to step 348.

In step 348, standards are assigned to each section. The process then proceeds to step 350.

In step 350, questions are generated for each section. The questions pertain to safety measures that must be performed in order to be in compliance with the legislation. The process then proceeds to step 352.

In step 352, answers are generated for each question provided in step 350. The process then proceeds to step 354.

In step 354, recommendations for each answer are generated. For example, a non-compliant answer would require that a task be performed to remedy the non-compliance. The recommendation would be to perform the specific task to remedy the non-compliance. The proceeds to step 356.

In step 356, points are assigned to each answer. In one embodiment, points never exceed the value of 2 for the highest generated answer. The process then returns to step 338 (in FIG. 3F) where additional sectors for the discipline are identified. Steps 340-356 (in FIGS. 3F and 3G) are repeated until all sectors have been addressed.

Note that in one embodiment, there are 50 sections to an audit. A section may contain one or more questions, but usually does not exceed six questions. For example, if hotels is a sector, then a section could be bedrooms in the hotel. Another section could be fitness areas, such as a pool, gym, etc. within the hotel. Another section could be a kitchen within the hotel.

B. Performing Benchmark Audits

The present invention enables a user to perform benchmark audits. In one embodiment, benchmark audits allow a user to compare their site against an industry standard. The industry standard may include, but is not limited to, other sites within the user's area, other sites outside of the user's area, other areas defined by the user, gateways, countries, and tour operators. A user may also compare one area, site, gateway, country, or tour operator against another area, site, gateway, country, or tour operator. One skilled in the relevant art(s) would know that there are other comparison categories that may be selected for performing a benchmark audit without departing from the scope of the present invention.

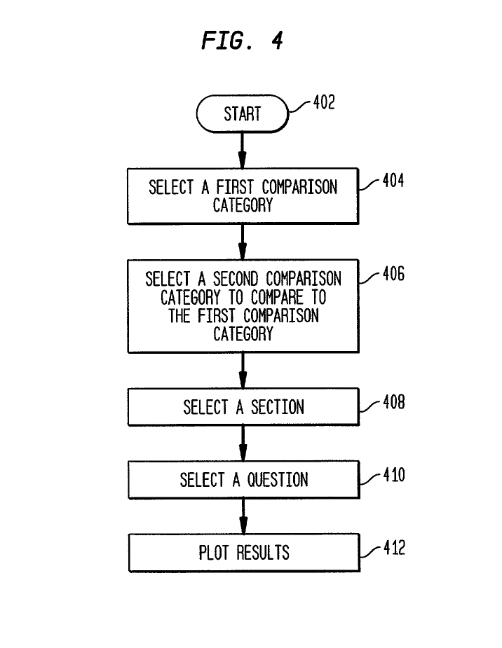

An exemplary process for performing a benchmark audit is illustrated in FIG. 4. The process begins with step 402, where the process immediately proceed to step 404.

In step 404, the system enables a user to select a first comparison category. The first comparison category may be the user's site, another site, an area define by the user, a gateway, a tour operator, or a country. The process then proceeds to step 406.

In step 406, the system enables a user to select a second comparison category to compare to the first comparison category. The second comparison category may be an area define by the user, another site within the user's area, another site outside of the user's area, a gateway, a tour operator, and a country. The process then proceeds step 408.

In step 408, a user may optionally select a section for comparison. Within an audit, each sector may be divided into sections. For example, a sector may be a hotel and a section may be bedrooms and/or kitchens within the hotel. In one embodiment, an audit is comprised of fifty questions. Each section may have 1-6 questions. Thus, a user may limit the benchmark audit to a particular section within a sector. The process then proceeds to step 410.

In step 410, the user may optionally select a single question within a section to be benchmark. The process then proceeds to step 412.

In step 412, after all comparison criteria has been entered, the results are plotted. In an embodiment, the results are plotted when the user selects a plot results button. In one embodiment, the results are plotted on a bar chart graph. In another embodiment, the results are plotted on a line graph. One skilled in the relevant arts would know that other types of graphs may be used to plot the results without departing from the scope of the present invention.

C. Establishing Interactive and Audit Sites for Risk Assessment and Management

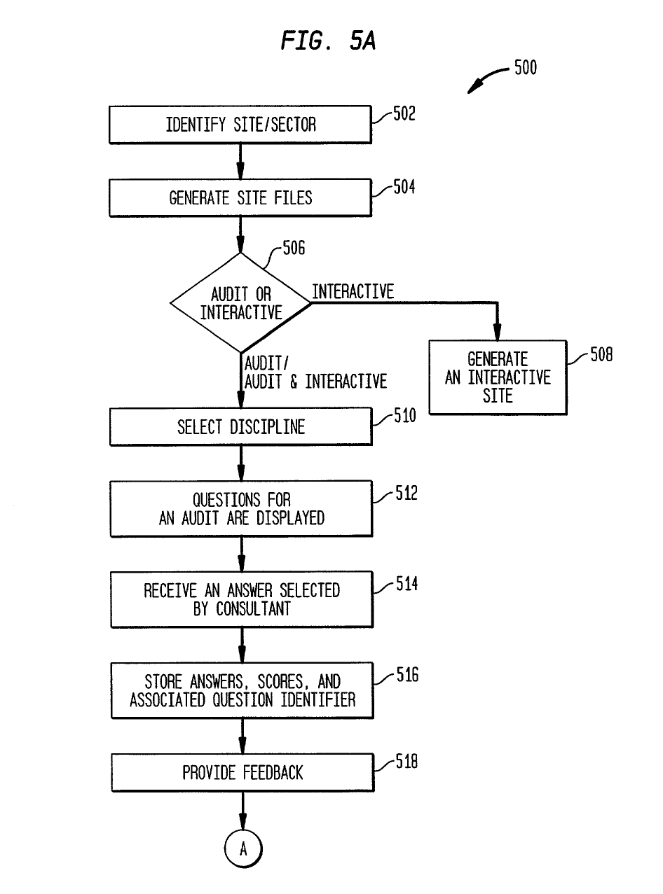

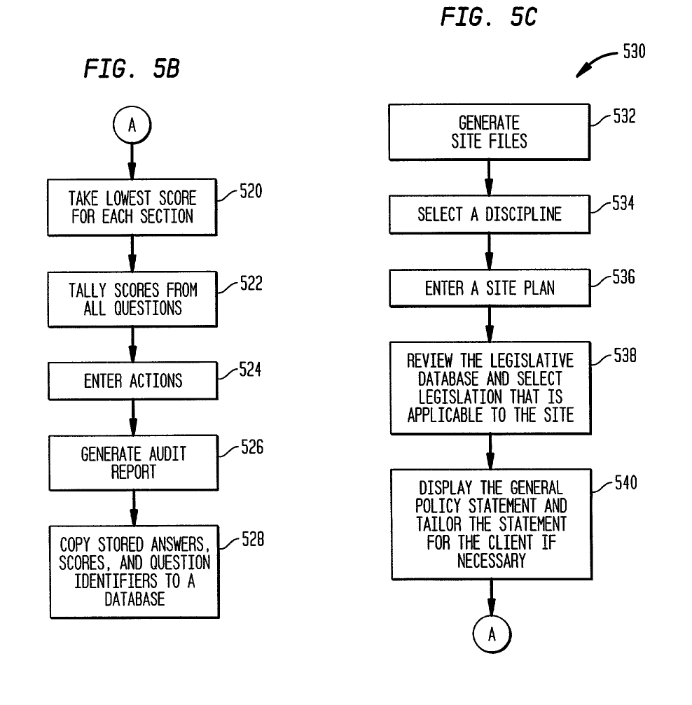

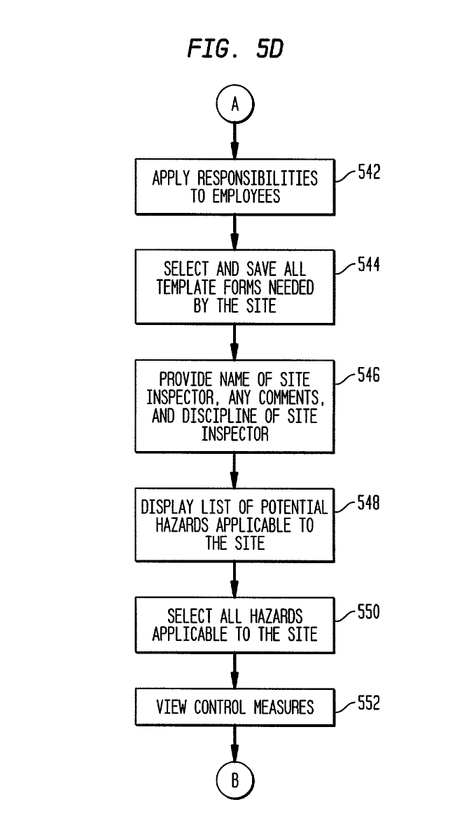

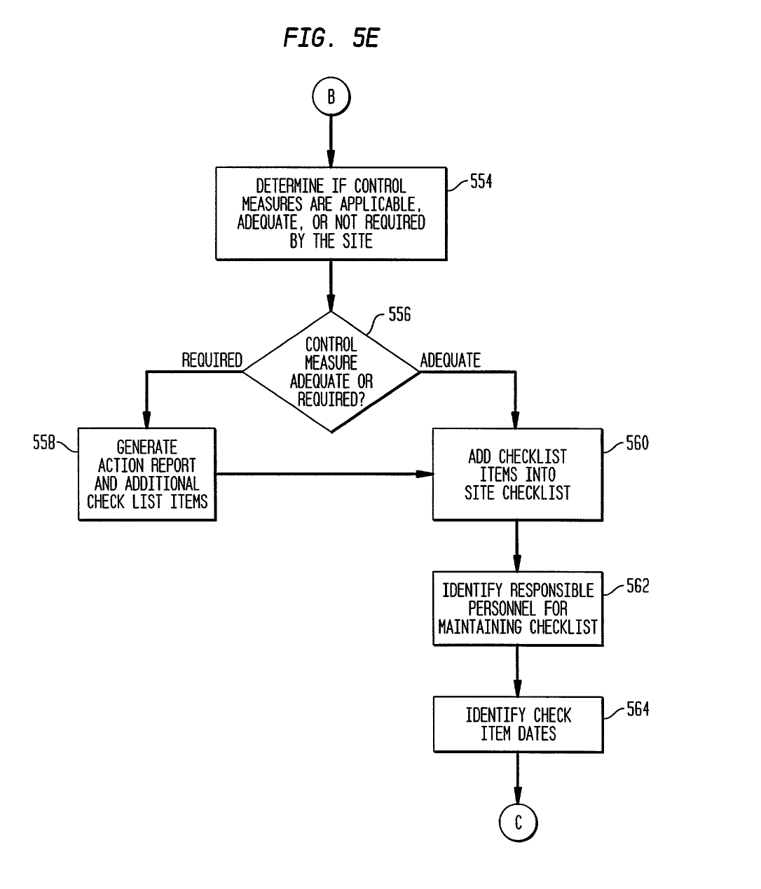

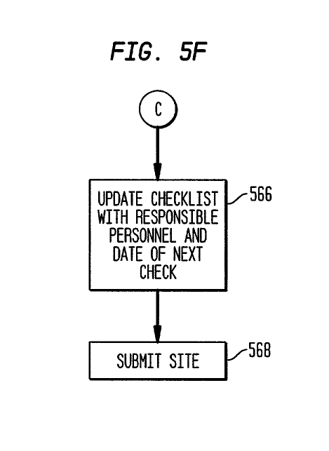

Once master manuals for a discipline have been established, these manuals may be tailored for clients. Local or resident EHCs and ESs tailor the master manuals to enable site specific manuals. FIGS. 5A and 5B illustrate an exemplary method for generating an audit site for a client. In one embodiment, a local or resident EHC or ES creates and amends the audit system while a site manager operates the audit system. Third parties may also be allowed to access the audit system, if given rights by the local EHC or ES. The process begins with step 502. In step 502 sectors are identified. As previously stated, a sector may be a hotel, a restaurant, a health care facility, a hospital, etc. The process proceeds to step 504.

In step 504, site files are generated. In one embodiment, site files are generated through registration 102 using the registration database. For example, one could click on a new site icon in the registration database. Upon clicking upon the new site icon, a new site form is displayed that requests an EHC to select the desired sectors. A sector could relate to more than one discipline. For example, a hotel may be a sector. The disciplines associated with the hotel may include fire safety, water safety, health and safety, occupational safety, and asbestos safety.

In one embodiment, an EHC may replicate a copy of a master audit database from the blank forms database 104. Alternatively, if a copy of the master audit database resides locally on the EHC's computer system, the EHC need only display the master audit database without having to request a copy from the server. The process then proceeds to decision step 506.

In decision step 506, it is determined whether an audit or an interactive site or both is being generated. If an interactive site is being generated, control then passes to step 508. In step 508, an interactive site is generated. This process is described below.

Returning to decision step 506, if an audit is selected or if an audit and an interactive site are selected, the process proceeds to step 510. In step 510, a discipline is selected. The process then proceeds to step 512.

In step 512, questions for an audit are displayed. The local EHC goes to each sector and answers each question. The process then proceeds to step 514. In step 514, answers selected by the EHC are received. The process then proceeds to step 516.

In step 516, the answers along with the scores and associated question identifier are stored. The process then proceeds to step 518.

In step 518, feedback may be provided. Feedback may come in the form of a recommendation such as a recommendation that enables the user to better comply with a standard. Many fields may be editable. In one embodiment, editable fields are an option that is provided by the chief EHC when the audit master is generated. In an embodiment, recommendations may be edited by the local EHC. Control then passes to step 520.

Referring now to FIG. 5B, in step 520, a score is determined for each section. As previously stated, in one embodiment each section is comprised of 50 questions. Some of the questions may not be applicable to the actual audit for a particular site. To score a particular section, the lowest score from all of the questions in the section is used as the overall score for that section. The process then proceeds to step 522. In step 522, scores from all questions are tallied and appropriately manipulated to obtain an overall percentage score. For example, if there are 50 sections with each section having a maximum score of 2, the overall percentage score would be determined by adding the scores from fifty sections, multiplying the results of each section by 2, and dividing by 100. If some of the 50 sections were not applicable, the overall percentage would be determined according to the number of sections that were applicable. In one embodiment, a total percentage score could be deducted at the discretion of the resident or local EHC.

In step 524, a local EHC is allowed to enter actions. Control then passes to step 526.

In step 526, an audit report is generated. Control then passes to step 528. In step 528 the answers, scores, and question identifiers that were stored in step 516 are copied to a database.

Site based interactive management systems are created from a master database in registration 102. In one embodiment, a local or resident EHC or ES creates and amends the interactive management system while a site manager operates the interactive management system. Third parties may also be allowed to access the system, if given rights by the local EHC or ES. A process for generating an interactive site is shown in FIGS. 5C, 5D, 5E and 5F. Referring now to FIG. 5C, the process begins with step 532. In step 532, site files are generated. In one embodiment, site files are generated through registration 102 using the registration database. For example, one could click on a new site icon in the registration database. Upon clicking upon the new site icon, a new site form is displayed. The process proceeds to step 534.

In step 534, a discipline is selected. The process then proceeds to step 536.

In step 536, a site plan is entered. The site plan is a brief description of the site. The process then proceeds to step 538.

In step 538, the legislative database is reviewed, and legislation that is applicable to the site is selected. The process then proceeds to step 540.

In step 540, the general policy statement is displayed. The general policy statement may be tailored for the client, if necessary. The process then proceeds to step 542.

Referring now to FIG. 5D, in step 542, responsibilities are assigned to individual employees. In one embodiment it is only necessary to assign responsibilities to one employee for each employee position. The site manager will be able to add the remaining employees when they have received training in using the system during installation. As previously stated, a skills matrix is automatically updated when a new skill is entered into the system. The process then proceeds to step 544.

In step 544, template forms needed by the site are selected and saved. The process then proceeds to step 546.

In step 546, the name of the site inspector and the discipline of the site inspector along with any comments necessary are entered into the system. The process then proceeds to step 548.

In step 548, a list of potential hazards applicable to the site are displayed. In step 550, all hazards applicable to the site are selected. The process then proceeds to step 552.

In step 552, control measures are viewed.

Referring now to FIG. 5E, in step 554, it is determined whether the controlled measures are applicable, adequate, or not required by the site. The process then proceeds to decision step 556.

In decision step 556, it is determined whether the selected control measures are adequate or required. If the selected control measures are adequate, the process proceeds to step 560. If the selected control measures are required, but yet not adequate, the proceeds to step 558.

In step 558, an action report is generated and additional check list items are determined. The action report contains a list of all defects found. Control then proceeds to step 560.

In step 560, all check list items are added to the site check list. Control then proceeds to step 562.

In step 562, responsible personnel for maintaining the items on the check list are identified. The process then proceeds to step 564.

In step 564, dates are identified for all check items. The process then proceeds to step 566.

Referring now to FIG. 5F, in step 566, the check list is updated with the responsible personnel and the date of the next check. The process then proceeds to step 568.

In step 568 the site is submitted.

D. User Initiated Tasks

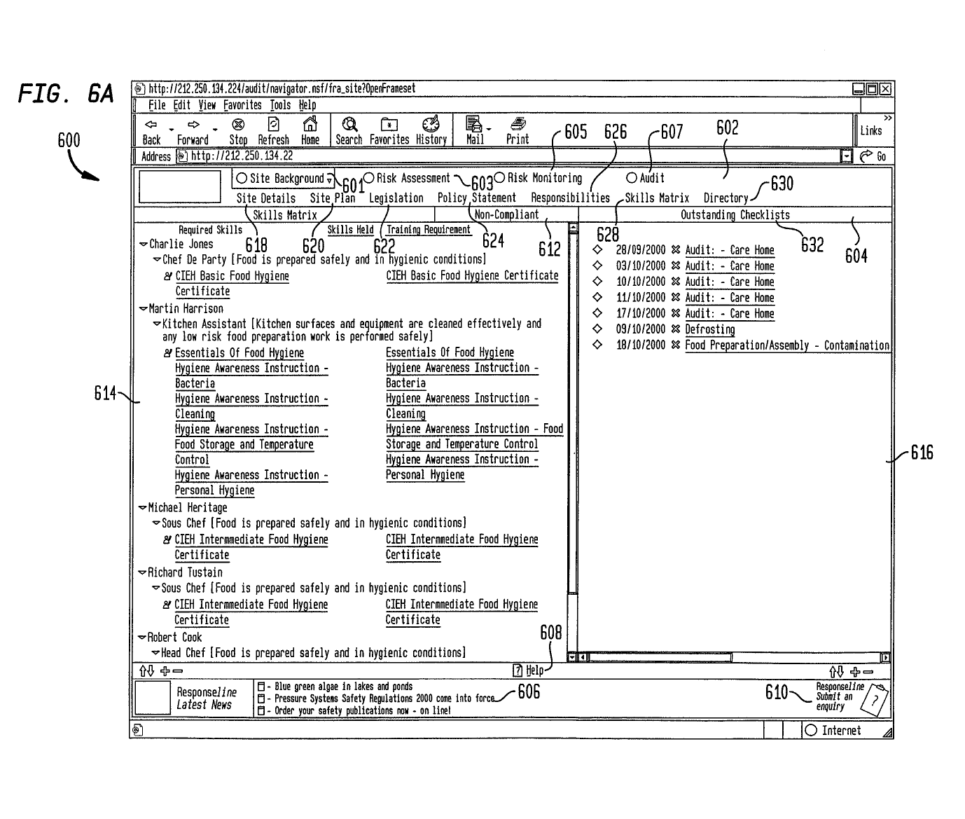

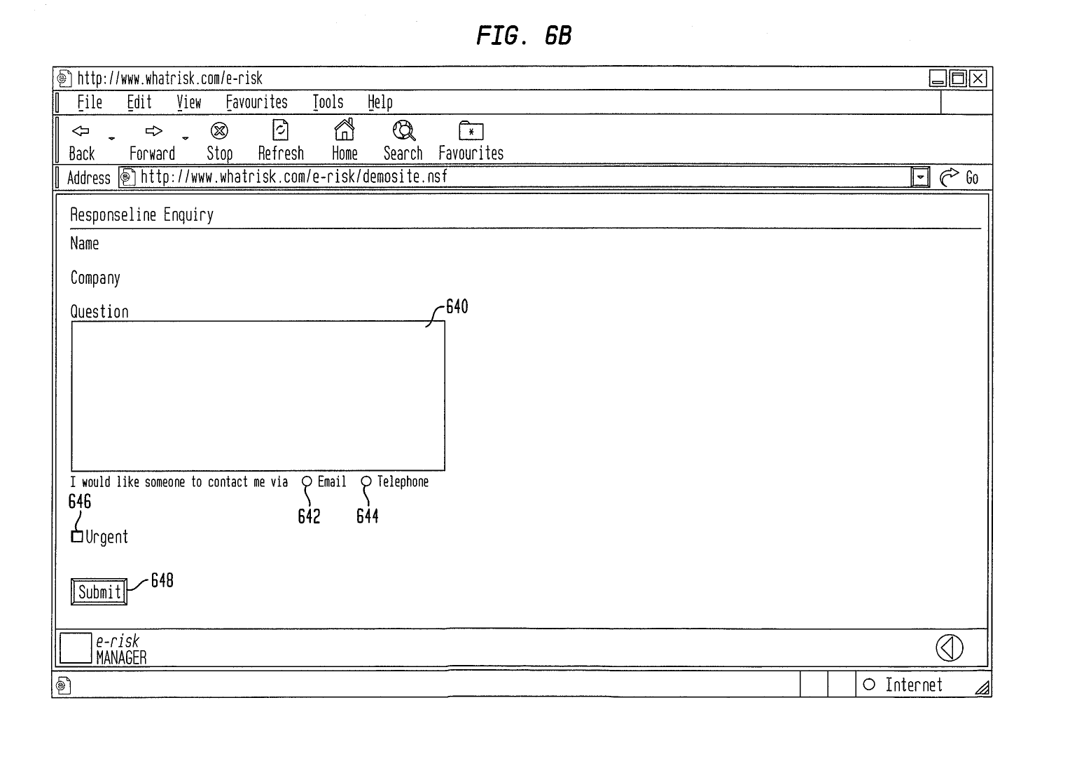

The user interface allows a user to perform such tasks as risk monitoring and risk assessment. An exemplary user interface screen shot is shown in FIG. 6A. A user interface 600 comprises a menu bar 602, a sub-menu bar 604, a news area 606, a help bar 608, an enquiry area 610, a compliant bar 612, a first information area 614, and a second information area 616. Menu bar 602 provides the following user interface menus: (1) Site Background 601, (2) Risk Assessment 603, (3) Risk Monitoring 605, and (4) Audit 607. Each user interface menu (601, 603, 605, and 607) in menu bar 602 has a corresponding sub-menu bar 604. For example, user interface 600 highlights Site Background menu 601. The corresponding sub-menu bar 604 therefore displays sub-menus for Site Background menu 601. The sub-menus for each menu bar 602 which will be discussed in greater detail below. News area 606 displays newsfeeds from the response line team. News area 606 also displays help features. Help bar 608 enables a User's Guide to be displayed. Enquiry area 610 enables a user to submit a question to the response line team to be queued into the newsfeed database.

If a user wishes to submit an enquiry, the user may click enquiry area 610 to enable a Responseline Enquiry screen to appear. An example Responseline Enquiry screen is shown in FIG. 6B. The user may then enter a question into a question box 640 along with the user's name and company. The user may also indicate a response method by checking one of an email button 642 or a telephone button 644. If email button 642 is indicated, the response will be in the form of an email. If telephone button 644 is indicated, the response will be via telephone. If the user desires an urgent response, the user may check an urgent box 646. To submit the enquiry, the user can click a submit box 648.

Referring back to FIG. 6A, compliant bar 612 indicates whether or not the site is compliant. If the site is compliant, the word Compliant is displayed in green. If the site is not compliant, the word Non-Compliant is displayed in red. In one embodiment, compliance bar 612 is always displayed when viewing user interface 600. The first and second information areas 614 and 616 display information from each sub-menu. In one embodiment, first information area 614 displays sub-menu information corresponding to the selected sub-menu while second information area 616 displays an Outstanding Checklists 632. Outstanding Checklists 632 lists all checklist items that need attending to in order for the site to be in compliance.

As previously stated, user interface 600 highlights user interface menu Site Background 601 and, therefore, displays all sub-menus for Site Background menu 601. The sub-menus from Site Background menu 601 include a Site Details menu 618, a Site Plan menu 620, a Legislation menu 622, a Policy Statement menu 624, a Responsibilities menu 626, a Skills Matrix menu 628, and a Directory menu 630. The Site Details menu 618 contains site details, such as background information about the site, the name of the EHC that performed the site audit and risk assessment, and the date(s) in which the site audit and risk assessment were carried out, for viewing by the user. The Site Plan menu 620 contains a brief description of the site along with the site plan for viewing by the user. The Legislation menu 622 contains all legislation pertaining to the site for viewing by the user. The Policy Statement menu 624 contains the client specific policy statement for viewing by the user. The Responsibilities menu 626 allows a user to view, as well as update, employee responsibilities for the site. For example, the site manager may provide new information for a new employee or a change in responsibilities for an existing employee. The Skills Matrix menu 628 allows a user to view summaries of the responsibilities for each employee position. Such information includes the skills required for the job, the skills possessed by the employee, and the skills needed by the employee to properly perform the position. First information area 614 of user interface 600 displays an exemplary Skills Matrix. The Directory menu 630 contains templates of blank forms as well as interactive forms.

Risk Assessment menu 603 includes the following sub-menus (not shown in FIG. 6): Identify Hazards, Control Standards, and Full Task List. The Identify Hazards menu lists the hazards with the associated control measures that were identified by the EHC. The Control Standards menu lists all of the relevant control standards identified by the site. The Full Task List menu lists all of the checklist items for the site.

The Risk Monitoring menu 605 includes the following sub-menus (not shown in FIG. 6): Checklist Calendar, Personal Checklist, Due Diligence, and Action Reports. In one embodiment, Risk Monitoring menu 605 is a default user menu. Anytime a user logs onto the system, the system immediately defaults to Risk Monitoring menu 605, and displays the Checklist Calendar sub-menu. The Checklist Calendar sub-menu displays checklist items for a particular day. For example, if it is Tuesday, Nov. 7, 2000, the Checklist Calendar will display the checklist items for Tuesday, Nov. 7, 2000. A user may click on one of the outstanding items in the checklist. Questions will then be displayed for the user to answer. If the user answers YES, the item will disappear from the checklist. If the user answers NO, the item will be marked with an X to indicate that an issue is associated with the item. In one embodiment, Outstanding Checklists is always displayed in the second information area 616 during the display of user menu 600. The Personal Checklist menu enables a user to enter a name to retrieve the personal checklist of the person whose name was entered. The Due Diligence menu displays an archive of all of the answered questions from the response line team. The Action Reports menu displays an action list from the site audit or the site interactive through the control measures. Diamonds are shown to distinguish between audit and interactive: red for audit and blue for interactive.

Audit menu 607 includes the following sub-menus (not shown in FIG. 6): Audits, External Audit Reports, and Standards. The Audits menu is a list of recent audits, the corresponding scores for that audit, the date the audit was conducted, and the person who conducted the audit. Also included is an option to perform a bench mark audit. The External Audit Reports menu lists each audit report and the date. The user can then select which audit report they would like to review. A standard answers and actions list is also provided that lists recommendations for all questions that did not receive the highest score. This is a quick way for the user to review what they need to be doing in order to attain a higher score at the next audit. The Standards menu lists the standard that the site was marked against. The standard relates to a section rather than a question. In one embodiment, 50 standards are listed. Each standard is trying to control a particular hazard.

Third parties users, multi-site users, and owners are each provided with an initial user interface that lists all of the sites and whether or not each site is compliant. This is shown using a big red cross or a big green check. Then, these users are able to click on any site. However, these users are given limited access based on assigned rights. These rights were assigned by the local EHC. Alternatively, chief EHCs and IT may also assign these rights.

E. Providing/Maintaining Reference Files

Referring to FIG. 1A, in an embodiment, one or more types of reference files 110 are provided to one or more clients of one or more users. In FIG. 1B, reference files 110 are illustrated as interactive template forms, newsfeed, and legislation. These are discussed below.

The invention is not limited to the example illustrated in FIG. 1B. Based on the description herein, one skilled in the relevant art(s) will understand that the invention can be implemented with other types of reference files as well. Such other business management processes are within the scope of the present invention.

Reference files can be provided to users in a variety of ways. For example, in an embodiment, reference files 110 are filtered according to discipline, country, and/or both. Alternatively, or in addition, reference files may be filtered according to site.

Referring to FIG. 1C, reference files 110 are illustrated as interactive template form files 140, newsfeed files 144, and legislation files 148. Interactive template form files 140 are stored in database 142. Newsfeed files 144 are stored in database 146. Legislation files 148 are stored in database 150.

1. Interactive Template Forms

Interactive template form files 140 are interactive template forms that may be copied and customized by the user. The interactive template forms may include any form that is relevant to the operation and management of the risk system. In one embodiment, all interactive template forms are displayed to the user. Interactive template forms may also be displayed by discipline.

2. Newsfeed

Newsfeed files 144 include news articles and inquires. As previously discussed, newsfeed files are handled by a response line team. World-wide news articles and papers, whether in draft, completed, or published form, may include any article that is relevant to a particular discipline. The articles are may be referenced on a site level or master discipline level. On a site level, the articles are viewed by users, site managers, and local consultants. On a master discipline level, the articles are viewed by IT s and Chief Consultants. News articles files may be displayed all at once, by country, or by discipline.

Inquiries are questions submitted to newsfeed files 144 by users of the system. The questions may pertain to the operation of the system and relevant legislation. In one embodiment, the response line team responds to an inquiry. Inquiries are categorized and displayed by country.

3. Legislation

Legislation files 148 contain all legislation from all countries relevant to a discipline of the risk management and assessment system. Legislation files 148 may be viewed by country, country and discipline, or discipline.

F. Business Management Processes

The present invention is now described as an example business management process. The invention is not limited to the business management processes described herein. Based on the description herein, one skilled in the relevant art(s) will understand that the invention can be implemented with other business management processes as well. Such other business management processes are within the scope of the present invention.

FIG. 9 illustrates a business management flowchart 900 in accordance with the invention. The business management process flowchart 900 illustrates previously described processors performed in parallel.

The business management process flowchart 900 includes:

step 904, generating and maintaining master templates;

step 906, generating and populating master discipline-specific manuals;

step 908, generating site-specific databases and assessing risks using the site-specific databases; and

optional step 910, providing reference file to clients.

With reference to FIG. 1I, step 904 is typically performed by IT administrators 150, step 906 is performed by chief consultants 152, step 908 is performed by local consultants 154 and optionally clients users (not shown in FIG. 1I), and step 910 is performed by response line teams 156.

In FIG. 9, an exemplary embodiment of step 908 is illustrated in a time line format 912. Exemplary time line 912 is now described.

Exemplary time line 912 begins at T1, perform initial risk assessment.

Exemplary time line 912 illustrates a interactive risk assessment process. The interactive risk assessment process illustrated in the exemplary time line 912 can be performed for one or more disciplines, and/or one or more sectors within one or more of the disciplines.

At time T1, a local consultant performs an initial risk assessment for a site. The initial risk assessment can be for one or more disciplines, and there are one more sectors within the discipline.

At time T2, the local consultant generates one or more site-specific manuals. Typically, the site-specific manuals are implemented in a computer based format and includes instructions and/or procedures to be performed periodically by client users.

At time T3, the local consultant trains client users to perform in accordance with the one or more site-specific manuals.

From time T4 through time T5, client users correct defects identified during the initial risk assessment performed at time T1. Client users also perform in accordance with the one or more site-specific manuals, as trained for at time T3.

In an embodiment, the risk assessment and management service provider contracts with the client to have one or more local consultants review the client's correction of defects identified at time T1 and corrected for between times T4 and T5. Similarly, where the risk assessment and management service contracts with the client, at time T7, the local consultant revises the site-specific manual. For example, the site-specific manual can be revised to change the day of the week that a particular procedure is to be performed by a current user.

From time T8 through time T9, users perform in accordance with the revised manual.

Optionally, the risk assessment and management service provider may contract with the client for periodic follow up risk assessments and manual revisions. This is illustrated at times T10 and T13, between which the client performs in accordance with the revised manual, as illustrated, for example, from time T1 through time T12.

Time line 912 is provided to assist the reader understanding the present invention. The present invention is not, however, limited to the example time line 912. Based on the description herein, one skilled in the relevant art will understand that step 908 can be implement along other time lines as well. Such other time lines are within the scope of the present invention.

G. Example Interactive User Guide

Below is an example UK user's guide for an example food safety risk management part of the e-Risk system 100, in accordance with the invention.

Contents

A. INTRODUCTION

1. Background

2. The System

3. The Implementation Process

4. The Service

B. GETTING STARTED

5. First Steps

6. Finding Your Way Around Your Site

7. Site Background

8. Risk Assessment

9. Risk Monitoring

10. FSS Audits

11. Where to get help

12. Data Protection Implications

A. INTRODUCTION

The risk of illness through the incorrect handling, preparation and delivery of food is always present. Where food is being handled in large quantities such as in hotels, restaurants, retail outlets and care homes this risk is even greater. It is therefore vitally important that all the necessary precautions are adhered to in order to reduce the risk of food related illness. The food safety risk management system identifies these risks and incorporates procedures to minimize them.

The term food safety system or FSS as used herein, refers to an interactive food safety management system in accordance with the invention, which, when implemented, will give you as the client the assurance that the food safety risks associated with your food handling processes are being minimized. This will be achieved through the implementation of a structured process that involves the expertise of the Environmental Health Consultants and your own employees who have knowledge of your business processes. Once established the system will allow quick on-line monitoring of the food safety controls related to the site by the designated site staff and the FSS Environmental Health Consultant.

1. Background

FSS has been developed in response to the needs of busy managers, as an invaluable tool for those responsible for managing food safety in their businesses.

FSS provides the key to successful food safety risk management through the correct identification of risks, the setting up of procedures to eliminate or control those risks and the continual monitoring of the effectiveness of those procedures.

This pictorial represents the elements of a food safety risk management system, all of which are incorporated into FSS. FSS also adopts the internationally recognized procedures associated with a HACCP programme where once again, hazards are recognized and critical controls are put in to place to minimize the risks associated with these hazards.

The key to the successful implementation of any food safety system is the correct identification of the potential risks that occur on any particular site, the setting up of procedures to eliminate or control those risks and the continuous monitoring of the effectiveness of those procedures.

FSS contains the essential elements of a successful food safety risk management system. This includes:

FOOD POLICY STATEMENT—affirming that the managers of the business have a policy of securing the health, safety and welfare of all persons affected by its operation as related to the handling of food, and have organizational arrangements in place to implement the policy.

EMPLOYEE RESPONSIBILITIES—allocating food safety responsibilities only to competent employees.

RISK ASSESSMENTS—identifying all the potential food safety hazard areas and activities, and the food safety risks to persons involved in each of those areas and activities, having regard to food safety law.

CONTROL STANDARDS—implementing management control standards, which are designed to eliminate or reduce the risks, identified in the risk assessments.

TRAINING—ensuring employees are appropriately trained in food safety to enable them to hold the necessary skills to demonstrate their competence.

PERFORMANCE MEASUREMENT—monitoring and recording that all aspects of the system, including the food safety control standards are being properly carried out.

These elements form a significant part of an employer's duties under the Food Safety (General Food Hygiene) Regulations 1995.

2. The System

FSS typically provides:

A clear definition of the FSS international food safety standards relevant to your site, independently verified, which are necessary to minimize the safety risks associated with the delivery and handling of food on your site.

Auditing of the site to the independently verified international standards by a FSS Environmental Health Consultant.

Benchmark scoring of the food safety standards on the site through an objective marking system.

Electronic access via an Internet based website address to the audit information and to a site specific and interactive risk management system. (This access can also be provided to managers who may not be based on site, providing them with valuable management information.)

Automatic on screen reminders of management checks to ensure standards are maintained.

Training on the use of the system. In addition, food safety training of personnel to levels defined by the international standard.

Automatic electronic updates to the system as a result of changes to local legislation or best practice codes.

Access to a help line service (Response line), which is manned 24 hours a day by qualified environmental health professionals, who can answer your food safety and health, safety and environmental queries via e-mail, fax or telephone.

3. The Implementation Process

The following stages identify how FSS will be implemented on your site:

| | |
|---|---|
| Stage 1 | Initial food safety audit of the site against the agreed |
| | international standards. |
| Stage 2 | Benchmark scoring of the audit against the international |
| | standards. |
| | (Trend analysis graphs will be provided for the site |
| | comparing its performance against other similar types of |
| | premises or against other sites within the organization |
| | where this is relevant and in time, with previous audit |
| | scores.) |
| Stage 3 | Submission of a detailed site audit report with prioritized, |
| | timetabled recommendations. |
| Stage 4 | Agreement on training and auditing programme over the |
| | next 12 months with the objective of achieving, |
| | maintaining and continually improving the recognized |
| | food safety standards. |
| Stage 5 | Creating the site specific interactive food safety risk |
| | management system and establishing the secure Internet |
| | website address, username and password to allow |
| | authorized local and remote access to the audit report |
| | information, scoring status and the interactive food risk |
| | management system. |
| Stage 6 | Remote support by the designated FSS Environmental |
| | Health Consultant via the Internet to ensure compliance |
| | with the food safety standards. |

4. The Service

The FSS service begins with a site specific food safety and hygiene audit and risk assessment by an experienced Environmental Health Consultant. The objective is to determine how well food safety is being managed and the extent that risks are under control within the business.

During the site visit the Environmental Health Consultant will examine the handling, preparation and delivery of food on the site according to the principles of HACCP and the FSS food safety standards. The audit will comprise:

A visual inspection of the food handling areas.

A review of any relevant food handling records being kept e.g. food temperature records, training records etc.

The completion of an audit report assessing and scoring each particular aspect of the food handling process present on the site. The observations and recommendations recorded on this audit form will be discussed with the site manager at the time of the audit and where possible a printed copy will be left.

A risk assessment and hazard analysis of the food handling processes where the FSS interactive system is being installed.

On completion of the site audit the Environmental Health Consultant will set up the FSS on-line interactive food safety risk management system which will allow you to monitor and record electronically the actions necessary to maintain the food safety standards on the site.

Once this has been completed the Environmental Health Consultant will revisit the site and train you in how to use the system.

Important Note: Please Read This Carefully

e-Risk FSS has been designed to enable the effective management of the food safety risks within those areas identified to the Environmental Health Consultant during their site visit.

In completing your audit and designing your system, the Environmental Health Consultant will take reasonable steps to ensure all areas and activities are included, however, you will have to play your part by letting us know of any changes to your food handling processes.

The Environmental Health Consultant will aim to work in partnership with you to ensure your system remains fully up to date, enabling you to effectively manage your food safety risks.

B. Getting Started

5. First Steps

The first thing to do is to access the Internet. You may already have experience in accessing the Internet, however, if you have not, your FSS Environmental Health Consultant will be able to demonstrate just how straight forward this is.

Once on the Internet, you will be automatically directed to the e-Risk FSS website. Once there you will see a number of international flags displayed. Click on the British flag and wait for the English language page to appear. Click on the ‘log-in’ tab in the bottom right hand corner.

The User Name and Password table will appear on your screen. You will be asked for your User Name and Password, both of which will have been issued to you separately. Simply type in both the user name and password and click on the Login tab.

This will take you into your site specific FSS Site.

Although, your interactive management system is accessed via the Internet, you do not need to remain on line all day. Simply access your system when you require some information or when you need to complete records, for example, first thing each morning.

6. Finding Your Way Around Your Site

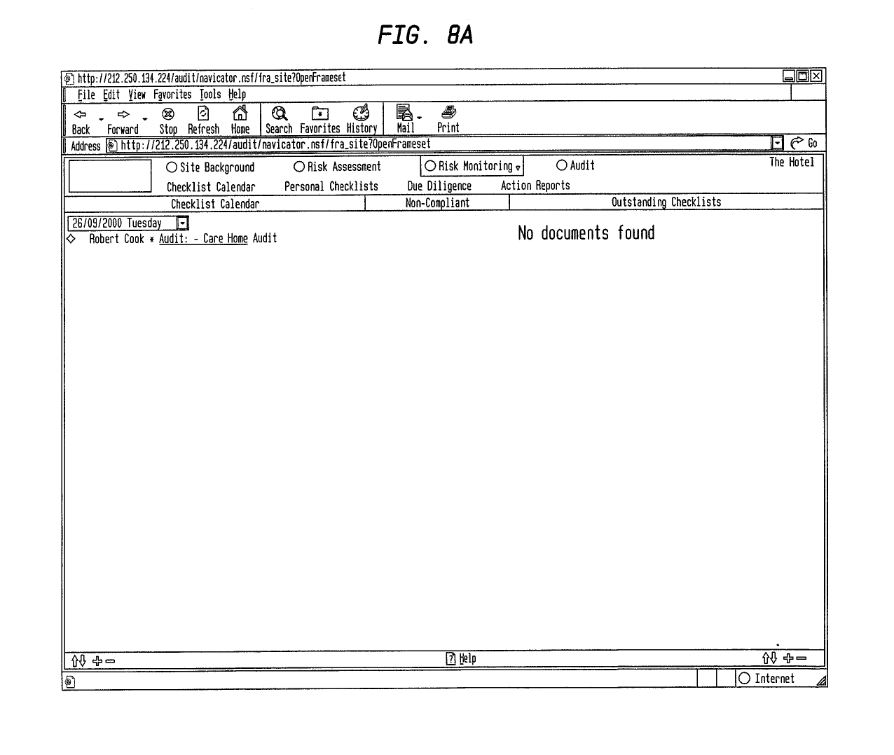

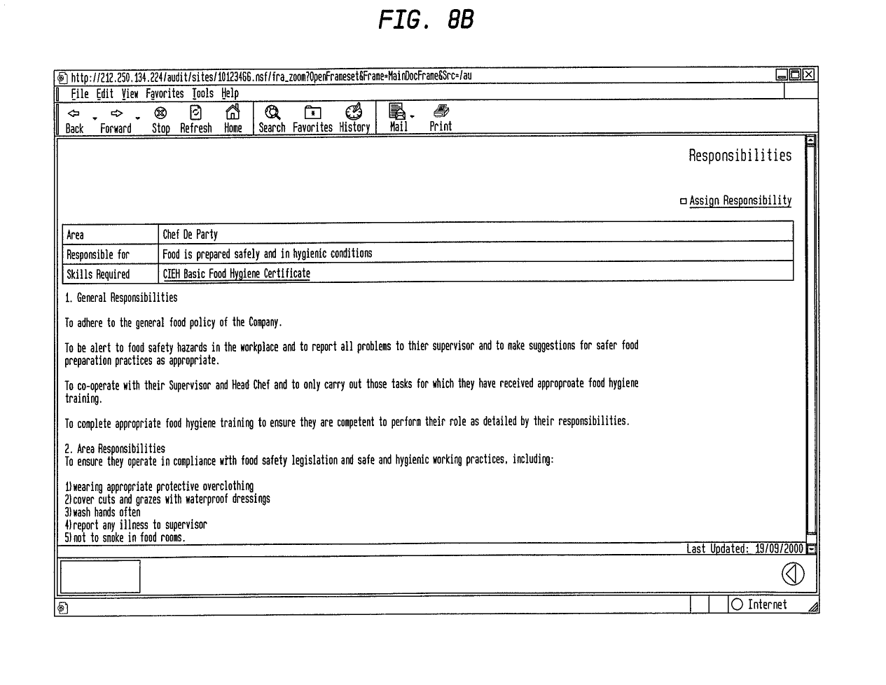

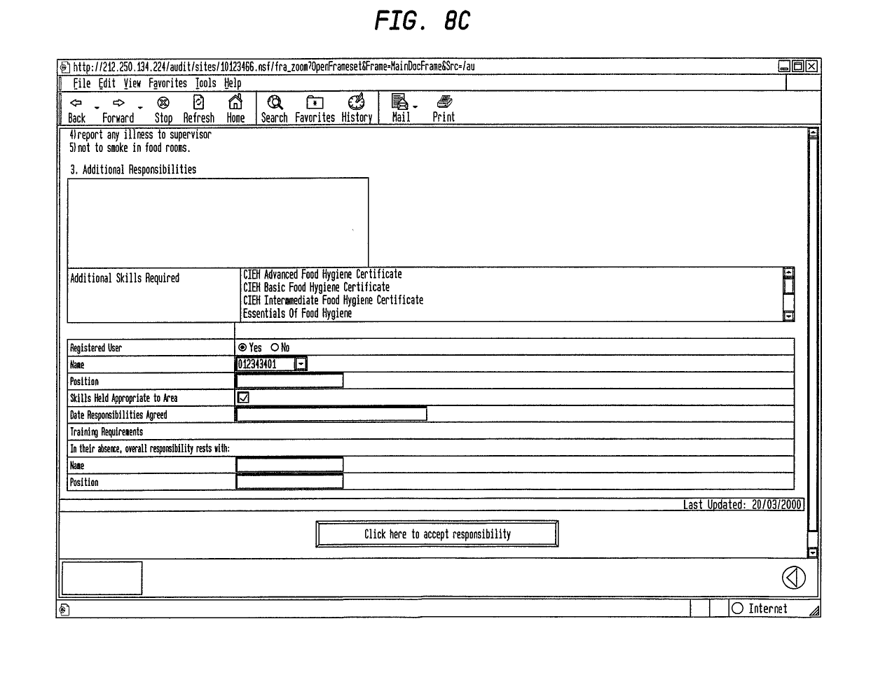

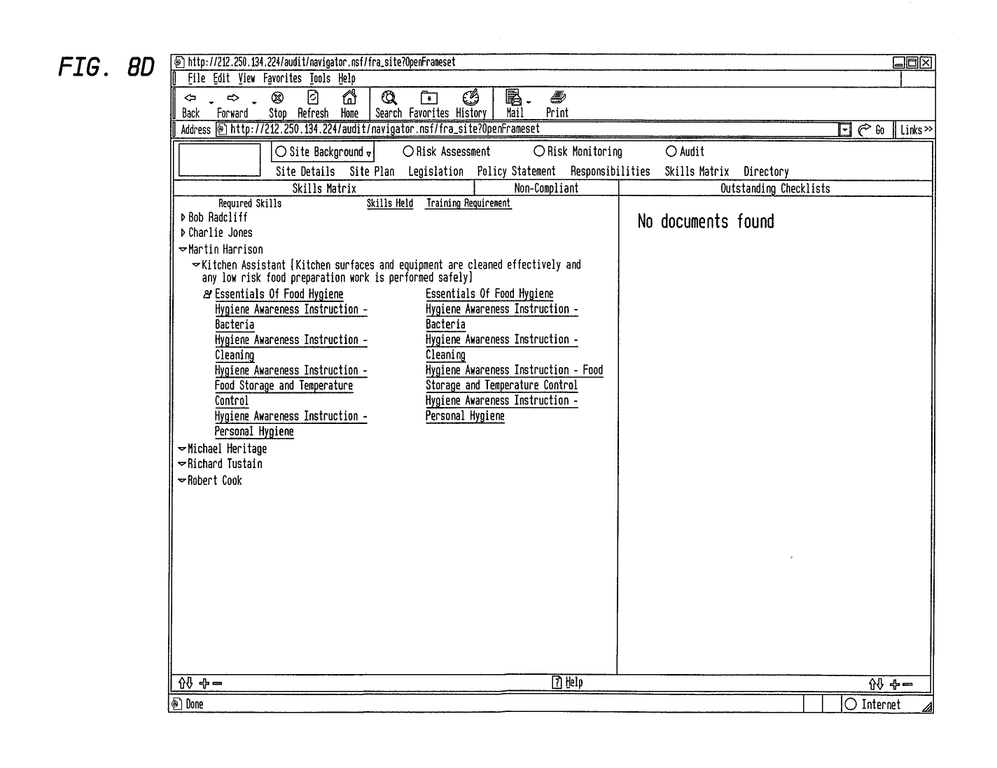

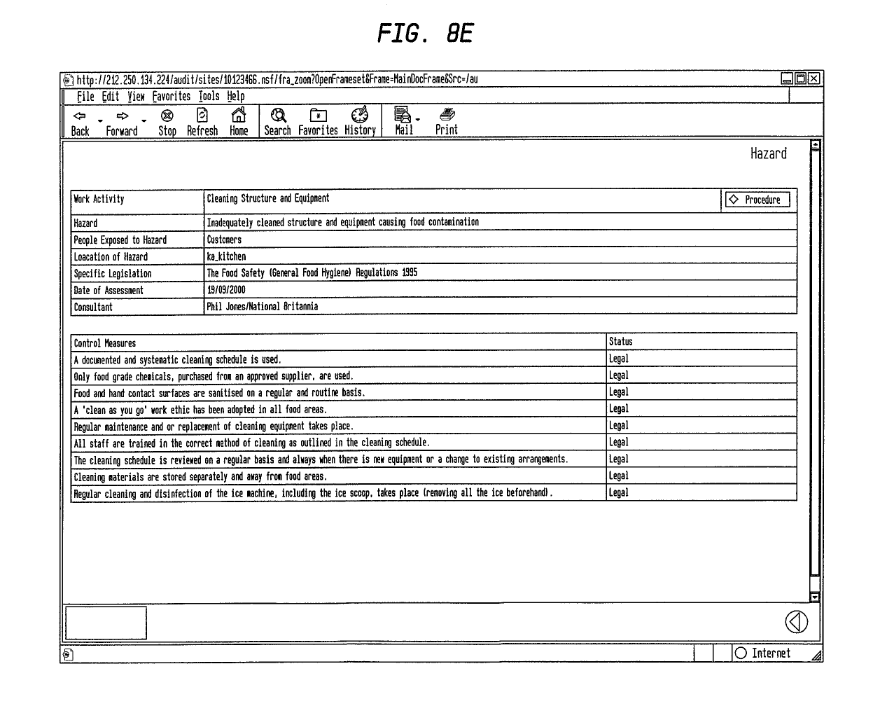

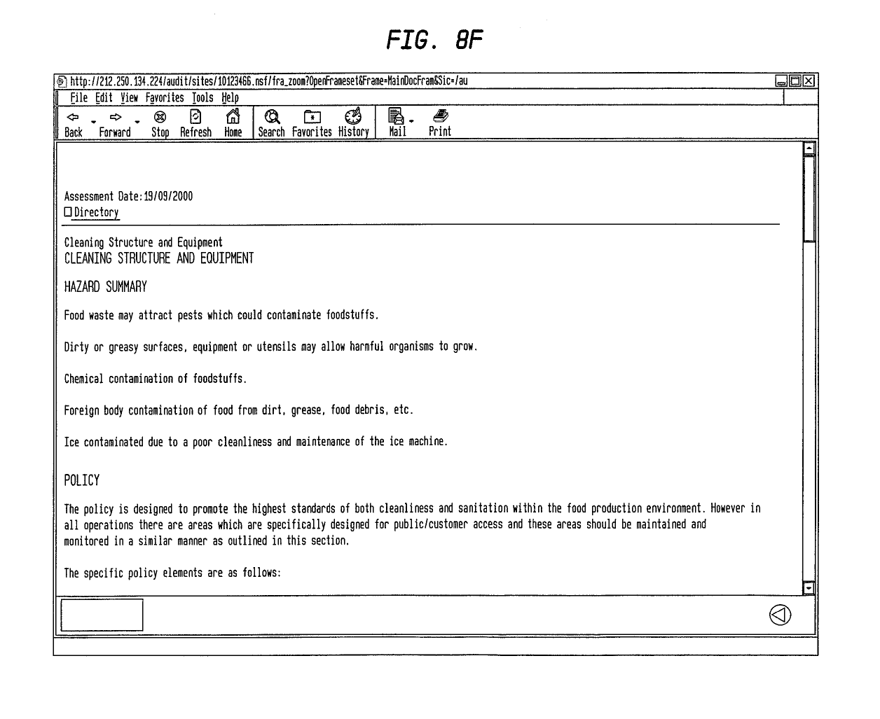

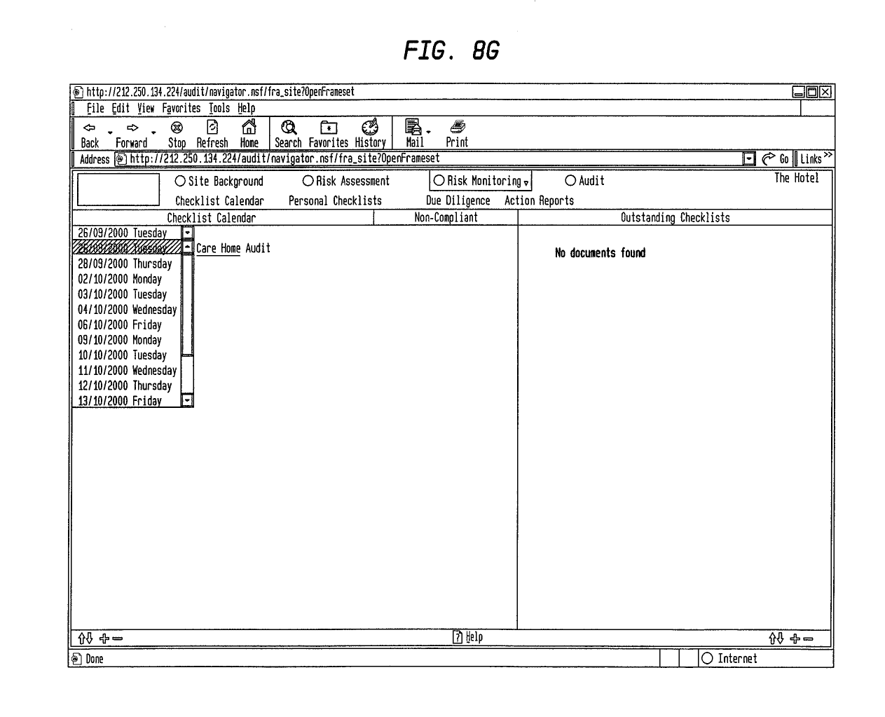

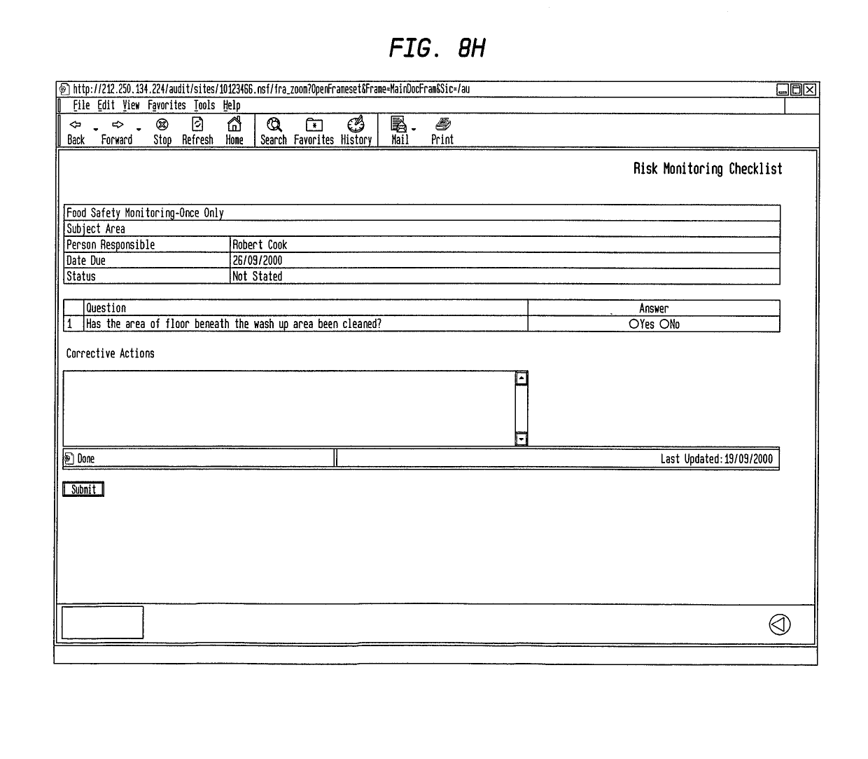

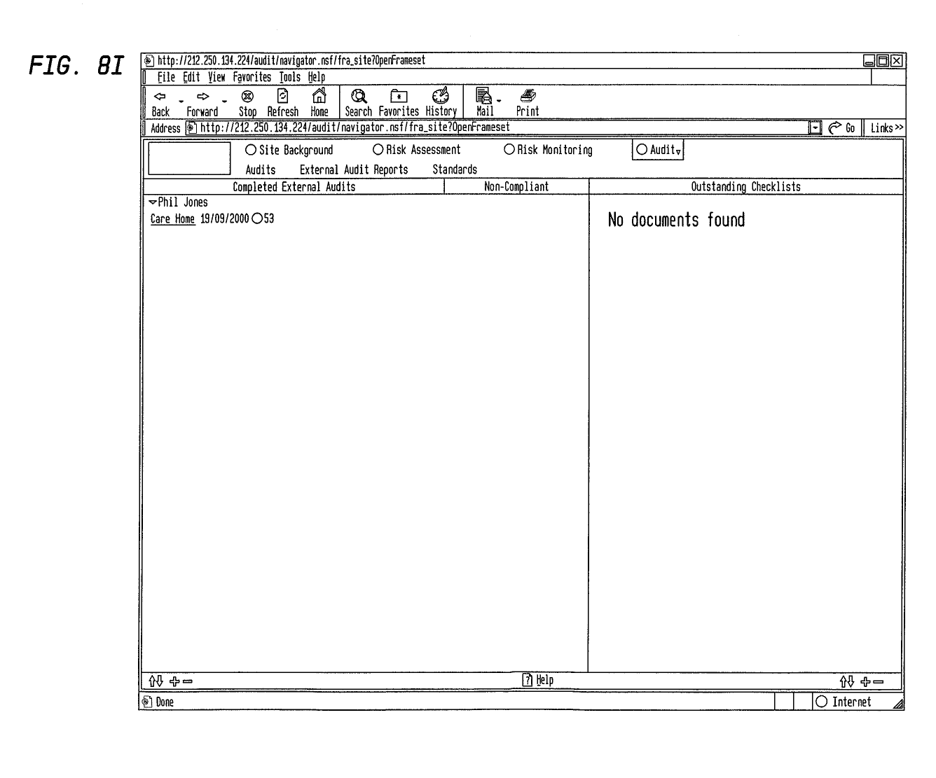

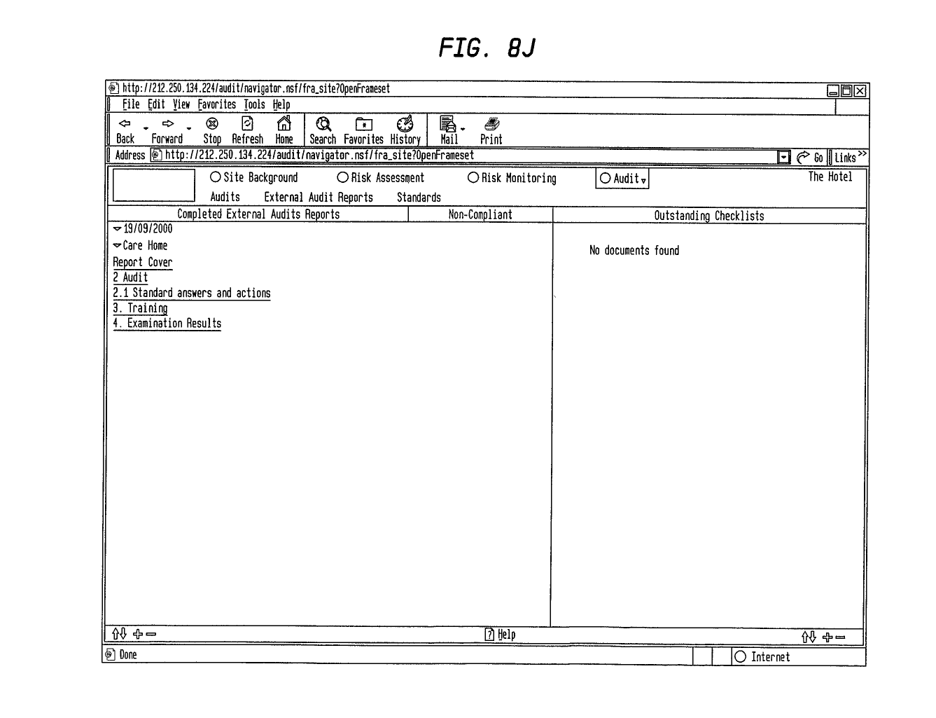

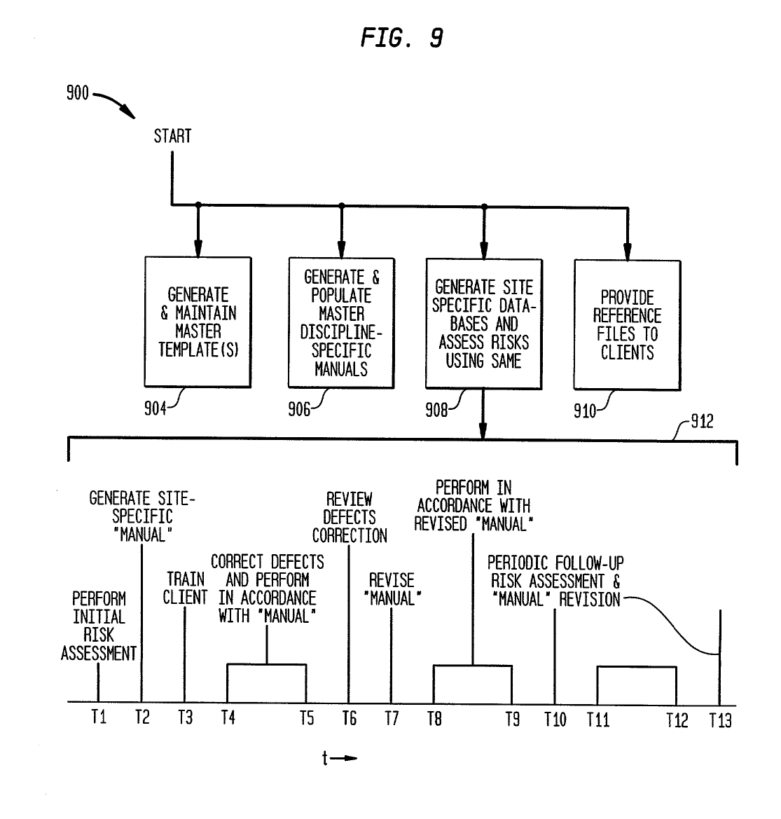

FIG. 8A illustrates an example FSS front screen.

Tabs Along the top of the front screen you will see four main tabs which will be explained in detail below and which are shown by FIG. 8A:

Site Background

Risk Assessment

Risk Monitoring p0 Audits

Sub Tabs

Within each of the four tabs listed above there are sub tabs, which again will be explained in more detail below:

| | | | |
|---|---|---|---|
| Tab - | Site Background | Sub Tab - | Site Details |
| | | | Site Plan |
| | | | Legislation |
| | | | Policy Statement |
| | | | Responsibilities |
| | | | Skills Matrix |
| | | | Directory |
| Tab - | Risk Assessment | Sub Tab - | Identified Hazards/Risks |
| | | | Control Standards |
| | | | Full Task List |
| Tab - | Risk Monitoring | Sub Tab - | Checklist Calendar |
| | | | Personal Checklists |
| | | | Due Diligence |
| | | | Action Reports |
| Tab - | Audits | Sub Tab | Audits |
| | | | External Audit Reports |
| | | | Standards |

NOTE:
When you access new screens you will be able to see the following icon located in the bottom right of each page. By clicking on this icon you will be able to quickly close the page and return to your previous view.

To navigate your way around these various tabs and sub tabs simply move your cursor, (which will normally be in the shape of an arrow), over the tab you are wishing to view. The cursor will then change to a small hand and to view the tab or sub tab, click once.

When you access your site the front screen will be set on the Risk Monitoring tab as shown in FIG. 8A. You will see on the right hand side of the screen the Outstanding Checklists and the Compliant (green) or Non-Compliant (red) indicator in the center of the screen. These will be explained below. The outstanding checklists and compliant/non-compliant indicator will appear on each of the three main tab screens.

7. Site Background

Site Details

This contains background information about your site including the name of the Environmental Health Consultant who carried out the FSS audit and risk assessment and the date on which it was carried out.

Legislation

The food safety legislation relevant to your site has been included within this part of the system. The legislation is a summary of the law related to your country.

This part is for reference purposes and will enable you to obtain essential information on food safety law. To open the law simply click on the piece of legislation you require information on.

When legislation changes, for example, when regulations are amended, the system will automatically update this for you. To view the new legislation, click on the old legislation title and by doing this, the new legislation will become available and will appear from that date onwards.

Policy Statement

Your own company food safety policy statement will be located here. You can access this document and should you wish to, print it off directly from this location.

NOTE: To print from Internet Explorer, right click on the page you wish to print, click on Select All and then click on print.

Responsibilities

This part of the system will detail the food safety responsibilities of your employees based on site and have been arranged under the Employee Areas identified during the site visit and are listed below:

Head Chef

Sous Chef

Chef De Party

Kitchen Assistant

It is vitally important that employees are only made responsible for those matters which they have received appropriate training; this then permits food safety responsibilities to be allocated only to those employees who are deemed to be competent.

Your employees based on site will be included under one of the above employee areas. They will each be allocated their own food safety responsibilities and a list of skills that they will require in order for them to become competent in those matters for which they have been made responsible for.

You will be required to assign responsibilities for new employees who may start work in the food preparation areas. This is achieved by firstly clicking on the Responsibilities sub tab, then click on the particular Employee Area description, for example, Kitchen Assistant. A new screen will appear on which you must click on the red square button located at the top right hand side of the screen marked Assign Responsibilities (this will allow you to edit the document).

FIG. 8B illustrates an example responsibilities screen showing the Assign Responsibilities Function.

Should the employee be responsible for any matter beyond those that have been assigned automatically, you can add these by firstly detailing under the Additional Responsibilities heading what they are.

FIG. 8C illustrates an example responsibilities screen showing the additional responsibilities function.

If the employee has been made responsible for additional matters, these will need to be matched by additional skills. These can be identified by clicking on the Additional Skills Required button at the bottom of the screen. Click on the additional skills required. (Multiple skills can be selected by holding down the control key on your keyboard prior to selecting the additional skills.)

At this point there is no need to complete the Date Responsibilities Agreed field.

Complete the information in the table and press the Click here to accept responsibility button.

Where the interactive system has been installed, once you have submitted all the information, a checklist question will automatically be generated in 3 months time, which will remind you of an individual's training requirement.

Skills

You will be required to deliver the necessary skills (or training) in line with the information entered in the employee's responsibilities, to prove an individual's competence.

To do this click on the Skills sub tab, which will then produce a list of your employees. For each employee you are able to identify three important pieces of information:

Required Skills

Skills Held

Training Requirement.

Required Skills

By clicking on the blue triangle located on the left-hand side of the employee name, this will identify the employee area, which was explained above. Click on the blue triangle to the left of the employee area-this will show their required skills for the employee, the skills they currently hold and their training requirement.

FIG. 8D illustrates an example skills matrix view, showing required skills, skills held, and training requirement.

For any particular skill listed in the training requirement column, click on the wording of the skill and this will take you to the individual employee responsibilities screen. Click on the skill in the training requirement box at the bottom of the screen to take you into the training material which may be in the form of training information (modules) which are linked directly to the training requirement or a requirement to organise external specialist training from, for example, the CIEH Advanced Food Hygiene Certificate.

Simply go through the information with the employee and ask the employee the Food Safety Training Questions located at the bottom of the screen to ensure the information has been fully understood.

NOTE: You will automatically be reminded that an employee has to be trained through a checklist question.

Once the employee has received all their required skills, click on the small icon of a person located to the left of the list of skills-this will then take you into the individual's responsibilities record. To edit the document, click on Edit Document and enter the Date Responsibilities Agreed. Click on the submit button at the bottom of the screen.

You will have to then repeat the above procedure for all your employees.

By then clicking on the Skills Held sub tab, you will be able to identify by each skill, those employees who hold that particular skill, for example, the Essential of Food Hygiene. This will be useful when you wish to establish whether an employee can be made responsible for a task or not.

If you then click on the Training Requirement sub tab you will be able to identify by each skill, those employees requiring training in that particular skill, making it easy to arrange a course for example.

From time to time you will have to remove employees from the system, for example, when they leave. To remove an employee, open up their individual responsibilities record and click on the Edit Document button. After clicking on this button, a new button will appear namely Delete Document. Simply click on this button to remove the employee from the system.

8. Risk Assessment

Identified Risks and Hazards

The assessment of risk is an essential element of operating a successful food safety management system. The emphasis of much of the recent food safety legislation is on carrying out and recording the results of detailed assessments.

This part contains your site specific risk assessments. These risk assessments are specific to this site.

Risk Assessment is a process whereby HAZARDS (anything with the potential to cause food poisoning/food contamination) are identified on site. The RISKS (likelihood of the hazard resulting in food poisoning/food contamination) are then assessed for each of the identified hazards. The degree of risk can then be used to prioritise control measures, which will be required to ensure the risk is reduced to an acceptable level.

However, once the hazards have been identified, the first consideration must be to determine whether it is possible to remove the hazard completely and thus avoiding the need to control the risk associated with it. Where it is not possible to remove the hazard either in terms of cost or practicability, then the hazard will require control measures to be implemented.

It must be noted that the hazards identified in the site risk assessment have been deemed to be unavoidable and therefore, require their corresponding risks to be assessed and appropriate control measures introduced.

The Environmental Health Consultant will have already identified the hazards associated with the handling of food on site i.e. all aspects of food handling which have the potential to cause harm e.g. the storing of raw and cooked food, temperature control, waste disposal.

The following matters are then identified for hazards associated with each work activity:

Specific food safety legislation

Persons exposed to the risk, e.g. customers, residents and/or the public.

The Environmental Health Consultant will have then determined which control measures are necessary to reduce the risk associated with a particular hazard, to an acceptable level. In making their decision, the Environmental Health Consultant will have determined whether the:

control measure is already in place (Existing Control Measure) or

control measure is not in place and is therefore required to be introduced (Additional Control Measure).

When a control measure is already in place the Residual Risk is deemed to be Acceptable and conversely when a control measure is not in place and is therefore required to be introduced, the residual risk is deemed to be Unacceptable.

It will be the responsibility of the Head Chef to implement the additional control measures listed in individual risk assessments as soon as is reasonably practicable, although the Environmental Health Consultant will prioritise the additional control measures as follows:

The additional control measures contained in the particular risk assessment table must be implemented Within Three Weeks. This action will be recommended for the following:

item contravenes food safety legislation and/or official guidance and presents a significant but not imminent risk, and

item is likely to result in formal action by an enforcement officer requiring longer term action.

The additional control measures that are considered necessary to avoid a serious risk of food poisoning/food contamination must be implemented Immediately. For these items, steps should be taken immediately to control the risks. If the control measure cannot be fully implemented straight away, temporary controls such as no longer using a piece of equipment should be put into place. Where items include a long lead-time or high capital expenditure, for example, with some types of repair work, immediate start times may be recommended with a longer-term completion time.

Additional control measures requiring immediate action will be recommended for the following:

item contravenes food safety legislation and presents an imminent risk, and

item is likely to result in prosecution and/or a Statutory Notice requiring short term action.

When immediate additional control measures are identified, these will be documented in the sites Audit Report that is explained below.

In addition to the immediate additional control measures, those other additional control measures that require implementation within a time scale agreed in the site audit and documented in the Audit Report.

To access the site specific risk assessment information, click on Risk Assessment tab. A list of the risk assessments will then appear on the left-hand side of the screen under the Identified Risks/Hazards sub tab. Click on an individual risk assessment and the risk assessment table will appear which lists all the information detailed above.

The Control Measures listed in the table will reflect the existing as well as the additional controls that have been assessed by the Environmental Health Consultant; the additional control measure need to be implemented and this process is achieved through implementing the associated Control Standard.

FIG. 8E illustrates an example risk assessment menu.

Control Standards

From the risk assessment table, click on the blue diamond marked Procedure located at the top right-hand side of the table (see FIG. 8D). This will then open the control standards screen. Systematically implement the various requirements of the standard.

Should the control standard require a form to be completed, for example, Food Receipt/Delivery, simply click on the red button marked Directory located in the top left hand corner and then open the required form from the list.

FIG. 8F illustrates an example control standard.

Full Task List

To help you ensure that all the control measures and all aspects of the control standards have been implemented by the required date, checklist questions will automatically be generated. These checklist questions will be generated from 2 sources of information:

Audit Recommendations as a result of the FSS audit carried out by the Environmental Health consultant.

Risk Assessment Actions following on from the risk assessment carried out by the Environmental Health Consultant at the same time as the FSS audit.

Some recommendations which once addressed will not reappear again e.g. remove the defective mixer, patch up the flaking plaster by the dish washing area.

Other recommendations will require regular checklists as part of the interactive system, for example, record daily fridge temperature checks, record training requirements and results. These are explained in more detail below.

9. Risk Monitoring

This part of the system contains all the checklist management tools that are available to manage the checklist questions that have been generated by your system.

To access this information, click on the Risk Monitoring tab; you will then be able to view the following three sub tabs:

Checklist Calendar

Personal Checklists

Due Diligence

Action Report

Click on the Checklist Calendar and you will find on the left-hand side of the screen the name of the person allocated to complete the checklist question together with a drop down calendar.

To identify whether checklist questions fall on particular days in the future, simply click on the drop down calendar and click on the particular date; if a checklist is due on the date, this will appear below the calendar. The calendar will help you assign checking responsibilities to other competent employees should you not be able to complete them, for example, when you are away on holiday.

FIG. 8G illustrates example risk monitoring menu.

To answer individual checklist questions, click on the subject, which will take you to a new screen. Answer the question contained in the pink box by clicking on the Yes or No button. If your answer to any question is No, add any Further Corrective Actions in the adjacent box and then click on Submit. You will then have to implement the corrective action. This will in turn produce a red cross by the side of the checklist item.

When you have completed the corrective action, in the question click on YES and then Click on the Mark Completed red square icon at the bottom of the table which will again bring up a new screen. The system will ask you to insert the name of the individual who completed the check; add the name and click on OK. See FIG. 8I.

FIG. 8H illustrates an example checklist showing question, corrective action and mark completed function.

NOTE: The appropriate manager must aim to complete all the checklist questions on their due dates.

On the right hand side of the screen you will find the Outstanding Checklists, which as mentioned above will remain on the screen on all the main screens. By completing the significant checklist questions at the appropriate frequencies, the status of the site will be Compliant and to reflect this visually, the red box will turn to green.

Symbols

There are a number of symbols that you need to be aware of and which relate to the checklist questions. These are explained below:

Checklist question has not been started.

Checklist question requires corrective action.

Checklist question is in progress but not yet submitted.

Completed checklist question with corrective action history. (Located in the Due Diligence section)

Due Diligence Section

The completed checklists are located in the Due Diligence sub tab. At the top of each column heading (Date Due, Area, Frequency, Completed By and Completion Date) you will see up/down symbols. By clicking on these symbols, you are able to view the listed questions in date order or frequency order etc.

10. FSS Audits

This part of the system contains all the audit details as a result of the field audit carried out by the FSS Environmental Health Consultant.

To access this information, click on the Audits tab; you will then be able to view the following three sub tabs:

Audits

External Audit Reports

Standards

Clicking on this Audit sub tab will reveal:

The name of the Environmental Health Consultant responsible for your site

The type of premise that you manage

The date(s) and score of each audit carried out.

This page will identify the audit score and the range this score fits into through the identification of a colored disc. The ranges are as follows:

A score of:

0-30

31-50

51-75

76-100

FIG. 8I illustrates an example audit view.

If you click on the External Audit Reports sub tab you will be able to view the actual audit findings as detailed below.

The Executive Summary detailing the key points raised by the Environmental Health Consultant during the audit. It will also include a summary of the food training status and examination results, where relevant, of the food handling staff.

Details of the Audit Scores against each of the standards sections.

Full details of the audit observations and Recommendations.

FIG. 8J illustrates an example external audit report view.

Standards

Clicking on this section will reveal:

A list of specific food standards related to the site and by which the audit scoring system is marked on.

By double clicking on any of the standards then the full standard will be revealed.

11. Where to Get Help

If you need specific advice about the operation of FSS on site, or if you want to discuss items contained in the Risk Assessment, contact your Environmental Health Consultant through our Head Office on 555-1212.

If you need an Environmental Health Consultant to be on site to help with a food safety problem, for example, following a suspected food poisoning incident, we can arrange this. We can also liaise on your behalf with local authority Environmental Health Officers, although there would be an additional fee for this support work.

12. Data Protection Implications

Data Protection Acts 1984 & 1998

Most companies should already have a clause related to the above legislation, which has been signed off as part of the terms of employment.

However, e-Risk manager FSS will not assume this and therefore, the wording in the clause below has been added to the bottom of the employee food safety responsibility records. These records must be signed and dated by anyone who might have information related to themselves on the e-Risk FSS system.

We strongly recommend that your employees sign the clause, when their food safety responsibility records are issued to them.

Clause

FSS recognizes its obligations under the Data Protection Acts 1984 and 1998. In order to comply with its obligations, you are requested to confirm that you allow FSS to hold certain records related to training and other food safety matters, which have been received. Such records may be held manually or on a computer system and may be accessed by your employer or FSS.

IV. Conclusions

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A method for risk assessment and management, comprising the steps of:
(1) generating one or more discipline-specific master assessment manuals from one or more blank master assessment templates;
(2) populating the one or more discipline-specific master assessment manuals with discipline-specific questions;
(3) generating one or more site-specific assessment files from the one or more populated discipline-specific master assessment manuals; and
(4) performing an assessment of a site using the one or more site-specific assessment files.

2. The method according to claim 1, wherein step (1) comprises the step of generating one or more computer file copies of the one or more blank master assessment templates.

3. The method according to claim 1, wherein said one or more blank master assessment templates are generated by information technology (IT) professionals.

4. The method according to claim 1, wherein step (1) comprises the step of generating one or more interactive assessment manuals directed to ongoing risk maintenance.

5. The method according to claim 1, wherein step (1) comprises the step of generating one or more blank master audit manuals directed to taking a snapshot of an entity's condition.

6. The method according to claim 1, wherein step (1) comprises the steps of:
(a) generating one or more interactive assessment manuals directed to ongoing risk maintenance; and
(b) generating one or more blank master audit manuals directed to taking a snapshot of an entity's condition.

7. The method according to claim 1, wherein discipline-specific questions in step (2) comprise one or more of risk assessment and management questions, procedures, links, comments, and other information useful for risk assessment and management.

8. The method according to claim 1, wherein the population of said one or more discipline-specific master assessment manuals are performed by one or more chief consultants having expertise in a specific discipline, wherein the one or more chief consultants populate the one or more discipline-specific master assessment manuals with questions that are structured to identify issues and assess compliance with statutes, rules, regulations, best practices, and other duties of care relevant to the specific discipline.

9. The method according to claim 1, wherein step (2) comprises the step of populating one of the one or more discipline-specific master assessment manuals with health and safety questions to generate a health and safety master assessment manual.

10. The method according to claim 9, wherein the population of said health and safety master assessment manual is performed by one or more chief consultants having expertise in the discipline of health and safety, said one or more chief consultants including environmental health consultants.

11. The method according to claim 1, wherein step (2) comprises the step of populating one of the one or more discipline-specific master assessment manuals with food safety questions to generate a food safety master assessment manual.

12. The method according to claim 11, wherein the population of said food safety master assessment manual is performed by one or more chief consultants having expertise in food safety, said one or more chief consultants including environmental health consultants.

13. The method according to claim 1, wherein step (2) comprises the step of populating one of the one or more discipline-specific master assessment manuals with occupational health questions to generate an occupational health master assessment manual.

14. The method according to claim 13, wherein the population of said occupational health master assessment manual is performed by one or more chief consultants having expertise in occupational health, said one or more chief consultants including medical officers.

15. The method according to claim 1, wherein step (2) comprises the step of populating one of the one or more discipline-specific master assessment manuals with occupational hygiene questions to generate an occupational hygiene master assessment manual.

16. The method according to claim 15, wherein the population of said occupational hygiene master assessment manual is performed by one or more chief consultants having expertise in occupational hygiene, said one or more chief consultants including environmental scientists.

17. The method according to claim 1, wherein step (2) comprises the step of populating one of the one or more discipline-specific master assessment manuals with water safety questions to generate a water safety master assessment manual.

18. The method according to claim 17, wherein the population of said water safety master assessment manual is performed by one or more chief consultants having expertise in the discipline of water safety, said one or more chief consultants including environmental scientists.

19. The method according to claim 1, wherein step (2) comprises the step of populating one of the one or more discipline-specific master assessment manuals with asbestos safety questions to generate an asbestos safety master assessment manual.

20. The method according to claim 19, wherein the population of said asbestos safety master assessment manual is performed by one or more chief consultants having expertise in the discipline of asbestos safety, said one or more chief consultants including environmental scientists.

21. The method according to claim 1, wherein step (2) comprises the step of populating one of the one or more discipline-specific master assessment manuals with resource conservation questions to generate a resource conservation master assessment manual.

22. The method according to claim 21, wherein the population of said resource conservation master assessment manual is performed by one or more chief consultants having expertise in the discipline of resource conservation, said one or more chief consultants including environmental scientists.

23. The method according to claim 21, wherein said resource conservation questions comprise one or more of water conservation questions, electrical energy conservation questions, and natural gas conservation questions.

24. The method according to claim 1, wherein step (2) comprises the step of populating one of the one or more discipline-specific master assessment manuals with food preparation questions to generate a food preparation master assessment manual.

25. The method according to claim 24, wherein the population of said food preparation master assessment manual is performed by one or more chief consultants having expertise in food preparation safety, said one or more chief consultants including environmental health consultants.

26. The method according to claim 1, wherein step (2) comprises the step of populating one of the one or more discipline-specific master assessment manuals with fire safety questions to generate a fire safety master assessment manual.

27. The method according to claim 26, wherein the population of said fire safety master assessment manual is performed by one or more chief consultants having expertise in fire safety, said one or more chief consultants including environmental health consultants.

28. The method of claim 1, wherein step (2) comprises the step of populating one or more blank master interactive assessment manuals directed to ongoing risk assessment with discipline-specific questions, wherein the discipline-specific questions are tailored for interactive assessments.

29. The method of claim 1, wherein step (2) comprises the step of populating one or more blank master audit manuals directed to taking a snapshot of an entity's condition with discipline-specific questions, wherein the discipline-specific questions are tailored for audit assessments.

30. The method according to claim 1, wherein step (3) comprises the step of selecting site-specific questions from the one or more populated discipline-specific master assessment manuals to generate one or more site-specific assessment files.

31. The method according to claim 30, wherein said one or more site-specific assessment files are site-specific interactive assessment files comprising discipline-specific questions tailored for interactive assessment.

32. The method according to claim 30, wherein said one or more site-specific assessment files are site-specific audit assessment files comprising discipline-specific questions tailored for audit assessment.

33. The method according to claim 1, wherein step (3) comprises the step of selecting site-specific questions from the one or more populated discipline-specific master assessment manuals to generate one or more site-specific assessment files, wherein a site-specific assessment file includes questions from more than one populated discipline-specific master assessment manual.

34. The method according to claim 1, wherein step (4) comprises the step of performing an interactive assessment of a site using one or more site-specific interactive assessment files.

35. The method according to claim 1, wherein step (4) comprises the step of performing an audit assessment of a site using one or more site-specific audit assessment files.

36. The method according to claim 1, further comprising the steps of:
(5) performing steps (1) and (2) on a central computer system;
(6) performing step (3) on a remote computer system;
(7) entering results from step (4) on the remote computer system; and
(8) uploading the results from step (4) from the remote computer system to the central computer system.

37. The method according to claim 1, further comprising the steps of:
(5) performing steps (1) through (3) on a central computer system;
(6) entering results from step (4) on a remote computer system; and
(7) uploading the results from step (4) from the remote computer system to the central computer system.

38. A method of assessing and managing risk for one or more clients, comprising the steps of:
(1) generating for each of the one or more clients, one or more discipline-specific master risk assessment manuals from one or more blank master assessment templates;
(2) populating the one or more discipline-specific master risk assessment manuals with discipline-specific questions;
(3) generating one or more site-specific risk assessment files from the one or more populated discipline-specific master risk assessment manuals; and
(4) performing initial risk assessments for each of the one or more clients using the one or more site-specific risk assessment files.

39. The method according to claim 38, further comprising the steps of:
(5) generating one or more discipline-specific master interactive assessment manuals from one or more blank master assessment templates;
(6) populating the one or more discipline-specific master interactive assessment manuals with discipline-specific questions; and
(7) generating for each of the one or more clients, one or more site-specific assessment files from the one or more populated discipline-specific master interactive assessment manuals, wherein the questions selected are based, at least in part, on results from the initial risk assessment performed in step (4).

40. The method according to claim 39, further comprising the steps of:
(7) training the one or more clients on use and revision of the one or more site-specific assessment files; and
(8) performing follow-up risk assessment of the one or more clients.

41. The method according to claim 40, further comprising the step of periodically performing audits for each of the one or more clients.

42. A method for risk assessment and management, comprising the steps of:
(1) generating blank master interactive assessment and audit templates;
(2) generating a master interactive assessment manual from the blank master interactive assessment template; and
(3) generating a master audit manual from the blank master audit template;
wherein said master interactive assessment manual and said master audit manual are used as a guide for auditing and assessing businesses and other entities for one or more areas of risk management based on standards of care that arise from statutes, rules, and regulations promulgated by government and regulatory organizations.

43. The method of claim 42, further comprising the steps of:
(4) generating site-specific audit files from the master audit manual;
(5) auditing a site using the site-specific audit files;
(6) generating interactive site-specific assessment files from the master interactive assessment manual;
(7) performing an initial audit of the site using the interactive site specific assessment files; and
(8) generating a site-specific interactive manual from the initial audit and from the interactive site specific assessment files, wherein the site-specific interactive manual includes instructions for reducing risks identified during the initial audit, and wherein the site-specific interactive manual includes instructions to periodically perform one or more risk management functions.

44. The method of claim 43, further comprising the step of training a site client to perform in accordance with the site-specific interactive manual.

45. The method of claim 42, wherein said one or more areas of risk management include health and safety, food safety, water safety, asbestos safety, fire safety, occupational health, resource conservation, and occupational hygiene.

46. The method of claim 42, wherein the blank master interactive assessment template is generated by one or more information technology (IT) professionals.

47. The method of claim 42, wherein the master interactive assessment manual is populated with risk management questions, procedures, links, comments, and other information useful for risk assessment and management.

48. The method of claim 42, wherein the master interactive assessment manual is populated with discipline-specific risk management questions, wherein the disciplines for the discipline specific risk management questions include questions from one or more of health and safety discipline, food safety discipline, occupational health discipline, occupational hygiene discipline, water safety discipline, asbestos safety discipline, resources conservation discipline, food preparation discipline, and fire safety discipline.

49. The method of claim 48, wherein one or more chief consultants having expertise in a specific discipline populates the master interactive assessment manual with discipline-specific risk management questions, wherein the discipline-specific risk management questions are structured to identify issues and to assess compliance with statutes, rules, regulations, best practices, and duties of care relevant to the specific discipline.

50. The method of claim 49, wherein one or more chief consultants include environmental scientists who have technical expertise in a discipline and medical officers who have medical expertise in a discipline.

51. The method of claim 42, wherein a site-specific assessment file for a single discipline is generated from the master interactive assessment manual.

52. The method of claim 42, wherein a site-specific assessment file for multiple disciplines is generated from the master interactive assessment manual.

53. A system for risk assessment and management, comprising:
a registration module for setting up client users and defining access authorization;
a blank template files module for creating blank templates to be used for different disciplines and different user clients;
one or more discipline-specific master template modules, wherein said one or more discipline-specific master template modules utilize said blank templates from said blank template files module, and wherein said one or more discipline-specific master template modules generate the master templates for risk assessment and risk management that are relevant to a specific discipline;
one or more site specific modules having site specific files for performing audits and interactive risk management and monitoring for a particular site, wherein said site specific files are generated from said master templates from said one or more discipline-specific master template modules; and
one or more user interfaces to allow said client users to interact with said registration module, said blank template files module, said one or more discipline-specific master template modules, and said one or more site specific modules for providing audits and interactive risk assessments;
wherein the risk assessment and management system utilizes standards of care that arise from statutes, rules, and regulations promulgated by government and regulatory organizations.

54. The system of claim 53, wherein said one or more discipline-specific master template modules generate one or more discipline-specific master manuals from a blank template and populate said one or more discipline-specific master manuals with questions designed to assess risk for a specific discipline.

55. The system of claim 54, wherein questions within said one or more discipline-specific master manuals are divided into one or more sectors associated with one or more types of businesses or entities.

56. The system of claim 53, wherein site-specific databases are generated from said one or more discipline-specific master manuals when a new client is identified for risk assessment, wherein said site-specific databases include question sets associated with one or more disciplines.

57. The system of claim 56, wherein said site-specific databases include interactive risk assessment questions that prompt a client user to periodically answer questions and periodically perform one or more tasks.

58. The system of claim 53, wherein said one or more user interfaces includes a network interface for a packet switched wide area network.

59. The system of claim 53, wherein said wide area network includes one or more of a private wide area network, a local area network, and a telecommunications network.

60. The system of claim 53, wherein said audits are snapshot measurements of risk at one point in time.

61. The system of claim 53, wherein said blank template module comprises a blank audit assessment template module and a blank interactive assessment template module.

62. The system of claim 61, wherein said blank audit assessment template module generates templates for use with an audit.

63. The system of claim 61, wherein said blank interactive assessment template module generates templates for use in an interactive risk management and monitoring system.

64. The system of claim 53, further comprising a reference files module, said reference files module comprising information relevant to using the system.

65. The system of claim 64, wherein said reference files module further comprises an interactive template forms module, a news feed module, and a legislation module.

66. The system of claim 65, wherein said interactive template forms module includes template forms that are specific to a particular site, wherein said template forms are saved locally by said client user.

67. The system of claim 65, wherein said news feed module provides a news service pertaining to risk management news, wherein news can be sorted, selected, and received by country, language, sector, discipline, clients, and products.

68. The system of claim 65, wherein said legislation module is a repository comprising legislation pertaining to regulations that may affect said client user.

69. The system of claim 53, wherein said registration module comprises a translation module that provides for the operation of said risk assessment and management system in other languages.

70. The system of claim 53, further comprising a report management system for enabling authorized viewers to access reports from a central location, wherein said reports include audit reports, supplier information reports, and industry standard reports.

71. The system of claim 70, wherein said report management system comprises a plurality of facilities, a plurality of assessment facilitators and a server/repository.

72. A computer program product comprising a computer useable medium including control logic stored therein, said control logic for enabling risk assessment and management, said control logic comprising:
first generating means for enabling a processor to generate one or more discipline-specific master assessment manuals from one or more blank master assessment templates;
populating means for enabling a processor to populate the one or more discipline-specific master assessment manuals with discipline-specific questions;
second generating means for enabling a processor to generate one or more site-specific assessment files from the one or more populated discipline-specific master assessment manuals; and
performing means for enabling a processor to perform an assessment of a site using the one or more site-specific assessment files.
